(19) United States
(12) Patent Application Publication
(10) Pub. No.: US 2001/0032247 A1
(43) Pub. Date: Oct. 18, 2001

(54) Additional value appended e-mail selecting apparatus, transmitting apparatus, transmitting/receiving system and methods of selecting and transmitting/receiving the same

(76) Inventor: Nobuyuki Kanaya, Kawasaki (JP)

Correspondence Address: STAAS & HALSEY LLP, 700 11TH STREET, NW, SUITE 500, WASHINGTON, DC, 20001, US

(21) Appl. No.: 09/797,931

(22) Filed: Mar. 5, 2001

(30) Foreign Application Priority Data
Mar. 31, 2000 (JP) 2000-097102

(51) Int. Cl. G06F 15/16

(52) U.S. Cl. 709/206; 709/207

(57) ABSTRACT

There are provided a threshold value storing unit for storing a threshold value set by a receiver for an additional value which becomes effective for the receiver when the receiver reads a piece of E-mail and an E-mail arrival notifying unit for, when the additional value which is appended to the the E-mail transmitted from a transmitter side exceeds the threshold value stored in the threshold value storing unit, notifying the receiver of the arrival of the E-mail so as to select the E-mail to which the additional value exceeding the threshold value is appended in order to induce the receiver to read the E-mail, by which it becomes possible for the E-mail receiver to select an appropriate piece of E-mail and it becomes possible for the transmitter to induce the receiver to select and read an advertisement or the like from among many pieces of E-mail.

### FIELD OF THE INVENTION

The present invention relates to an E-mail transmitting/receiving system and more particularly to an additional value appended E-mail selecting apparatus, a transmitting apparatus, a transmitting/receiving system and methods of selecting and transmitting/receiving the same adapted to effectively make a receiver read an additional value appended E-mail to which an additional value which becomes effective when the receiver reads the E-mail is appended.

### DESCRIPTION OF THE RELATED ART

A direct mail sent by E-mail is greatly different from an advertisement on the Web through which a transmitter can not provide information to a receiver before he looks at it in that an information provider can select a destination to whom the provider wants to give it. Accordingly, the E-mail system will become an important medium in the future in order to seek a new market.

However, in the conventional direct mail system used by E-mail, an information receiver has to pay a fee for receiving the information and hence no direct profit is yielded, that is, there is no benefit to the receiver, so that in many cases these mailings have been dumped after they have read. In addition, there have been no standards for determing the value of information except by addresses such as “From”, and the like, and “Subject” as standards for filtering the information. Accordingly, there is a flood of unnecessary information in the market and the effect of advertisement by E-mail will be of decreasing effect.

In addition, in a case that the address of the E-mail is passed into the hands of a third person, the third person can freely send the E-mail and hence the flooding of unnecessary E-mails will be accelerated. Accordingly, a receiver could not make his address public directly to the transmitter and what he could do was only to utilize an E-mail forwarding service or an E-mail selecting service utilized, which selects E-mails based on uncertain contents and senders. Further, even when the transmitter intends to send an advertisement or the like to the receiver, it is difficult for the transmitter to acquire the address of the receiver and hence the transmitter has to send mail via an Internet mail publicity agent or the like.

As described above, in the conventional E-mail system, it is almost impossible to control the quantity and quality of E-mail. The receiver cannot acquire appropriate information from a flood of E-mail and hence the receiver gives up reading the E-mail. On the other hand, even when the transmitter sends the E-mail to the receiver, it is buried in with many other pieces of E-mail and there is no guarantee for the transmitter to induce the receiver to read the transmitter's E-mail, resulting in a nastily circle in which the transmitter further increases the quantity of E-mail.

One prior art is disclosed in U.S. Pat. No. 5,794,210 in which the effectiveness of an advertisement is improved by paying an equivalent fee for such an action of a person looking at the advertisement. However, in a case that this invention is applied to the advertisement sent by E-mail, a piece of E-mail with no equivalent value is also sent and hence this invention is not effective. This invention also has a drawback in that a computer of an agent always lies between the transmitter and the receiver. That is, for example, a list of receivers is valuable information for business for the E-mail transmitter and hence the transmitter does not want to let the agent have access thereto.

As described above, the conventional E-mail transmitting/receiving system has such problems that it is impossible for both the transmitter and the receiver to control the number and contents of E-mails, on the receiver side, it is impossible for the receiver to select an E-mail that the receiver wants to read, and on the transmitter side, there is no guarantee that the transmitter can induce the receiver to read the advertisement sent by E-mail and the transmitter cannot appropriately select the destinations of the advertisement.

### SUMMARY OF THE INVENTION

The present invention has been contemplated in view of the above mentioned drawbacks associated with the prior art. Accordingly, a first subject of the present invention is to make it possible for a receiver to reject reception of a piece of E-mail which is not worth reading, a second subject of the present invention is to make it possible for a transmitter to securely induce the receiver to select the transmitter's advertisement or the like sent by E-mail from many E-mails and to read it, a third subject of the present invention is to make it possible to establish transmission and reception of the advertisement as a transaction (business deal) between the transmitter and the receiver, and a fourth subject of the present invention is to make it possible for the transmitter to select destinations of his advertisement such that the advertising effect of E-mail can be optimized.

In order to attain the above mentioned objectives, according to one aspect of the present invention, an E-mail selecting apparatus (receiving system) for selecting an additional value appended to electronic mail comprises a threshold value storing unit and an electronic mail arrival notifying unit. The threshold value storing unit stores a threshold value corresponding to an additional value. In this case, as the additional values, for example, a bill, a book token, a department store discount ticket and the like can be conceived of. The electronic mail arrival notifying unit compares the additional value appended to the electronic mail transmitted from a transmitter with the threshold value stored in the threshold value storing unit and to notify the receiver of the arrival of the electronic mail when the additional value exceeds the threshold value.

As a result, it becomes possible for the receiver to automatically or unintentionally reject reading of electronic mail to which the additional value less than the threshold value is appended.

In the above mentioned arrangement, there may be employed a plurality of kinds of additional values such as the bill, the book token, the department store discount ticket and the like such that the threshold value storing unit may store respective threshold values for the plurality of kinds of these additional values and the E-mail arrival notifying unit may notify the receiver of the arrival of the E-mail when the additional value appended to the E-mail exceeds the threshold value for the additional value corresponding to that appended to this E-mail.

In the above mentioned arrangement, The E-mail selecting apparatus also comprise a threshold value calculating unit calculating threshold values for additional values based on threshold values set for some of the plurality of kinds of additional values and rates for calculating threshold values for other kinds of additional values, and storing the threshold values thus calculated in the threshold value storing unit. In this arrangement, it is to be noted that these values may be set by the receivers.

As an additional value of another kind, there may be employed an additional value for a specific receiver generated on the side of the receiver of a piece of E-mail. In this case, the E-mail arrival notifying unit may be designed so as to notify, when the piece of E-mail to which an additional value exceeding the corresponding threshold value is appended is received from a transmitter that acquired the additional value for the specific receiver, the receiver of the arrival of the E-mail.

In an embodiment of the present invention, the additional value appended E-mail selecting apparatus may be installed on or comprised in the side of an E-mail reception mediator or agent interposed between the transmitter and the receiver of the E-mail and may further comprise with an additional value settling unit settling the account for an additional value appended to a piece of E-mail when a receiver reads the E-mail of which arrrival is notified.

In this case, as described above, either one kind of additional value or a plurality of kinds of additional values maybe employed. In addition, the E-mail selecting apparatus may further comprise a threshold value calculating unit calculating threshold values for all additional values based on threshold values set for some of the plurality of kinds of additional values and rates for calculating threshold values for other kinds of additional values, and storing the calculated values in the threshold value storing unit.

Next, an additional value appended E-mail transmitting apparatus according to the present invention comprises an E-mail transmitting unit transmitting some pieces of E-mail to which additional values exceeding threshold values which are set for additional values by one or more E-mail receivers and are provided from the outside are appended to the receivers that set the threshold values.

In an embodiment of the present invention, the additional value appended E-mail transmitting apparatus may be installed on or comprised in the side of the agent interposed between the E-mail transmitter and the receivers and may also comprise a threshold 0value storing unit for storing a threshold value provided from an outside receiver and sending the threshold value thus stored to the E-mail transmitting unit. In this case, as described above, either one kind of additional value or a plurality of kinds of additional values may be employed and the apparatus may further comprise such a threshold value calculating unit as mentioned above in a case that the plurality of kinds of additional values are to be handled.

An E-mail transmitting/receiving system according to the present invention comprises a threshold value storing unit storing threshold values which are set by one or more E-mail receivers for additional values corresponding thereto and are made public to an E-mail transmitter such as a Web server, and an E-mail transmitting unit referring to the contents stored in the threshold value storing unit and transmitting some pieces of E-mail to which additional values exceeding the threshold values which are made public are appended to the receivers that make their threshold values public.

In this E-mail transmitting/receiving system, as in the case with the above mentioned E-mail selecting apparatus, the threshold value storing unit may store respective threshold values for a plurality of kinds of additional values and the E-mail transmitting unit may transmit the E-mails to which additional values which are of the same kind and exceed the published threshold values are appended. In addition, the system may also comprise a threshold value calculating unit for receiving, from the receivers, threshold values set for some of the plurality of kinds of additional values and rates for calculating threshold values for other kinds of additional values, calculating threshold values for all kinds of additional values based on the threshold values and rates thus received and storing the threshold values thus calculated in the threshold value storing unit.

In an embodiment of the present invention, the E-mail transmitting unit of the E-mail transmitting/receiving system may also comprise an appended additional value determining unit referring to the contents stored in the threshold value storing unit and determining a value which is appropriate as an additional value to be appended to the E-mail, for example, a value which is the same as the threshold value published by a receiver. In this case, the E-mail transmitting unit may further comprise an advertisement selecting unit selecting an advertisement suitable to a receiver that makes the threshold value public in accordance with the kind of additional value corresponding to the threshold value thus published, for example, an advertisement of a bookstore to a receiver that designates a book token as the additional value and preparing a piece of E-mail with this advertisement.

In the embodiment of the E-mail transmitting/receiving system, the E-mail transmitting unit may further comprise an additional value distributing unit referring to the contents stored in the threshold value storing unit, appropriately distributing the gross value of the additional values designated by the transmitter of the E-mail and determining one or more receivers to which one or more pieces of E-mail to which the additional values thus distributed are appended should be sent. In this case, the E-mail transmitting unit may further comprise the advertisement selecting unit which is the same as the above so as to appropriately distribute the total amount of the additional values and to select an advertisement suitable for each receiver, thereby to transmit the E-mail including the advertisement thus selected together with the distributed additional value appended thereto.

A system for transmitting/receiving a piece of E-mail, to which a specific receiver additional value which is generated on the side of the E-mail receiver and which becomes effective when the receiver reads the E-mail is appended, comprises a threshold value storing unit storing a threshold value which is set by the E-mail receiver for the specific receiver additional value, an E-mail arrival notifying unit notifying the receiver of the arrival of the E-mail when the additional value appended to the E-mail sent from the transmitter exceeds the threshold value stored in the threshold value storing unit, and a specific receiver additional value mediating unit for mediating the specific receiver additional value between the E-mail transmitter and receiver.

According to the present invention, selection of additional values with reference to the threshold values can be realized not only for the transmission/reception of E-mail but also for the transmission/reception of a Web page, for example, via the Internet. In this case, the additional value appended E-mail selecting apparatus can be used almost directly as an additional value appended Web page selecting apparatus.

In this Web page selecting apparatus, a threshold value storing unit stores a threshold value which is set corresponding to an additional value by a Web page receiver and a Web page arrival notifying unit provided in place of the E-mail arrival notifying unit notifies the receiver of the arrival of the Web page so as to induce the receiver to read it when the additional value appended to the Web page sent from the transmitter exceeds the threshold value stored in the threshold value storing unit.

In this case, the threshold value storing unit may be designed so as to store respective threshold values for a plurality of kinds of additional values and the Web page arrival notifying unit may be designed so as to notify the receiver of the arrival of the Web page when the additional value appended to the Web page exceeds the stored threshold value for the additional value of the same kind as the above.

The Web page transmitting/receiving system according to the present invention comprises a threshold value storing unit storing a threshold value set, for example, by a receiver of a Web page for an additional value, a threshold value notifying unit notifying the Web page transmitter of the threshold value stored in the threshold value storing unit, and a Web page transmitting unit appending an additional value exceeding the threshold value thus made known to the Web page and transmitting the additional value appended Web page to the receiver.

Next, an additional value appended E-mail selecting method according to the present invention comprises the steps of storing a threshold value set for an additional value to be appended to a piece of E-mail by a receiver of the E-mail, and notifying the receiver of the arrival of the E-mail when the additional value appended to the E-mail sent from a transmitter exceeds the threshold value.

An additional value appended E-mail transmitting/receiving method according to the present invention comprises the steps of storing threshold values which are set for additional values to be appended to one or more pieces of E-mail by one or more receivers of the E-mail and which are made public to a transmitter of the E-mail, and transmitting the E-mail to which the additional value exceeding the published threshold value is appended with reference to the contents thus stored to each of the receivers that make the threshold values public.

As a storing medium according to the present invention, there is employed a storing medium which is readable through a computer and is adapted to load programs for instructing the computer to execute a process of storing of threshold value set for an additional value by a receiver of E-mail, and a process of notifying the receiver of the E-mail arrival when the additional value appended to the E-mail sent from a transmitter exceeds the stored threshold value.

As a storing medium according to the present invention, there is also employed a storing medium which is readable through a computer and is adapted to load programs for instructing the computer to execute a process of accepting an input of a threshold value which is set for an additional value by a receiver of E-mail and which is to be made public to a transmitter of the E-mail, and a process of storing the threshold value thus accepted.

As a storing medium according to the present invention, there is further employed a storing medium which is readable through a computer and is adapted to load programs for instructing the computer to execute a process of referring to a threshold value which is set for an additional value by a receiver of E-mail and is made public to a transmitter of the E-mail, and a process of transmitting the E-mail to which the additional value exceeding the published threshold value is appended to the receiver that makes the threshold value public as a result of execution of the above referring process.

As described above, according to the present invention, by transmitting and receiving a piece of E-mail with an additional value appended thereto, the additional value is given to a receiver in return for reading the E-mail and a charge therefore is claimed by a transmitter, and hence this additional value makes it possible for the receiver to select the E-mail so as to control the quality and quantity of the E-mail which is worth reading. In addition, on the side of the transmitter, such a guarantee can be attained that the transmitter can surely induce the receiver to read the E-mail. In general, such operations can be performed directly between the transmitter and the receiver with no provision of a server for controlling the additional value appending operation concentratingly within the E-mail transmission/reception system.

### BRIEF DESCRIPTION OF THE DRAWINGS

The features and advantages of the present invention will be more clearly appreciated from the following description taken in conjunction with the accompanying drawings in which like elements are denoted by like reference numerals and in which:

FIG. 1 is a diagram showing, in principle, the structure of the present invention;

FIG. 2 is a diagram of the fundamental structure of a first embodiment of the present invention;

FIG. 3 is a diagram showing the detailed structure of a reception system;

FIG. 4 is a general flowchart of an E-mail transmitting/receiving process;

FIG. 5 is a detailed flowchart of a threshold value setting process shown in FIG. 4;

FIG. 6 is a detailed flowchart of a process of preparing E-mail to be transmitted shown in FIG. 4;

FIG. 7 is a detailed flowchart of an E-mail receiving and notifying process shown in FIG. 4;

FIG. 8 is a detailed flowchart of an additional value settling process shown in FIG. 4;

FIG. 9 is an illustration showing a concrete example of the first embodiment of the present invention;

FIG. 10 is a diagram showing the detailed structure of the reception system according to a second embodiment of the present invention;

FIG. 11 shows an example of the contents stored in a threshold value storage database;

FIG. 12 is a flowchart of the threshold value setting process in the second embodiment of the present invention;

FIG. 13 is a flowchart of the threshold value setting process when a rate for a threshold value is inputted;

FIG. 14 is a detailed flowchart of the E-mail receiving and notifying process in the second embodiment of the present invention;

FIG. 15 is an illustration showing a concrete example of the second embodiment of the present invention;

FIG. 16 is a diagram of the fundamental structure of a third embodiment of the present invention;

FIG. 17 is a diagram of the detailed structure of a destination publishing system;

FIG. 18 shows an example of the contents stored in a destination storage database;

FIG. 19 is a general flowchart of the E-mail transmitting/receiving process in the third embodiment of the present invention;

FIG. 20 is a detailed flowchart (part 1) of a destination publishing process;

FIG. 21 is a detailed flowchart (part 2) of the destination publishing process;

FIG. 22 is a diagram illustrating a concrete example of the third embodiment of the present invention;

FIG. 23 is a diagram of the fundamental structure of a fourth embodiment of the present invention;

FIG. 24 is a detailed flow chart (part 1) of an E-mail preparing process in the fourth embodiment of the present invention;

FIG. 25 is a detailed flowchart (part 2) of the E-mail preparing process in the fourth embodiment of the present invention;

FIG. 26 is a diagram illustrating a concrete example of the fourth embodiment of the present invention;

FIG. 27 is a diagram of the fundamental structure of a fifth embodiment of the present invention;

FIG. 28 shows an example of the contents stored in a destination storage database according to the fifth embodiment of the present invention;

FIG. 29 is a detailed flowchart (part 1) of the E-mail preparing process in the fifth embodiment of the pressent invention;

FIG. 30 is a detailed flowchart (part 2) of the E-mail preparing process in the fifth embodiment of the present invention;

FIG. 31 is a diagram illustrating a concrete example of the fifth embodiment of the present invention;

FIG. 32 is a diagram of the fundamental structure of a sixth embodiment of the present invention;

FIG. 33 is a detailed flowchart of the E-mail preparing process in the sixth embodiment of the present invention;

FIG. 34 is a diagram illustrating a concrete example of the sixth embodiment of the present invention;

FIG. 35 is a diagram of the fundamental structure of a seventh embodiment of the present invention;

FIG. 36 is a detailed flowchart of the E-mail preparing process in the seventh embodiment of the present invention;

FIG. 37 is a diagram illustrating a concrete example of the seventh embodiment of the present invention;

FIG. 38 is a diagram of the fundamental structure of an eighth embodiment of the present invention;

FIG. 39 is a detailed flowchart of the E-mail preparing process in the eighth embodiment of the present invention;

FIG. 40 is a diagram illustrating a concrete example of the eighth embodiment of the present invention;

FIG. 41 is a diagram of the fundamental structure of a ninth embodiment of the present invention;

FIG. 42 is a general flowchart of the E-mail transmitting/receiving process in the ninth embodiment of the present invention;

FIG. 43 is a detailed flowchart of the E-mail preparing process in the ninth embodiment of the present invention;

FIG. 44 shows an example of the contents stored in the threshold value storage database in the ninth embodiment of the present invention;

FIG. 45 is a diagram illustrating a concrete example of the ninth embodiment of the present invention;

FIG. 46 is a diagram of the fundamental structure of a tenth embodiment of the present invention;

FIG. 47 is a general flowchart of the E-mail transmitting/receiving process in the tenth embodiment of the present invention.

FIG. 48 shows an example of the contents stored in a transmission permission database;

FIG. 49 is a diagram illustrating a concrete example of the tenth embodiment of the present invention;

FIG. 50 is a diagram of the fundamental structure of an eleventh embodiment of the present invention;

FIG. 51 is a diagram of the detailed structure of a destination registering system according to the eleventh embodiment of the present invention;

FIG. 52 is a general flowchart of the E-mail transmitting/receiving process in the eleventh embodiment of the present invention;

FIG. 53 is a detailed flowchart (part 1) of the destination registering process in the eleventh embodiment of the present invention;

FIG. 54 is a detailed flowchart (part 2) of the destination registering process in the eleventh embodiment of the present invention;

FIG. 55 is a flow chart of an advertisement preparing process in the eleventh embodiment of the present invention;

FIG. 56 is a detailed flowchart (part 1) of the E-mail preparing process in the eleventh embodiment of the present invention;

FIG. 57 is a detailed flowchart (part 2) of the E-mail preparing process in the eleventh embodiment of the present invention;

FIG. 58 is a diagram illustrating a concrete example of the eleventh embodiment of the present invention;

FIG. 59 is a diagram showing the fundamental structure of a twelfth embodiment of the present invention;

FIG. 60 is a diagram of the detailed structure (part 1) of a reception mediating system according to the twelfth embodiment of the present invention;

FIG. 61 is a diagram of the detailed structure (part 2) of the reception mediating system according to the twelfth embodiment of the present invention;

FIG. 62 is a flowchart (part 1) of a threshold value setting process in the twelfth embodiment of the present invention;

FIG. 63 is a flowchart (part 2) of the threshold value setting process in the twelfth embodiment of the present invention;

FIG. 64 is a flowchart (part 3) of the threshold value setting process in the twelfth embodiment of the present invention;

FIG. 65 is a detailed flowchart (part 1) of an E-mail receiving and notifying process in the twelfth embodiment of the present invention;

FIG. 66 is a detailed flowchart (part 2) of the E-mail receiving and notifying process in the twelfth embodiment of the present invention;

FIG. 67 is a detailed flowchart of an additional value settling process in the twelfth embodiment of the present invention;

FIG. 68 is a diagram illustrating a concrete example of the twelfth embodiment of the present invention;

FIG. 69 is a diagram showing the fundamental structure of a thirteenth embodiment of the present invention;

FIG. 70 is a diagram (part 1) showing the detailed structure of an inspecting system according to the thirteenth embodiment of the present invention;

FIG. 71 is a diagram (part 2) showing the detailed structure of the inspecting system according to the thirteenth embodiment of the present invention;

FIG. 72 is a diagram (part 3) showing the detailed structure of the inspecting system according to the thirteenth embodiment of the present invention;

FIG. 73 is a diagram (part 4) showing the detailed structure of the inspecting system according to the thirteenth embodiment of the present invention;

FIG. 74 is a diagram (part 1) showing the detailed structure of a transmitting system according to the thirteenth embodiment of the present invention;

FIG. 75 is a diagram showing an example of the contents stored in an additional value storage database;

FIG. 76 is a diagram (part 2) showing the detailed structure of the transmitting system according to the thirteenth embodiment of the present invention;

FIG. 77 is a general flowchart of a Web page transmitting/receiving process in the thirteenth embodiment of the present invention;

FIG. 78 is a detailed flowchart (part 1) of the threshold value setting process in the thirteenth embodiment of the present invention;

FIG. 79 is a detailed flowchart (part 2) of the threshold value setting process in the thirteenth embodiment of the present invention;

FIG. 80 is a detailed flowchart (part 1) of a process of preparing a Web page to be transmitted in the thirteenth embodiment of the present invention;

FIG. 81 is a detailed flowchart (part 2) of the transmitted Web page preparing process in the thirteenth embodiment of the present invention;

FIG. 82 is a detailed flowchart (part 1) of a request transmitting process in the thirteenth embodiment of the present invention;

FIG. 83 is a detailed flowchart (part 2) of the request transmitting process in the thirteenth embodiment of the present invention;

FIG. 84 is a detailed flowchart (part 3) of the request transmitting process in the thirteenth embodiment of the present invention;

FIG. 85 is a detailed flowchart (part 1) of the Web page transmitting process in the thirteenth embodiment of the present invention;

FIG. 86 is a detailed flowchart (part 2) of the Web page transmitting process in the thirteenth embodiment of the present invention;

FIG. 87 is a detailed flowchart (part 1) of the Web page receiving process in the thirteenth embodiment of the present invention;

FIG. 88 is a detailed flowchart (part 2) of the Web page receiving process in the thirteenth embodiment of the present invention;

FIG. 89 is a detailed flowchart of the additional value settling process in the thirteenth embodiment of the present invention;

FIG. 90 is a diagram illustrating a concrete example of the thirteenth embodiment of the present invention;

FIG. 91 is a structural diagram of a computer; and

FIG. 92 is a diagram illustrating loading of programs and data for implementing the present invention to the computer.

### DESCRIPTION OF THE PREFERRED EMBODIMENTS OF THE PRESENT INVENTION

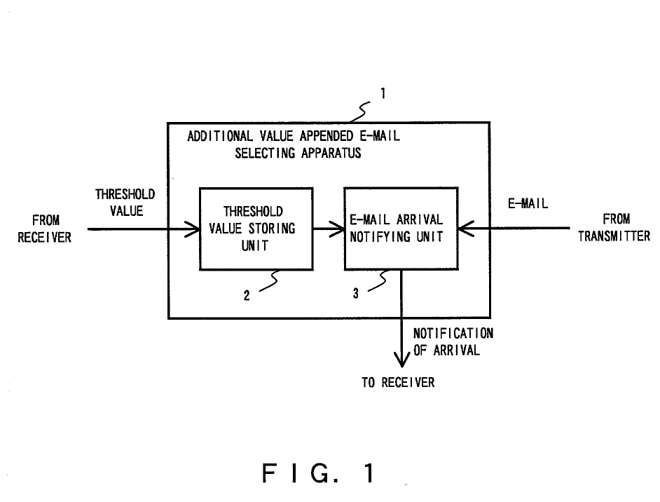

FIG. 1 is a diagram showing, in principle, the structure of an additional value appended E-mail selecting apparatus according to the present invention. That is, FIG. 1 is the diagram showing, in principle, the structure of the selecting apparatus constructed such that an additional value appended piece of E-mail to which an additional value, such as a coupon for a bill, a book token or the like, which becomes effective for a receiver when the receiver reads the E-mail is appended, is selected so as to induce the receiver to read it. This apparatus corresponds to a first embodiment constituting the most fundamental embodiment of the present invention so as to realize the selection of the E-mail on the side of the receiver which is one of the most important concept of the present invention.

In FIG. 1, the additional value appended E-mail selecting apparatus 1 comprises a threshold value storing unit 2 and an E-mail arrival notifying unit 3. The threshold value storing unit 2 is constituted, for example, by a threshold value memory or a threshold value storage database and is adapted to store a threshold value corresponding to an additional value. The threshold value is set by the receiver of the E-mail.

The E-mail arrival notifying unit 3 is adapted to notify the receiver of the arrival of the E-mail so as to induce the receiver to read it when the additional value appended to the E-mail sent from a transmitter exceeds the threshold value stored in the threshold value storing unit 2, for example, when a bill which is the additional value appended to the E-mail amounts to 500 yen and the threshold value stored in the threshold value storing unit 2 so as to correspond to the bill amounts to 200 yen.

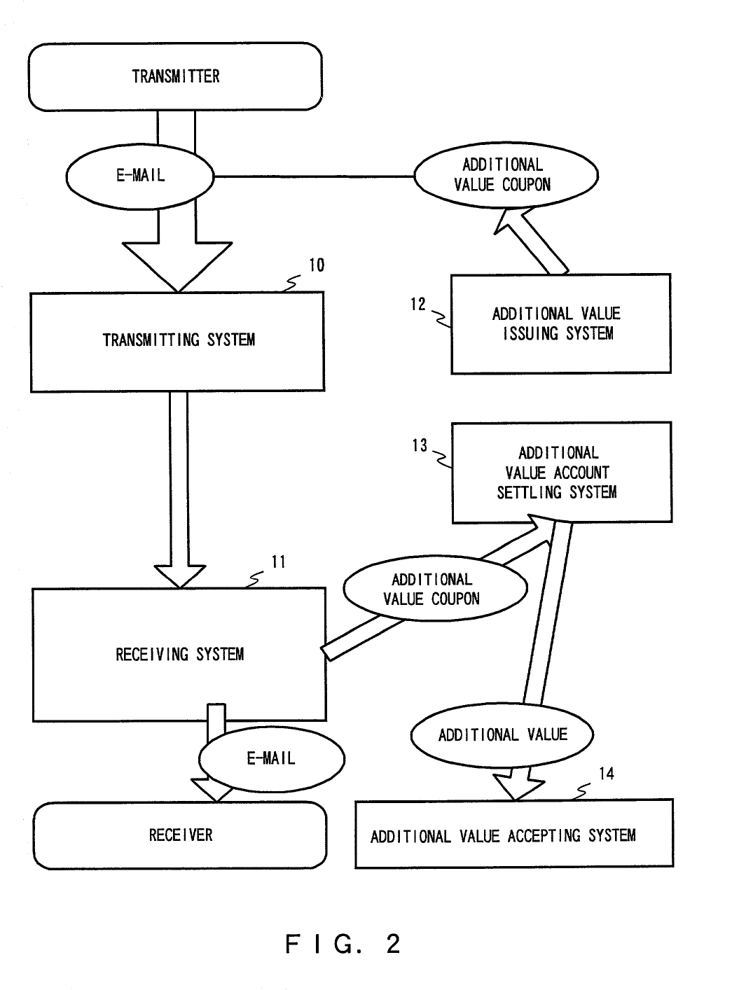

FIG. 2 is a diagram of the fundamental structure of the first embodiment of the present invention. This first embodiment is the most fundamental one of the embodiments of the present invention. In this embodiment, there is executed the most fundamental operation that, among many pieces of E-mail sent from the transmitter with the additional values appended thereto, the receiver accepts one (or some) of them only when the additional value appended thereto exceeds the threshold value which has been set in advance by the receiver.

In FIG. 2, the first embodiment of the present invention comprises a transmitting system 10, a receiving system 11, an additional value issuing system 12, an additional value settling system 13 and an additional value accepting system 14.

The transmitting system 10 is adapted to transmit the E-mail prepared by the transmitter to the receiving system 11 installed on the side of the receiver. The receiving system 11 is adapted to receive the E-mail thus transmitted thereto, to compare the additional value appended thereto with the threshold value designated in advance by the receiver, to notify the receiver of the arrival of the E-mail when the threshold value is smaller than the additional value, and to transmit a coupon for the additional value to the additional value settling system 13 when the receiver 16 read the E-mail.

The additional value issuing system 12 is adapted to issue the coupon for the additional value to the transmitter and the transmitter sends the E-mail with the coupon appended thereto to the transmitting system 10. The additional value settling system 13 is adapted to receive the coupon for the additional value from the receiving system 11 and then to verify whether the coupon is the correct one. When it is the correct one, the system 13 sends the additional value such as cash, a book token or the like to the additional value accepting system 14 which, then accepts and saves the additional value.

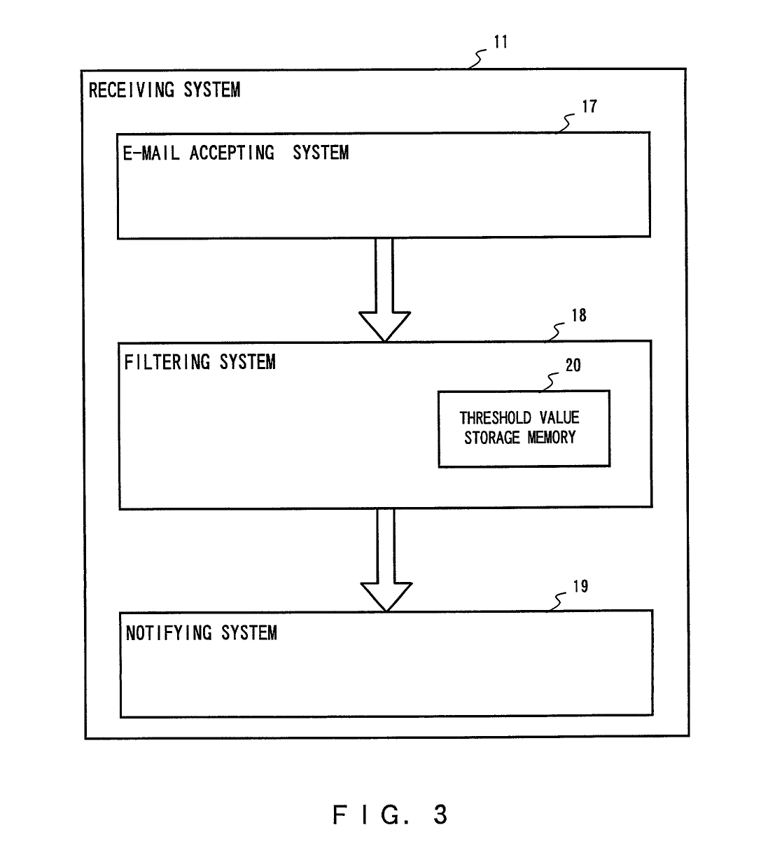

FIG. 3 is a diagram showing the detailed structure of the receiving system 11 shown in FIG. 2. In the drawing, the receiving system 11 comprises an E-mail accepting system 17 for accepting the E-mail sent from the transmitting system 10, a filtering system 18 for selecting the transmitted E-mail to which the additional value exceeding the threshold value is appended, and a notifying system 19 for notifying the receiver of the arrival of the E-mail to which the additional value exceeding the threshold value is appended. Within the filtering system 18, there is provided a threshold value storage memory 20 for storing the threshold value which has been set in advance by the receiver.

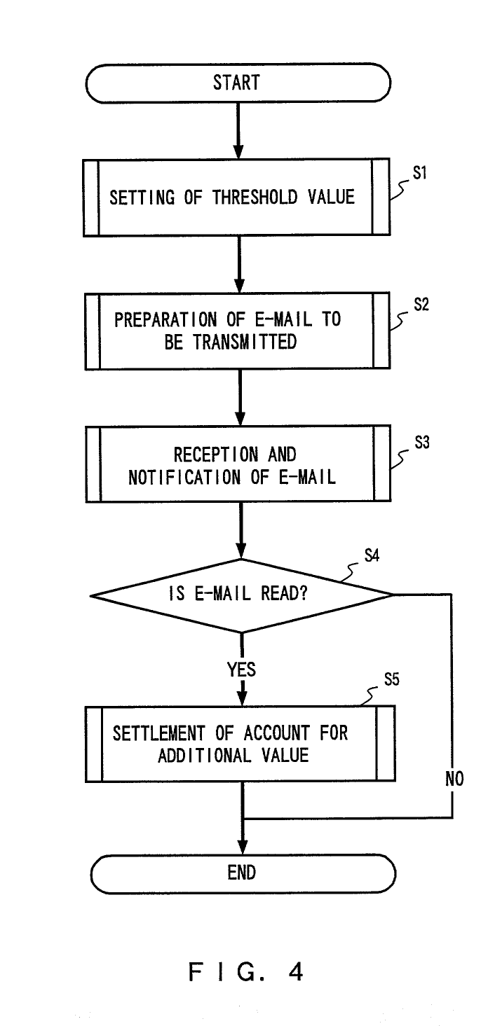

FIG. 4 is a general flowchart of an E-mail transmitting/receiving process in the first embodiment of the present invention. In the drawing, when the process is started, the threshold value is set by the receiver in FIG. 2 at a step S1, then, at a step S2, the E-mail to be transmitted is prepared by the transmitter, at a step S3, the E-mail is received by the receiving system 11 and the arrival of the E-mail is notified to the receiver, and at a step S4, it is judged whether the additional value appended to the E-mail exceeds the threshold value and it is judged whether the receiver read the E-mail, that is, it is judged whether the contents of the E-mail was fetched, for example, into the personal computer of the receiver. Then, when the receiver read the E-mail, the account for the additional value is settled at a step S5. However, when the receiver did not read the E-mail, that is, when the additional value does not reach the threshold value, the process immediately comes to an end.

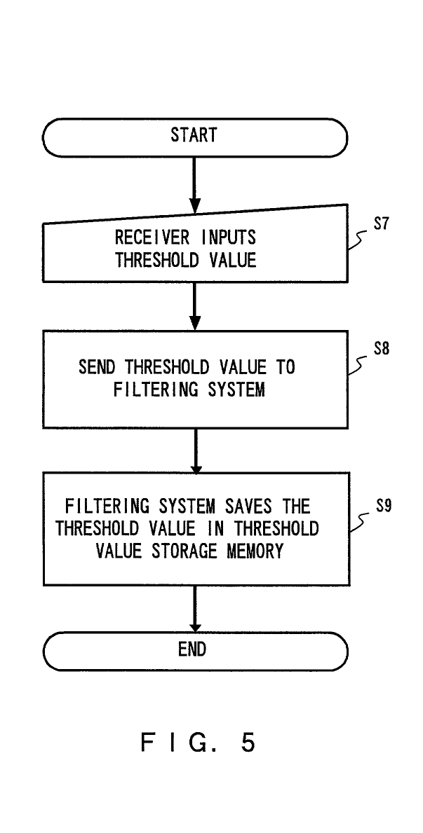

FIG. 5 is a detailed flowchart of the process at the step S1 in FIG. 4, that is, the threshold value setting process. In the drawing, when the process is started, the threshold value is inputted into the receiving system 11 by the receiver at a step S7, the threshold value is sent to the filtering system 18 at a step S8, and the threshold value is stored in the threshold value storage memory 20 at a step S9, at which point the process is finished.

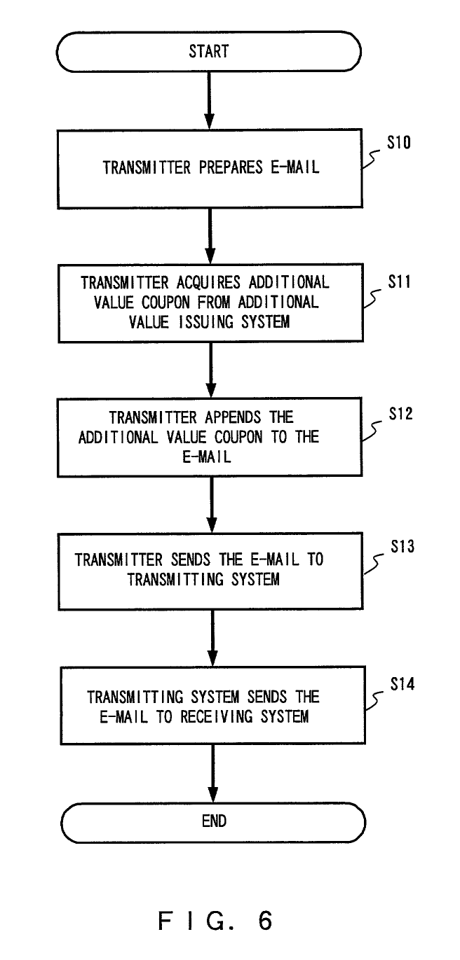

FIG. 6 is a detailed flowchart of the process at the step S2 in FIG. 4, that is, the process of preparing the E-mail to be transmitted. In the drawing, when the process is started, the E-mail is prepared by the transmitter at a step S10, the coupon for the additional value is acquired from the additional value issuing system 12 by the transmitter at a step S11, the additional value coupon is appended to the E-mail by the transmitter at a step S12, the E-mail is sent from the transmitter to the transmitting system 10 at a step S13, and the E-mail with the additional value coupon appended thereto is transmitted from the transmitting system 10 to the receiving system 11 at a step S14, at which point the process is finished.

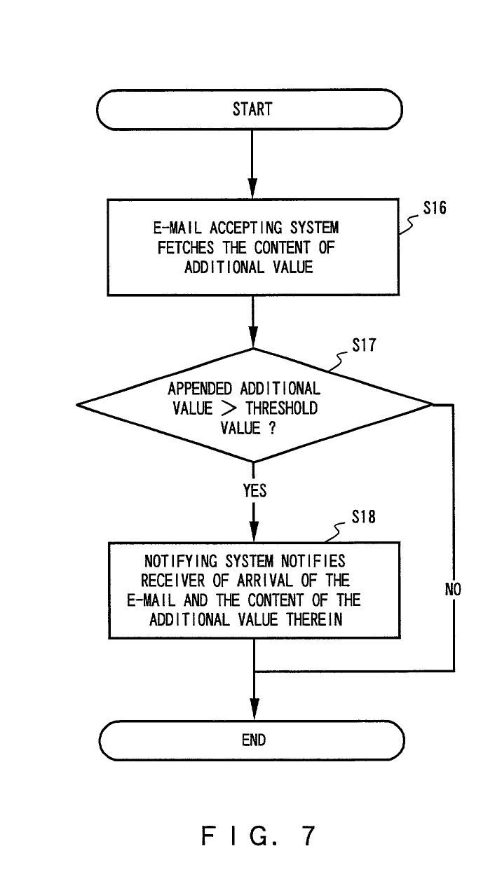

FIG. 7 is a detailed flowchart of the E-mail receiving and notifying process at the step S3 in FIG. 4. In the drawing, when the process is started, the contents of the additional value is fetched by the E-mail accepting system 17 shown in FIG. 3 at a step S16. The filtering system 18 judges whether the additional value appended to the E-mail exceeds the threshold value stored in the threshold value storage memory 20 at a step S17, then, when the additional value exceeds the threshold value, the notifying system 19 notifies the receiver of the arrival of the E-mail and the contents of the additional value at a step S18, and thereafter the process is finished, or when the additional value is less than the threshold value, the process immediately comes to an end.

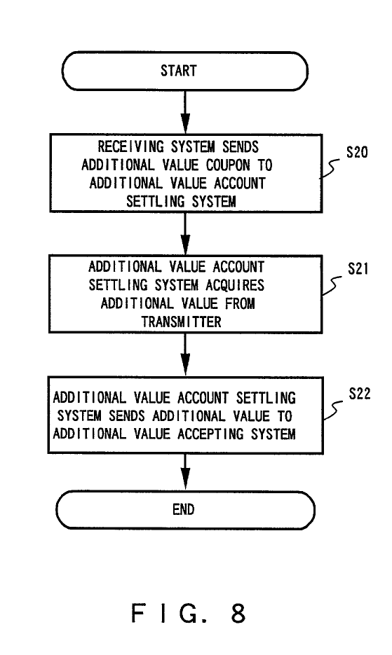

FIG. 8 is a detailed flowchart of the additional value settling process at the step S5 shown in FIG. 4. In the drawing, when the process is started, the additional value coupon is sent to the additional value settling system 13 from the receiving system 11 at a step S20, the additional value such as the cash, the book token or the like is acquired from the transmitter by the additional value settling system 13 at a step S21, the additional value is sent from the additional value settling system 13 to the additional value accepting system 14 at a step S22, and thereafter the process is finished.

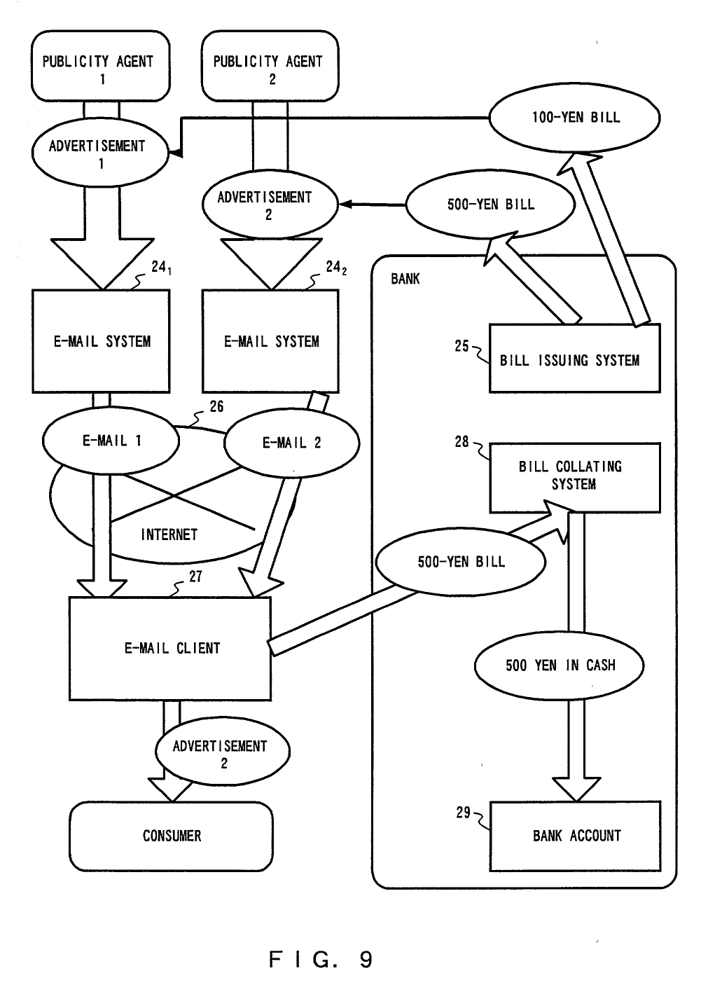

FIG. 9 is an illustration of a concrete example of the first embodiment of the present invention. In this example, the transmitter shown in FIG. 2 corresponds to two publicity agents, likewise, the receiver, a consumer; the transmitting system 10, two E-mail systems 24₁ and 24₂; the receiving system 11, an E-mail client 27; the additional value issuing system 12, a bill issuing system 25 within a bank; the additional value settling system 13, a bill collating system 28; and the additional value accepting system 14, a bank account 29. A bill which is settled on the spot is used as the additional value coupon. Therefore, the contents of the additional value is cashed. For example, in a case that the bill is not settled on the spot, the bill is saved somewhere to be paid into the bank account 29 of the consumer upon settlement. In this case, it is assumed that the E-mail is transmitted via the Internet 26.

First, it is assumed that the consumer sets 200 yen as the threshold value.

Next, the publicity agent 1 prepares an advertisement 1, acquires a bill for 100 yen from the bank, appends the bill to the advertisement 1, and transmits an E-mail 1 with this advertisement 1 to the consumer. Then, the publicity agent 2 prepares an advertisement 2, acquires a bill for 500 yen from the bank, appends the bill to the advertisement 2, and transmits E-mail 2 with this advertisement 2 to the consumer.

The E-mail client 27 which received the E-mail 1 fetches the bill for 100 yen therein. However, because the value of this bill is less than the threshold value, the client does not notify the receiver of its arrival. However, the E-mail client 27 which received the E-mail 2 fetches the bill for 500 yen therein. Because the value of this bill exceeds the threshold value, the E-mail client 27 notifies the consumer of the arrival of the E-mail 2.

After confirmation that the consumer read the advertisement 2 in the E-mail 2, the E-mail client 27 transmits the bill for 500 yen to the bill collating system 28. The bank confirms that the bill thus transmitted is a real one and then pays 500 yen into the bank account 29 of the consumer.

As a result, the consumer reads only the advertisement to which the bill for 200 yen or more is appended, that is, no notification is issued at the arrival of E-mail with no appended additional value or E-mail to which a bill of a value less than 200 yen is appended, and hence the consumer can only read E-mail which is beneficial to him. For the publicity agent, such an advantage is obtained that the agent can surely induce the consumer to read the advertisement thereof selectively from among many pieces of E-mail.

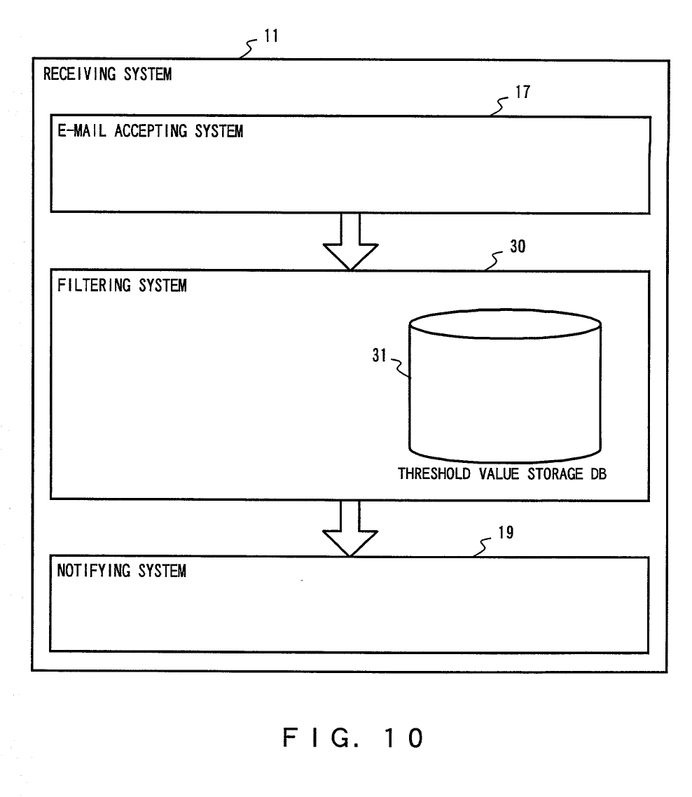

FIG. 10 is a diagram of the detailed structure of the receiving system 11 according to a second embodiment of the present invention. In the succeeding embodiments, aspects different from those in the first embodiment will be described in detail. The fundamental structure of the second embodiment is basically the same as that shown in FIG. 2 for the first embodiment, except that the filtering system 30 within the receiving system 11 is provided with a threshold value storage database 31.

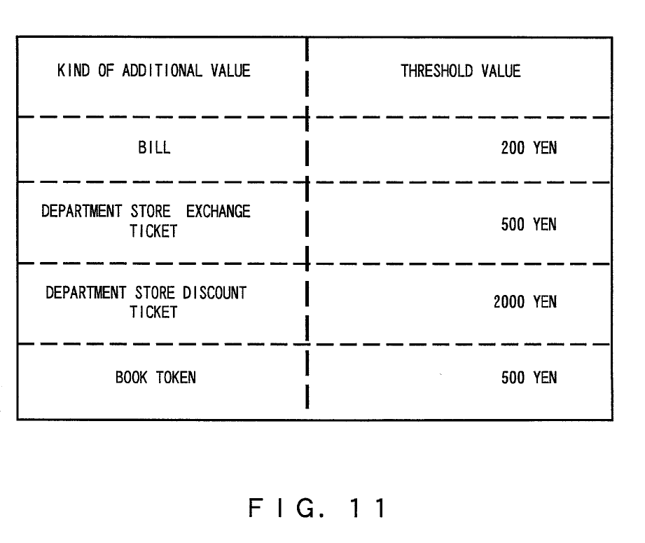

It is assumed that in the second embodiment, with respect to the additional value that the transmitter transmits appended to the E-mail, any of a plurality of kinds of additional values can be used, unlike the first embodiment in which only one kind of additional value can be used. Thus, threshold values set by the receiver will be stored in the threshold value storage database 31 in FIG. 10 separately corresponding to the respective kinds of additional values. FIG. 11 shows the contents stored in the threshold value storage database 31 in which the additional values are classified into four kinds, that is, into a bill, department store exchange ticket, department store discount ticket and book token, and threshold values are set for the respective additional values.

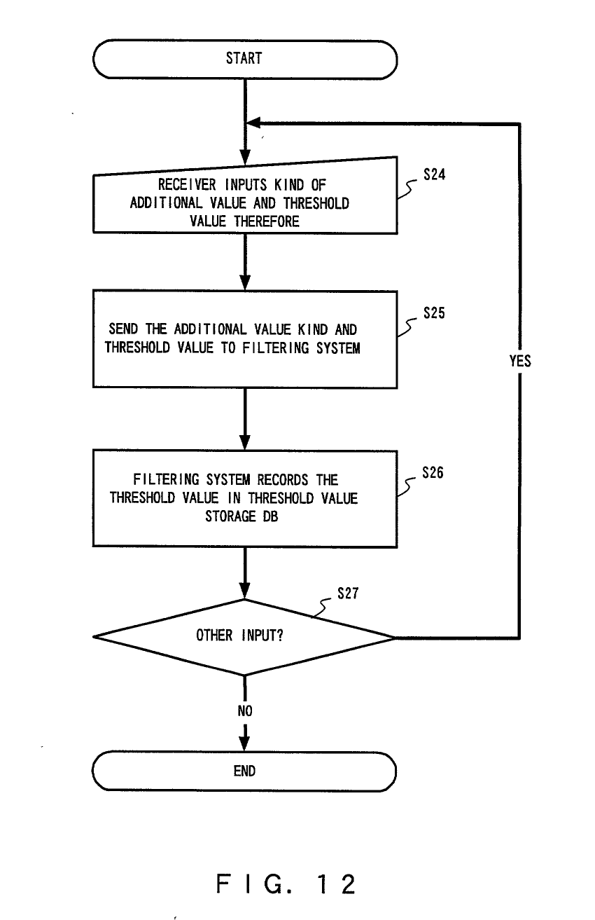

FIG. 12 is a flowchart of the threshold value setting process in the second embodiment. The process shown in FIG. 12 corresponds to the process shown in FIG. 5 for the first embodiment. In the drawing, when the process is started, the kind of additional value and a threshold value corresponding thereto are respectively inputted by the receiver at a step S24, the kind of additional value and the threshold value thus inputted are sent to the filtering system 30 at a step S25, the kind of additional value and the threshold value thus sent are recorded in the threshold value storage database 31 at a step S26, it is judged whether inputting of a threshold value corresponding to another kind of additional value is needed at a step S27, and when needed, the processes at the step S24 and succeeding steps are repeated, or when not needed, the process comes to an end.

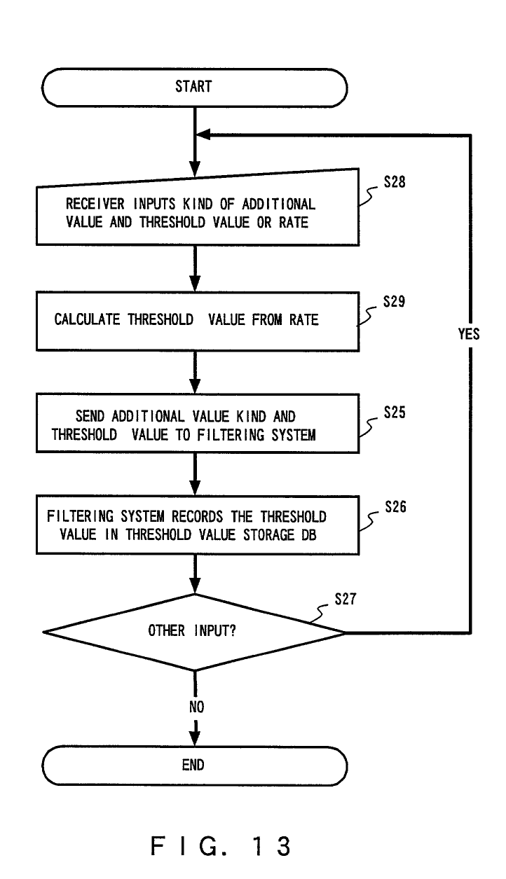

In the second embodiment, instead of setting the respective threshold values for the plurality of kinds of additional values, for example, it is also possible to input one threshold value for one kind of additional value and to input a rate for the threshold value for another kind of additional value. FIG. 13 is a flowchart of the threshold value setting process to be executed in the above case. FIG. 13 differs from FIG. 12 in that while in the FIG. 12, the threshold value corresponding to the kind of additional value is inputted at the step S24, whereas in FIG. 13, the threshold value corresponding to the kind of additional value or the rate to the threshold value is inputted by the receiver at a step S28 and the threshold value is calculated from the value of the rate thus inputted at a step S29.

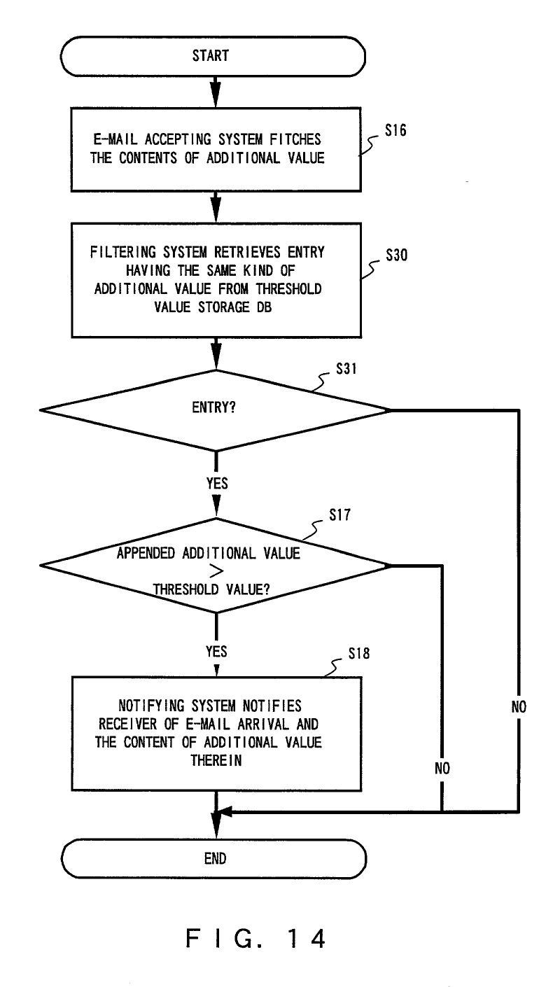

FIG. 14 is a detailed flowchart of the E-mail receiving and notifying process in the second embodiment of the present invention. The process show in FIG. 14 corresponds to the process shown in FIG. 7 for the first embodiment. In comparison with FIG. 7, after the contents of the additional value have been fetched at the step S16, an entry having the same kind of additional value is sought for from the threshold value storage database 31 by the filtering system 30 at a step S30 and it is judged whether the entry was made at a step S31. When the entry is judged to have been made, the processes at the steps S17 and S18, which are the same as those in FIG. 7, are executed, while when there is no entry having the same additional value, the process directly comes to an end.

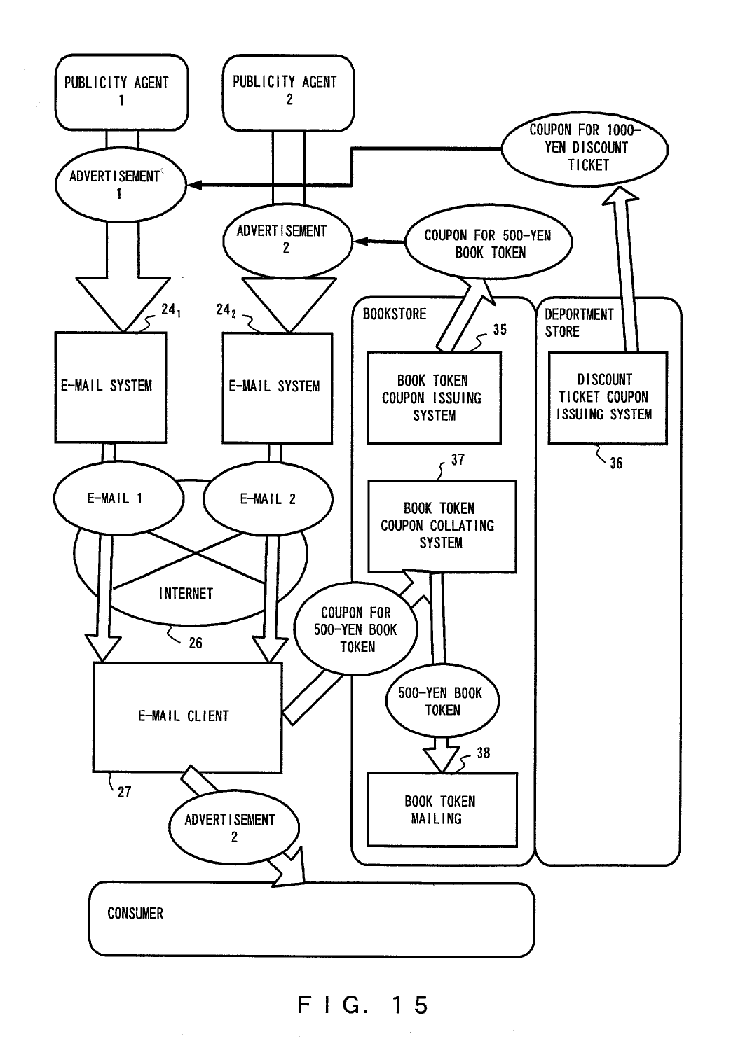

FIG. 15 is a concrete example of the second embodiment of the present invention. In this example, it is also assumed that the transmitter corresponds to the publicity agents 1 and 2 and that the receiver corresponds to a certain consumer. As the additional value coupons, there are employed the book token and the department store discount ticket. As the additional value issuing system 12, a book token coupon issuing system 35 and a discount ticket coupon issuing system 36 are furnished from a bookstore and a department store, respectively. As the additional value accepting system 14, book token mailing 38 to the consumer is adopted. In addition, as the E-mail transmitting/receiving system, a mailing system via the Internet 26 is employed.

First, it is assumed that the consumer sets the bill to 200 yen, sets the department store exchange ticket to 500 yen, sets the department store discount ticket to 2000 yen and sets the book token to 500 yen as the threshold values. The contents in the threshold value database of this case are shown in FIG. 11. Instead of individually setting the threshold values, the same threshold values can be set by designating the bill as 200 yen, designating the department store exchange ticket as 500 yen, designating the exchange rate of the department store ticket to the department store discount ticket as 1:4, and designating the exchange rate of the department store exchange ticket to the book token as 1:1.

Next, the publicity agent 1 prepares an advertisement 1, acquires the coupon for the 1000-yen discount ticket from the department store, appends the coupon to the advertisement 1 and transmits E-mail 1 with this advertisement 1 to the consumer. Then, the publicity agent 2 prepares an advertisement 2, acquires the coupon for the 500-yen book token from the bookstore, appends the coupon to the advertisement 2, and transmits E-mail 2 with this advertisement 2 to the consumer.

The E-mail client 27 which received the E-mail 1 fetches the coupon for the 1000-yen discount ticket therein. However, because this value is less than the threshold value, the notification of the arrival thereof is not issued to the consumer. On the other hand, the E-mail client 27 which received the E-mail 2 fetches the coupon for the 500-yen book token therein. Because this value exceeds the threshold value, the E-mail client 27 notifies the consumer of the arrival of the E-mail 2.

After confirmation that the consumer read the advertisement 2 within the E-mail 2, the E-mail client 27 transmits the coupon for the 500-yen book token to the book token coupon collating system 37 in the bookstore. After it has been confirmed that the coupon thus sent is a real one, the bookstore sends by mail the 500-yen book token to the consumer.

In the above mentioned manner, the consumer can freely set threshold values for the plurality of kinds of additional values and the transmitter can freely select the additional values.

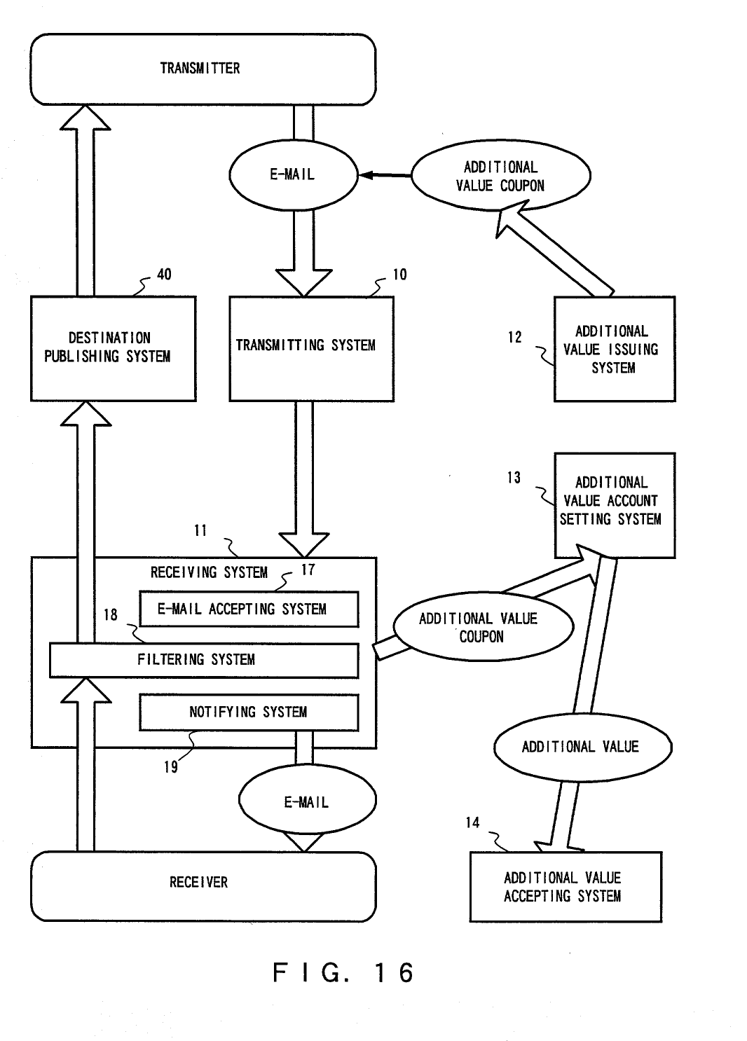

FIG. 16 is a diagram showing the fundamental structure of a third embodiment of the present invention. In comparison with FIG. 2 for the first embodiment, FIG. 16 differs from FIG. 2 only in that a destination publishing system 40 is added. In the third embodiment, the threshold value set by the receiver is made public, so that it becomes possible for the transmitter, for example, to append an additional value exceeding the threshold value to the E-mail to be transmitted to the receiver corresponding to the threshold value thus published.

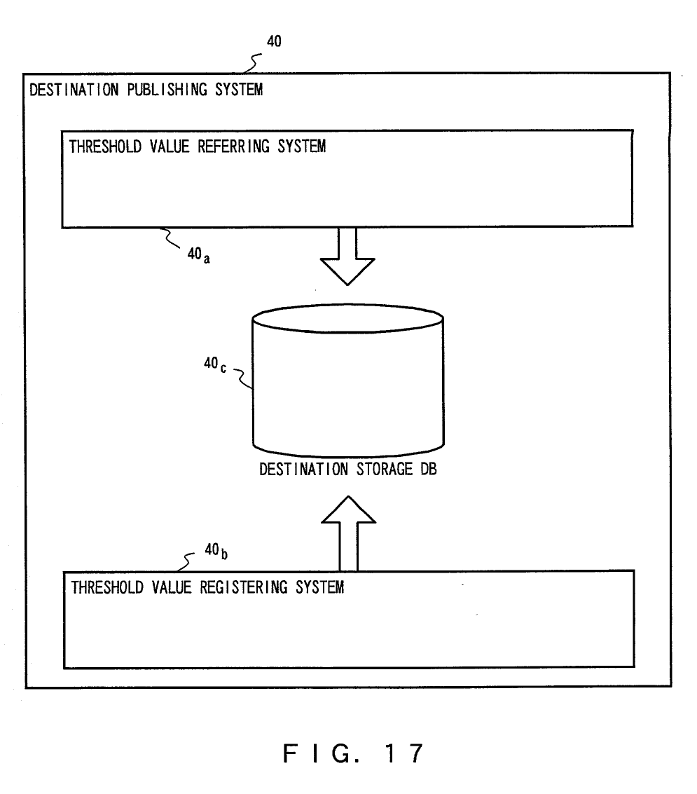

FIG. 17 is a diagram showing the detailed structure of the destination publishing system 40. The destination publishing system 40 comprises a threshold value referring system 40a, a threshold value registering system 40b and a destination storage database 40c.

The threshold value registering system 40b transmits the threshold value sent from the receiving system 11 shown in FIG. 16 together with an address (E-mail address) corresponding to the receiver to the destination storage database 40c, which then stores therein the address and the threshold value. In the case of a plurality of kinds of additional values, addresses, kinds of additional values and threshold values are stored in the destination storage database 40c corresponding to the receiver. The threshold value referring system 40a refers to the contents of the destination storage database 40c and sends the contents to the transmitter. Alternatively, the receiving system 11 may send the threshold values only for some of the plurality of kinds of additional values and the rates for calculating the threshold values for other kinds of additional values to the threshold value registering system 40b such that the threshold value registering system 40b may calculate the threshold values for all kinds of additional values to be stored in the destination storage database 40c.

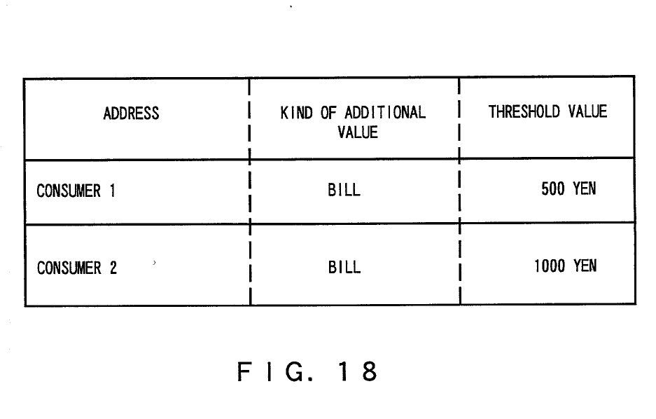

FIG. 18 shows an example of the contents stored in the destination storage database 40c. In this example, addresses, kinds of additional values and threshold values corresponding to the consumers 1 and 2 are stored.

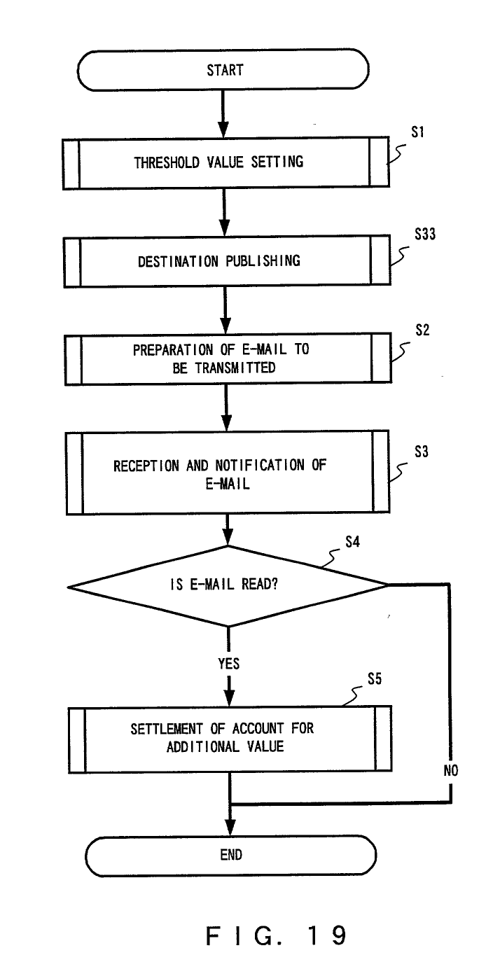

FIG. 19 is a general flowchart of the E-mail transmiting/receiving process in the third embodiment of the present invention. In comparison with FIG. 4 of the first embodiment, FIG. 19 differs from FIG. 4 only in that between the threshold value setting process at the step S1 and the transmitted E-mail preparing process at the step S2, a destination publishing process is executed at a step S33.

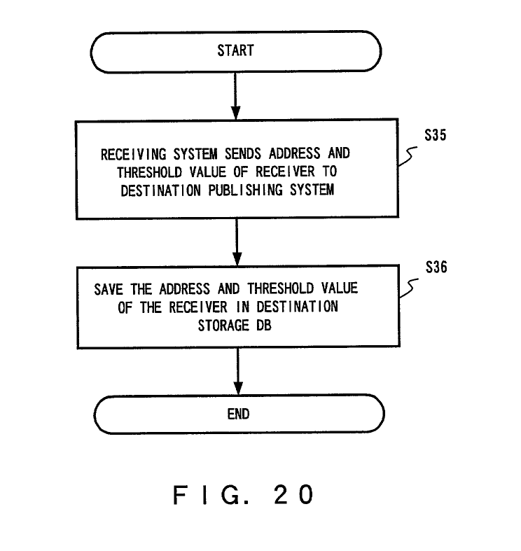

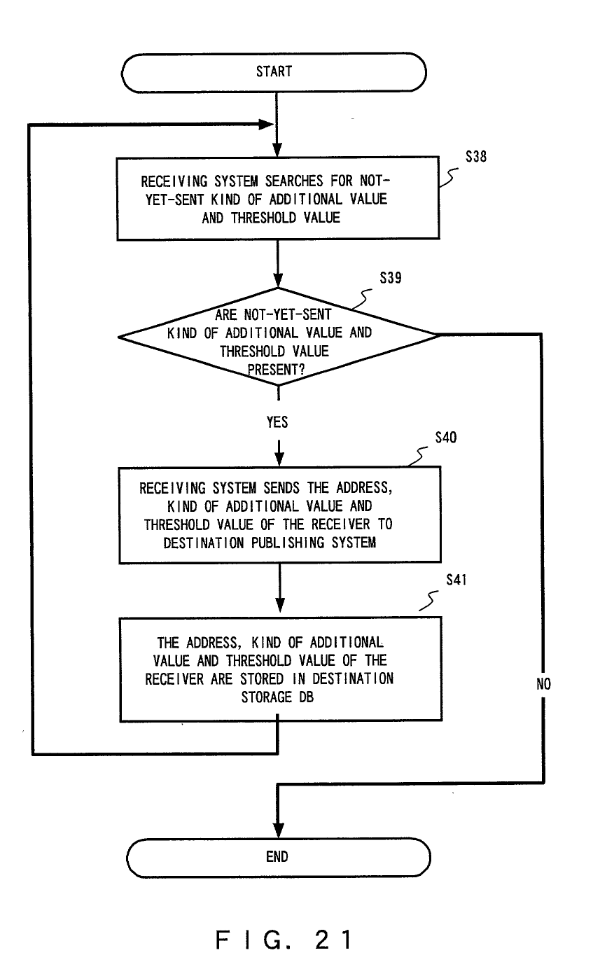

FIGS. 20 and 21 are detailed flowcharts of the destination publishing process. FIG. 20 shows the process in a case that only one kind of additional value is used and FIG. 21 shows the process in a case that the plurality of kinds of additional values are used. In FIG. 20, when the process is started, the address and the threshold value of the receiver are sent from the receiving system 11 to the destination publishing system 40 at a step S35, the address and the threshold value are stored in the destination storage database 40c at a step S36 and then the process is finished.

In FIG. 21 showing the case of the plurality of kinds of additional values, when the process is started, a threshold value corresponding to the kind of the additional value, which is not yet sent to the destination publishing system 40 is sought for by the receiving system 11 at a step S38, it is judged whether an additional value which is not yet sent is present at a step S39, and if it is not present the process directly comes to an end. On the other hand, when the additional value which is not yet sent is present, the address, the kind of the additional value and the threshold value of the receiver are sent from the receiving system 11 to the destination publishing system 40 at a step S40, the address, the threshold value and the kind of the additional value are stored in the destination storage database 40c at a step S41, and the processes at the step S38 and succeeding steps are repeated.

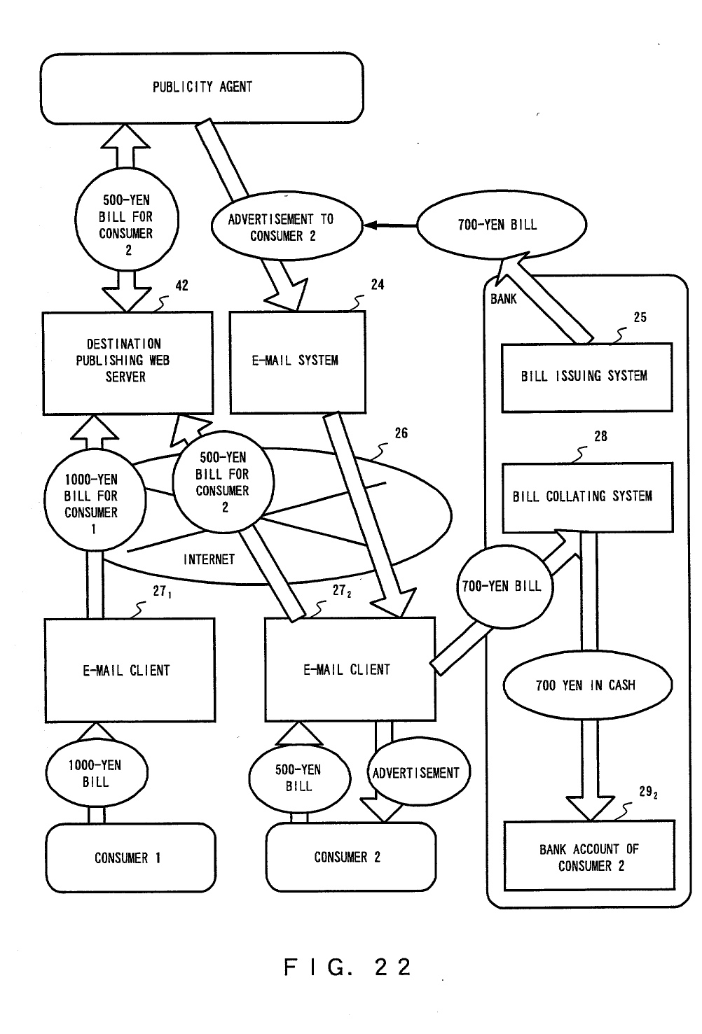

FIG. 22 shows a concrete example of the third embodiment. In this example, it is assumed that the transmitter corresponds to one publicity agent and the receiver corresponds to a certain consumer 1 and a certain consumer 2. Cash is used as the additional value and the bill is used as the coupon for the additional value. A bank provides the additional value issuing system 12 and the additional value settling system 13 as a bill issuing system 25 and a bill collating system 28, respectively and a bank account 29₂ of the consumer 2 is used as the additional value accepting system 14. In addition, a mailing system via the Internet 26 is used as the E-mail transmitting/receiving system and a destination publishing Web server 42 is used as the destination publishing system 40.

First, it is assumed that the consumer 1 sets the bill as the additional value kind and sets 1000 yen as the threshold value, and it is also assumed that the consumer 2 sets the bill as the additional value kind and sets 500 yen as the threshold value. The contents stored in the destination storage database in this case are shown in FIG. 18. In this connection, it is to be noted that when only one kind of additional value is used, the column of the additional value kind is omitted.

Next, it is assumed that the publicity agent acquires a bill for 700 yen from the bank. Then, the publicity agent prepares an advertisement and appends the bill for 700 yen thereto. Then, the publicity agent refers to the destination publishing Web server 42 to seek a receiver to whom the agent can send his advertisement with the 700-yen bill appended thereto. In this case, the corresponding receiver is the consumer 2. Then, the agent transmits a piece of E-mail with this advertisement to the consumer 2. The E-mail client 27₂ receives the E-mail and fetches the 700-yen bill from the E-mail. This bill exceeds the threshold value, so that the client notifies the receiver of the arrival of the E-mail.

After confirmation that the receiver read the advertisement in the E-mail, the E-mail client 27₂ transmits the 700-yen bill to the bill collating system 28. The bank confirms that the bill thus transmitted is a real one and then pays 700 yen into the account 29₂ of the consumer 2.

In the above mentioned manner, it becomes possible for the consumer 1 to read only an advertisement with a bill of a value exceeding 1000 yen appended thereto, and it also becomes possible for the consumer 2 to read only an advertisement with a bill of a value exceeding 500 yen appended thereto. That is, no notification is issued for the arrival of E-mail with no bill appended thereto or E-mail with a bill of the value less than the threshold value and hence it becomes possible for the consumers to read only E-mails beneficial to them, so that the consumers can make their addresses public safely. In addition, for the publicity agent, it becomes possible to select a destination from the published addresses and to induce the consumer to read his advertisement selectively from many pieces of E-mails.

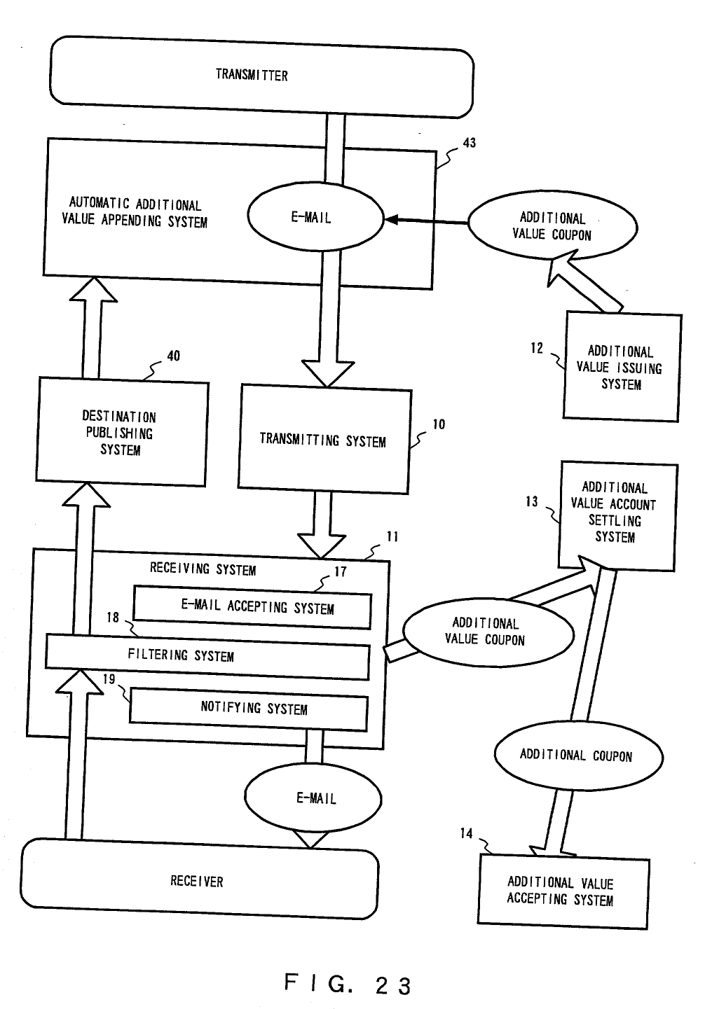

FIG. 23 is a diagram showing the fundamental structure of a fourth embodiment of the present invention. In comparison with FIG. 16 corresponding to the third embodiment, FIG. 23 basically differs from FIG. 16 in that an automatic additional value appending system 43 is futher added in addition to the destination publishing system 40. As described above with reference to the concrete example in FIG. 22, in the third embodiment, there is a possibility that even when a 500-yen bill is made public as the threshold value, an E-mail with a 700-yen bill appended thereto may be transmitted to the receiver. Accordingly, in the fourth embodiment, the transmitter selects a destination of the E-mail from among receivers whose threshold values are made public, and when one receiver is designated, the transmitter transmits the E-mail in a state that an appropriate additional value conforming to this threshold value is appended thereto.

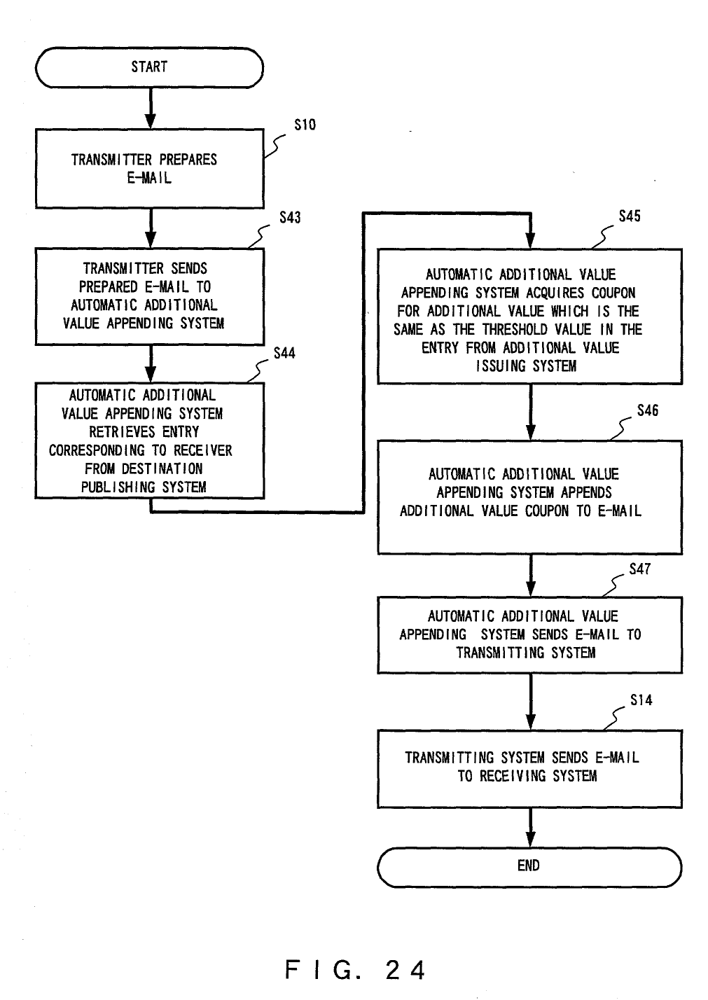

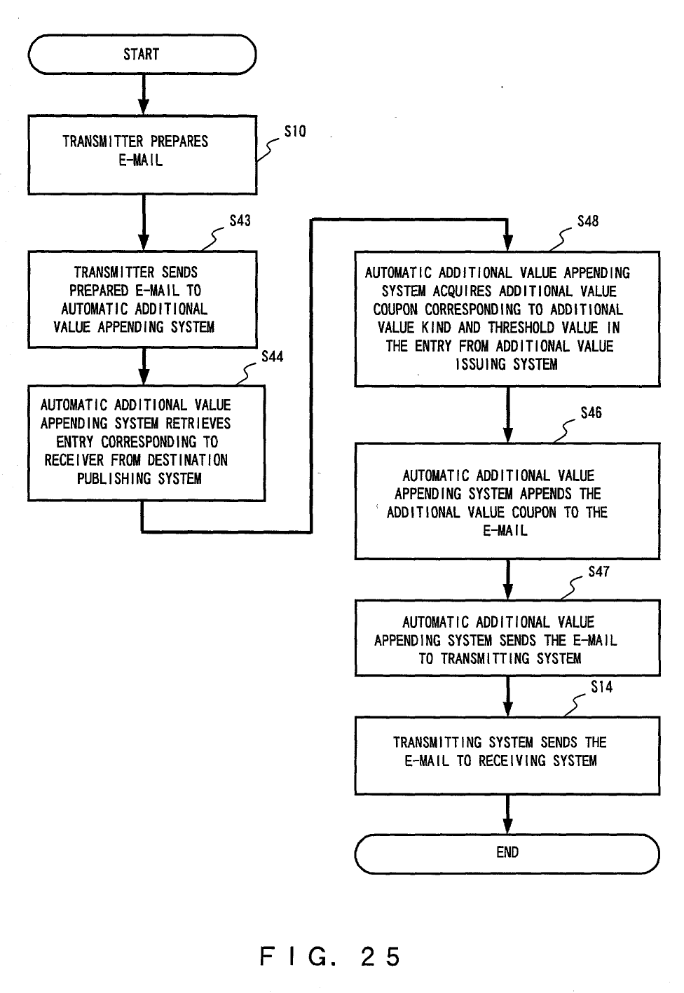

FIGS. 24 and 25 are detailed flowcharts of the E-mail preparing process in the fourth embodiment of the present invention. FIG. 24 is the flowchart of the process in which only one kind of additional value is used and FIG. 25 is the flowchart of the process in which a plurality of kinds of additional values are used.

In comparison with FIG. 6 of the first embodiment, processes at the first step S10 and the last step S14 are the same as those in FIG. 6.

In FIG. 24, after the process at the step S10, the E-mail prepared by the transmitter is sent to the automatic additional value appending system 43 in a state that the receiver is designated at a step S43, an entry corresponding to the receiver is retrieved from the destination publishing system 40 by the automatic additional value appending system 43 at a step S44, an additional value coupon of the value which is the same as the threshold value in the entry thus retrieved is acquired from the additional value issuing system 12 at a step S45, the additional value coupon thus acquired is appended to the E-mail at a step S46, the E-mail is sent to the transmitting system 10 at a step S47, and thereafter the E-mail is transmitted to the receiving system 11 at the step S14 to finish the process.

The process in FIG. 25 showing the case in which the plurality of kinds of additional values are used differs from the process shown in FIG. 24 only in that instead of the step S45 in FIG. 24, the additional value kind and the additional value coupon of the same value as the threshold value in the entry retrieved by the automatic additional value appending system 43 are acquired from the additional value issuing system 12.

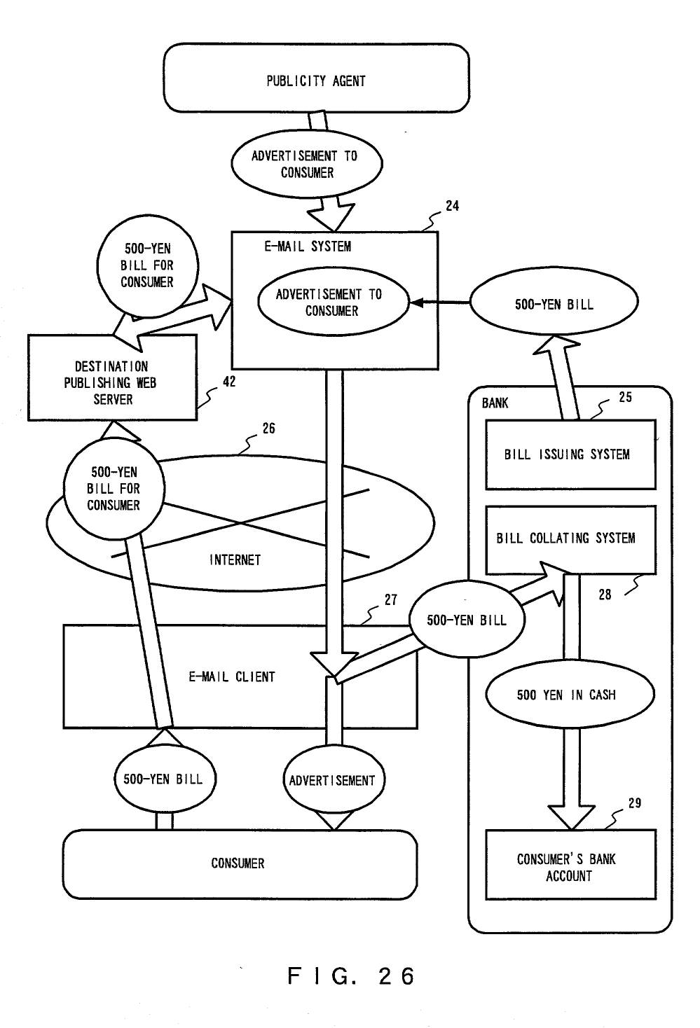

FIG. 26 is a concrete example of the fourth embodiment of the present invention. In this example, it is assumed that the transmitter corresponds to a publicity agent and the receiver corresponds to a certain consumer. In addition, cash is used as the additional value and the bill is used as the additional value coupon. As in the case shown in FIG. 22, the bank provides the additional value issuing system 12 and the additional value settling system 13, and the bank account 29 of the consumer is used as the additional value accepting system 14. In addition, the mailing system via the Internet 26 is used as the E-mail transmitting/receiving system and the destination publishing Web server 42 is used as the destination publishing system 40.

First, it is assumed that the consumer sets the bill as the additional value kind and sets 500 yen as the threshold value.

Next, the publicity agent prepares an advertisement to be transmitted to the consumer and sends it to the E-mail system 24 acting as the automatic additional value appending system. Then, the E-mail system 24 refers to the destination publishing Web server 42 to find that the additional value kind of the consumer is the bill and the threshold value is 500 yen, then it acquires the bill for 500 yen from the bank and appends the bill to the advertisement. Thereafter, the E-mail system 24 transmits E-mail with the advertisement appended to the consumer.

As described above, with the use of the automatic additional value appending system, the transmitter can send the E-mail to the target consumer efficiently.

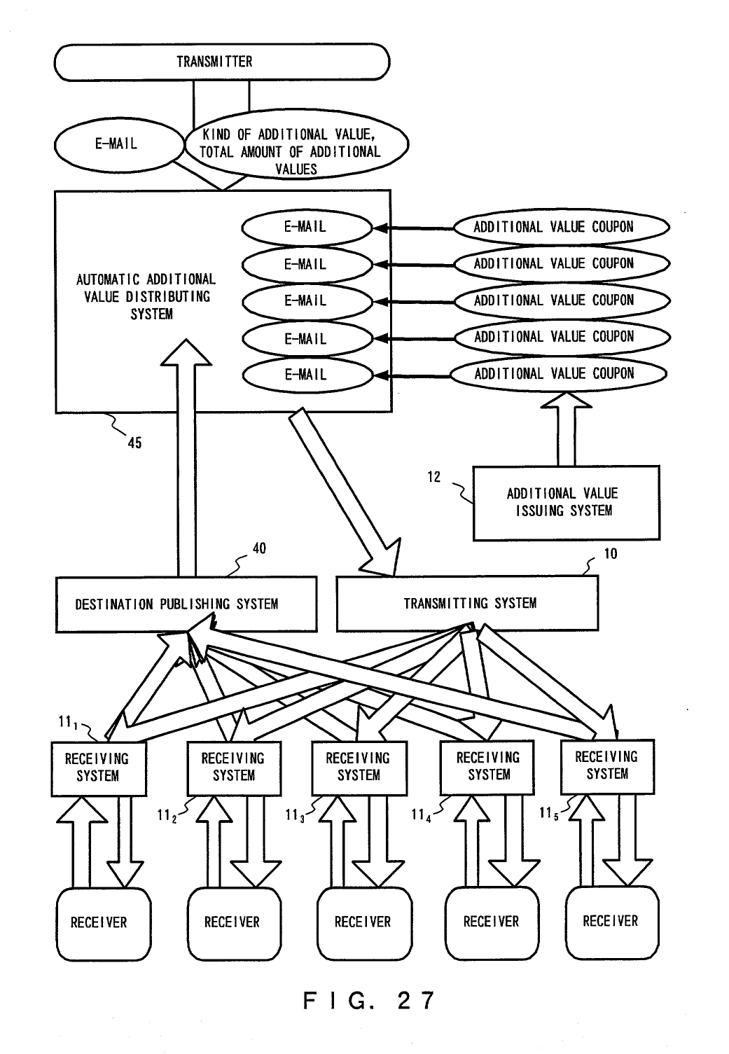

FIG. 27 is a diagram showing, the principle structure of a fifth embodiment of the present invention. In comparison with FIG. 23 for the fourth embodiment, FIG. 27 differs from FIG. 23 in that an automatic additional value distributing system 45 is provided, basically in place of the automatic additional value appending system 43. In addition, a plurality of receiving systems 111 to 115 are provided corresponding to a plurality of receivers. In this connection, it is to be noted that although the additional value settling system and the additional value accepting system are omitted in the drawing, it is apparent that these systems are indispensable to this embodiment as in the case shown in FIG. 23.

In the fifth embodiment, the total amount of the additional values issued by the additional value issuing system 12 is fixed and an operation in which this total amount is distributed to as many receivers as possible so as to transmit E-mail thereto is executed. That is, the automatic additional value distributing system 45 refers to kinds of additional values and threshold values which are made public by the destination publishing system 40 and which correspond to the plurality of receivers, distributes the total amount of additional values issued by the additional value issuing system 12 thereto, appends additional value coupons to individual pieces of E-mail, and transmits the E-mail to the receiving systems 11₁ to 11₅ via the transmitting system 10 so as to induce as many receivers as possible to read the E-mail.

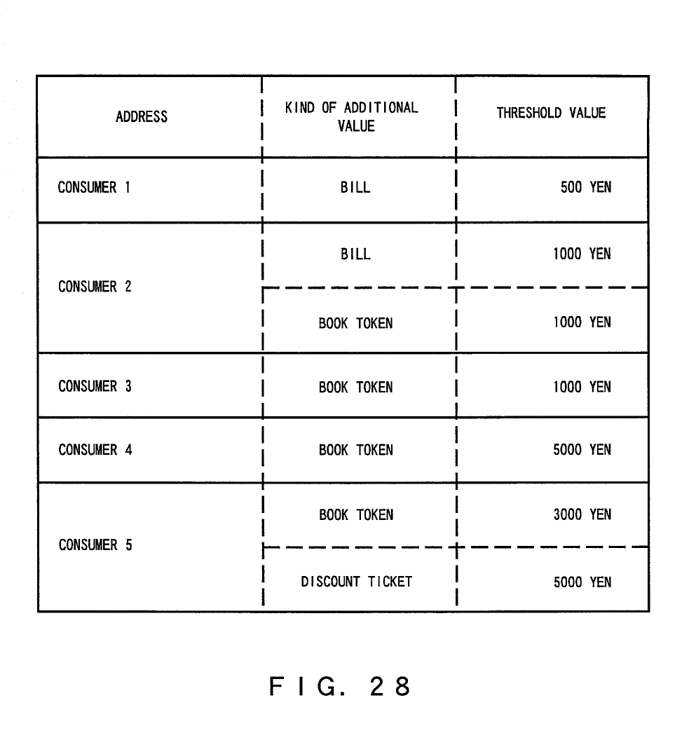

FIG. 28 shows an example of data stored in the destination storage database 40c provided in the destination publishing system 40. As shown in the drawing, addresses, kinds of additional values and threshold values for the plurality of consumers 1 to 5 are stored and threshold values for a plurality of kinds of additional values are stored for some consumers.

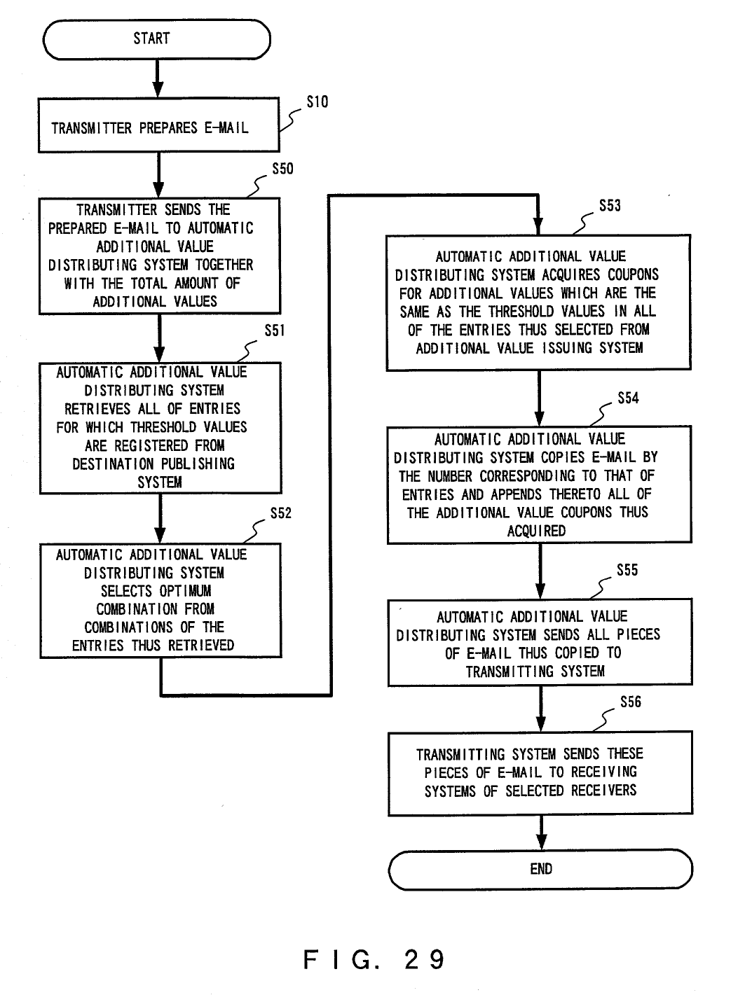

FIG. 29 is a detailed flowchart of the E-mail preparing process in the fifth embodiment of the present invention. This flowchart is for the case that only one kind of additional value is used. In the flowchart, as in the case shown in FIG. 25 for the fourth embodiment, the processes at the first step S10 and the last step S56 are the same as those in the first embodiment.

After the process at the step S10, the E-mail prepared by the transmitter is delivered to the automatic additional value distributing system 45 together with the total amount of additional values at a step S50, entries for which threshold values are stored are retrieved by the automatic additional value distributing system 45 from the destination publishing system 40 at a step S51, an optimum combination of the retrieved threshold values, for example, an combination such that additional values exceeding the threshold values can be distributed to the maximum number of receivers is selected from the combinations of the threshold values for the retrieved entries at a step S52, coupons for additional values which are the same as the threshold values in all of the entries thus selected are acquired from the additional value issuing system 12 at a step S53, the E-mail is copied by the number corresponding to the number of entries and all of the additional value coupons thus acquired are appended to the individual pieces of E-mail thus copied at a step S54, all pieces of the E-mail are transmitted to the transmitting system 10 at a step S55, and these pieces of E-mail are transmitted from the transmitting system 10 to the receiving systems of the selected receivers at a step S56 to finish the process.

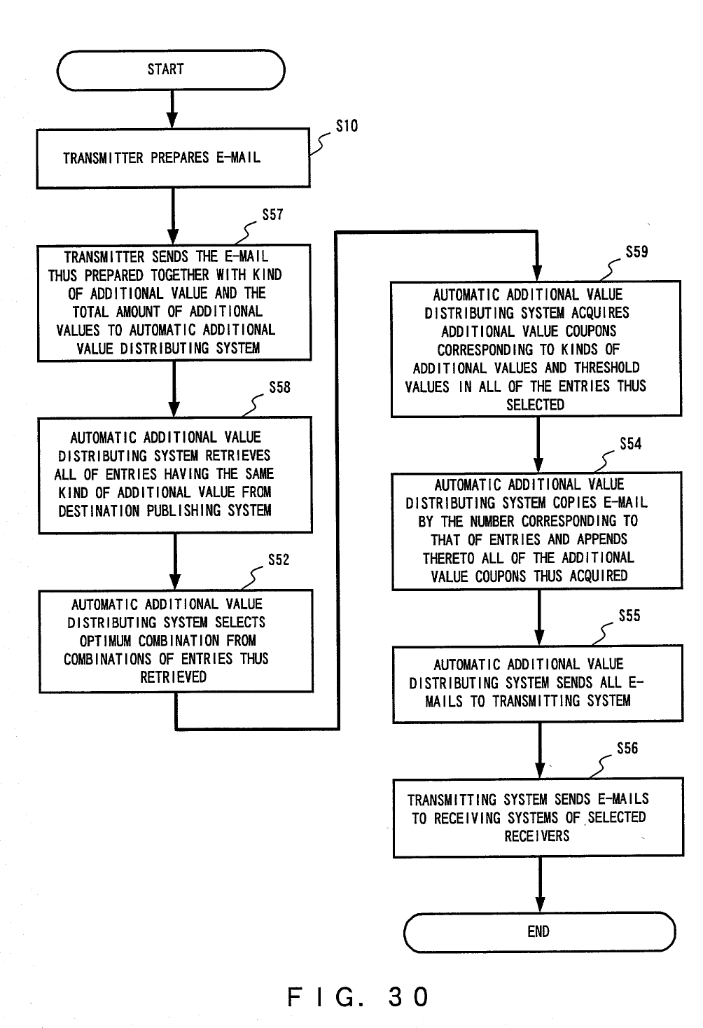

FIG. 30 is a detailed flowchart of the E-mail preparing process in the fifth embodiment of the present invention in a case that a plurality of kinds of additional values are used. In comparison with FIG. 29 for the case in which only one kind of additional value is used, FIG. 30 differs from FIG. 29 in that the kinds of additional values are delivered to the automatic additional value distributing system 45 in addition to the total amount of additional values at a step S57 corresponding to the step S50, all of the entries having the same kind of additional value are retrieved at a step S58 corresponding to the step S51, and coupons of additional values corresponding to the additional value kind and the threshold values in all of the selected entries are acquired from the additional value issuing system 12 at a step S59 corresponding to the step S53.

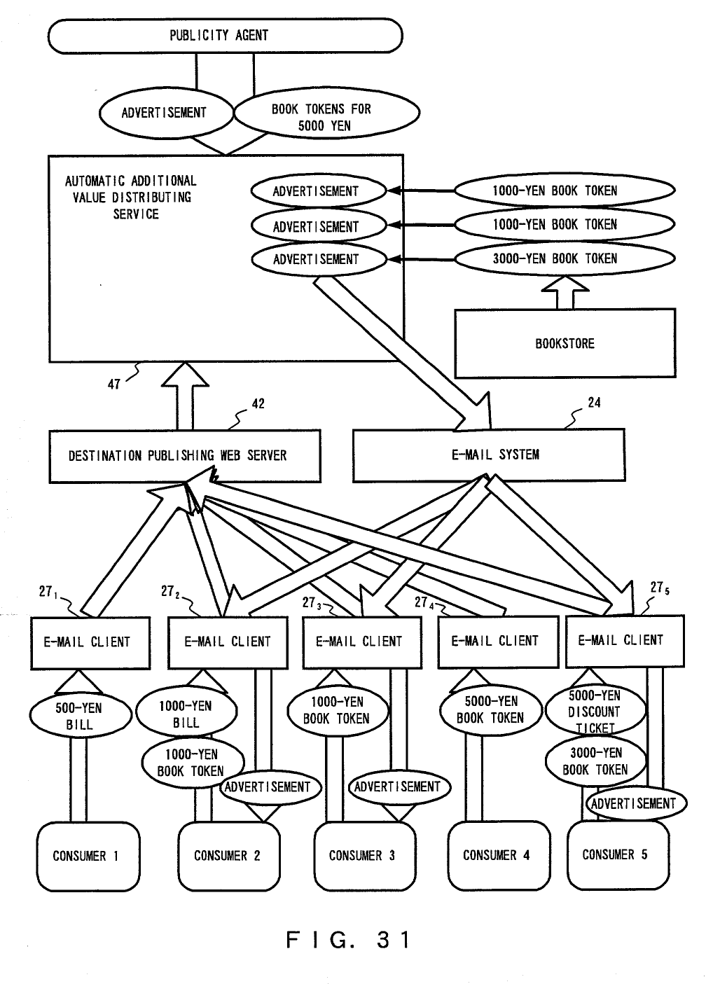

FIG. 31 shows a concrete example of the fifth embodiment of the present invention. In this example, it is assumed that the transmitter corresponds to a publicity agent and the receivers corresponds to a consumer 1, a consumer 2, a consumer 3, a consumer 4 and a consumer 5. The book token is used as the additional value and the destination publising Web server 42 is used as the destination publishing system 40.

It is assumed that the consumer 1 sets the threshold value of the bill to 500 yen, the consumer 2 sets the threshold value of the bill to 1000 yen and sets the threshold value of the book token to 1000 yen, the consumer 3 sets the threshold value of the book token to 1000 yen, the consumer 4 sets the threshold value of the book token to 5000 yen, and the consumer 5 sets the threshold value of the discount ticket to 5000 yen and sets the threshold value of the book token to 3000 yen. The destination storage database (DB) for this case is shown in FIG. 28.

Next, after preparation of an advertisement, the publicity agent uses the book token as the additional value and designates the total amount thereof as 5000 yen, and accesses an automatic additional value distributing service 47. The automatic additional value distributing service 47 refers to the destination publishing Web server 42 to calculate an optimum combination of receivers in which transmission can be realized with the book tokens totaling 5000 yen. In this embodiment, the Greedy algorithm in which allocation is started with an object having the smallest threshold value is employed as an argorithm. In this case, it is optimum to send the book tokens to the consumer 2, the consumer 3 and the consumer 5. Thus, the automatic additional value distriuting service 47 transmits, from the bookstore, the advertisement appended to the book token for 1000 yen to the consumer 2, the advertisement appended to the book token for 1000 yen to the consumer 3, and the advertisement appended to the book token for 3000 yen to the consumer 5.

As described above, with the use of the automatic additional value distributing service 47, there can be realized the most efficient transmission of advertisement by utilizing the limited additional value. This automatic additional value distributing service is installed independently of the publicity agent, by which the distributing service can be established as an independent business, and hence the threshold values which are made public by the receivers can be kept secret from the publicity agent and the publicity agent can save time and labor to append the book token coupons and the like to the advertisements.

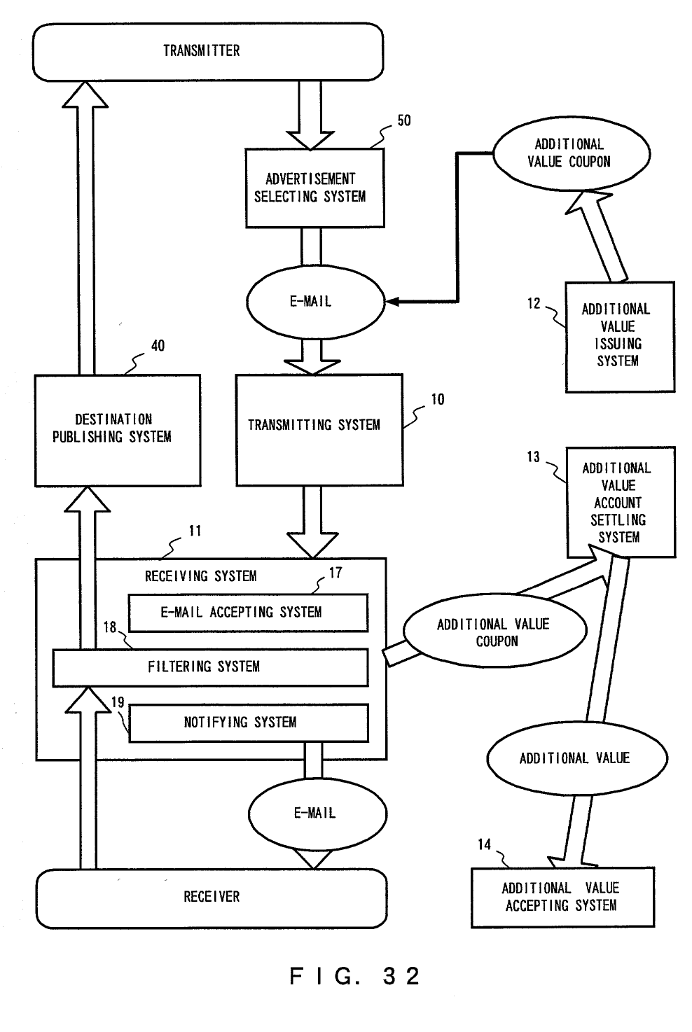

FIG. 32 is a diagram showing the fundamental structure of a sixth embodiment of the present invention. In comparison with FIG. 16 of the third embodiment, FIG. 32 differs from FIG. 16 in that there is provided an advertisement selecting system 50 between the transmitter and the transmitting system 10. In the sixth embodiment, such operations are performed that an advertisement which is considered to be requested from a receiver is selected in accordance with the kind of additional value which is made public by the receiver and a piece of E-mail to which a coupon for the additional value is appended together with the advertisement is transmitted to the receiver.

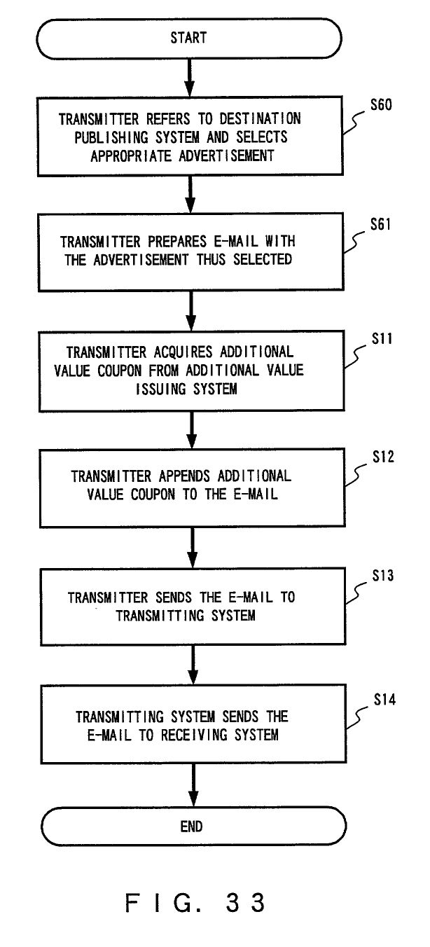

FIG. 33 is a detailed flowchart of the E-mail preparing process in the sixth embodiment of the present invention. In comparison, for example, with FIG. 6 of the first embodiment, FIG. 33 differs from FIG. 6 in that before the processes at the steps S11 to S14 in FIG. 6, processes are executed at steps S60 and S61. At the step S60, the transmitter refers to the contents stored in the destination storage database 40c within the destination publishing system 40 to select an advertisement suitable to the receiver, and then at the step S61, a piece of E-mail with the advertisement thus selected is prepared. Thereafter, the processes at the step S11 and succeeding steps are executed.

In the destination storage database 43, the kinds of additional values corresponding to the respective consumers as described with reference to FIG. 28 are stored. In general, it is not always easy to determine what kind of advertisement is wanted by each consumer and hence various methods are now under investination. In the present invention, as one embodiment, in a case that the consumer designates, for example, the book token as the kind of additional value, it is considered that the consumer is in need of the advertisement of a bookstore and in a case that the customer designates, for example, the department store discount ticket, it is considered that the customer is in need of the advertisement of a department store, based on which advertisement is selected.

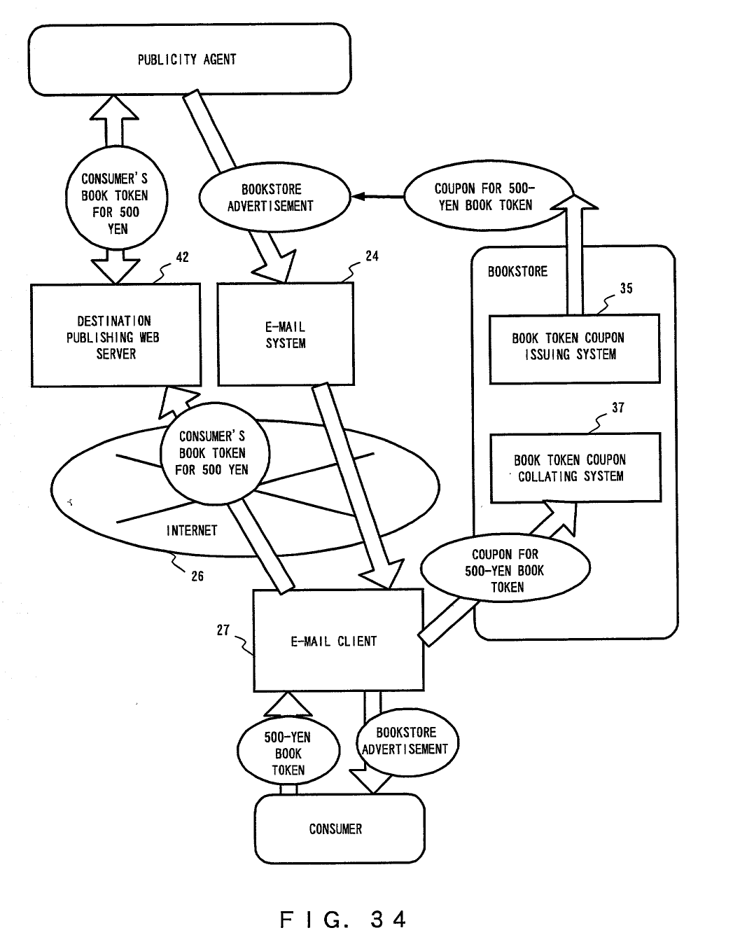

FIG. 34 is a conrete example of the sixth embodiment of the present invention. In this example, it is assumed that the transmitter corresponds to a publicity agent and the receiver corresponds to a certain consumer. As the additional value, the book token is used. The mailing system via the Internet 26 is used as the E-mail transmitting/receiving system and the destination publishing Web server 42 is used as the destination publishing system 40.

First, it is assumed that the consumer sets the book token as the kind of additional value and sets 500 yen as the threshold value.

Next, the publicity agent prepares a piece of E-mail to be transmitted to the consumer in the form of an advertisement of the bookstore because the book token is designated as the kind of additional value, acquires a 500-yen coupon for the book token from the bookstore depending on the designated kind of additional value, appends the coupon to the advertisement and transmits the E-mail with this advertisement to the consumer.

As described above, by selecting the advertisement to be transmitted depending on the kind of additional value thus published, the suitable advertisement can be transmitted to the target consumer as the E-mail with no waste.

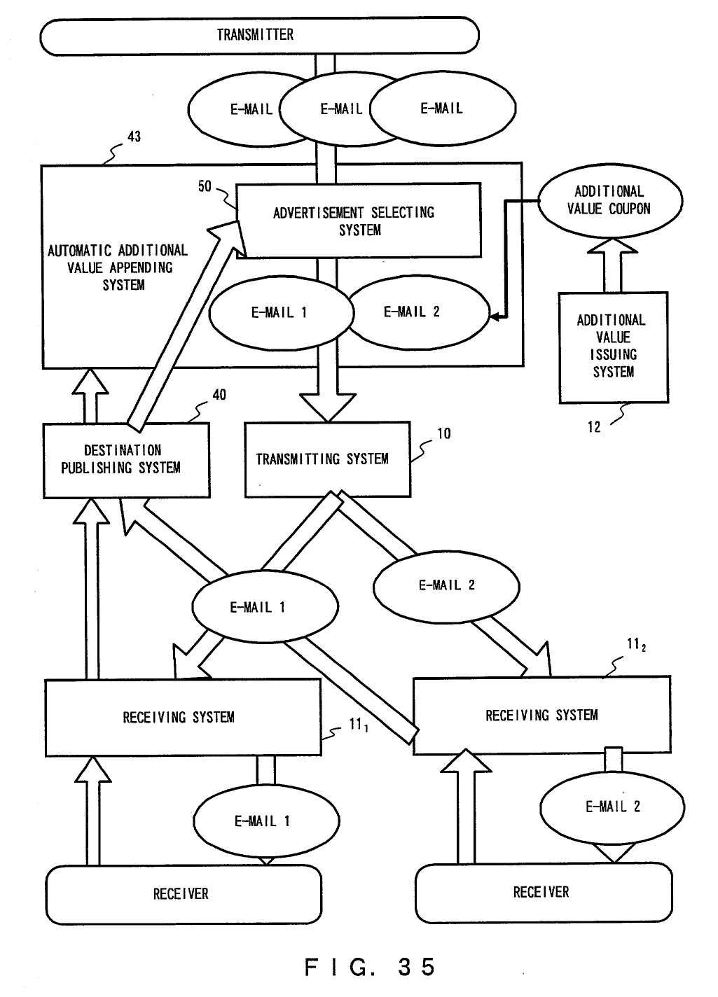

FIG. 35 is a diagram showing the fundamental structure of a seventh embodiment of the present invention. In comparison, for example, with FIG. 23 for the fourth embodiment, FIG. 35 basically differs from FIG. 23 in that within the automatic additional value appending system 43, there is provided the advertisement selecting system 50 which is the same as that in the sixth embodiment. In this connection, it is to be noted that in FIG. 35, the additional value settling system and the additional value accepting system are omitted and a plurality of receiving systems are provided for a plurality of consumers.

In this seventh embodiment, as in the case in the fourth embodiment, in addition to the operation of automatically appending the additional value coupon having the same value as the threshold value designated by the receiver, an advertisement is selected corresponding to the kind of additional value as in the case in the sixth embodiment and the additional value coupon is appended to the advertisement thus selected to be transmitted to the receiver as the E-mail.

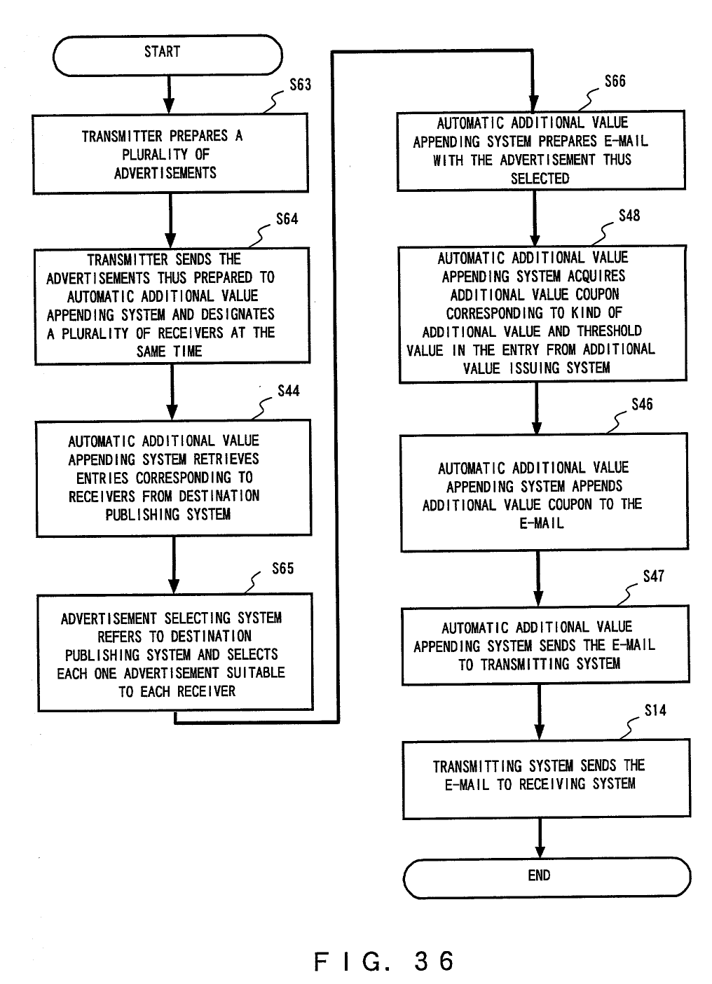

FIG. 36 is a detailed flowchart of the E-mail preparing process in the seventh embodiment. In comparison with FIG. 25 for the fourth embodiment, FIG. 36 differs from FIG. 25 in that instead of the steps S10 and S43 in FIG. 25, first, a plurality of advertisements are prepared by the transmitter at a step S63 and then the advertisements thus prepared are delivered to the automatic additional value appending system 43 at a step S64 and, simultaneously therewith, the plurality of receivers are designated.

After the process at the step S44, in the embodiment shown in FIG. 36, the contents of the destination storage database 40c in the destination publishing system 40 are referred to by the advertisement selecting system 50 and each suitable advertisement is selected corresponding to the kind of additional value for each of the plurality of receivers, each piece of E-mail with each advertisement thus selected is prepared at a step S66, and thereafter the processes at the step S48 and succeeding steps are executed in the same manner as that shown in FIG. 25.

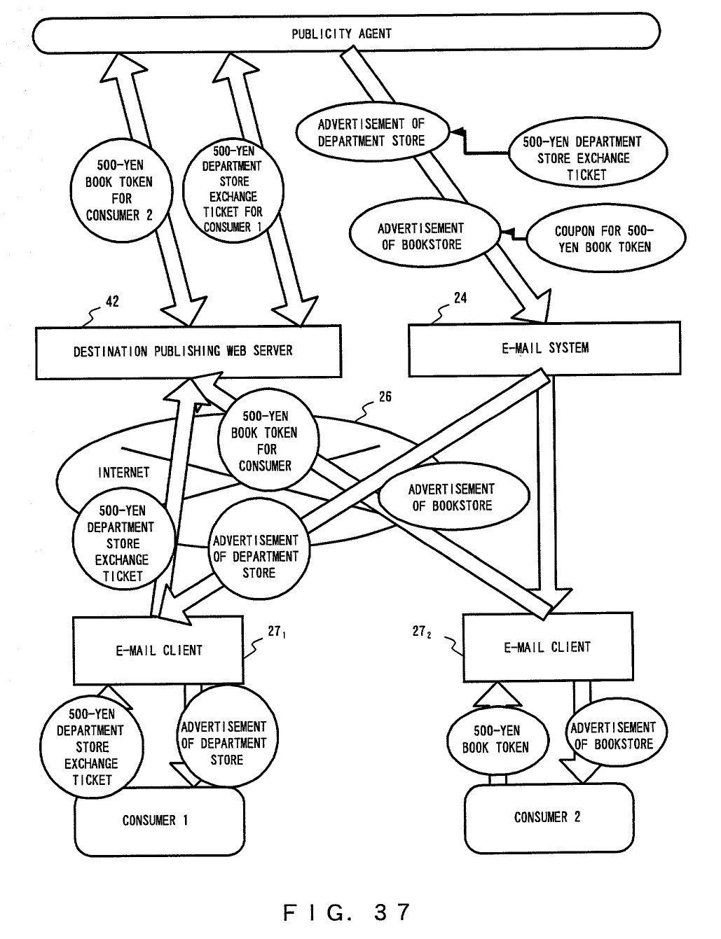

FIG. 37 is a concrete example of the seventh embodiment of the present invention. In this example, it is assumed that the transmitter corresponds to a publicity agent and the receiver corresponds to a consumer 1 and a consumer 2. In addition, the mailing system via the Internet 26 is used as the E-mail transmitting/receiving system, and the destination publishing Web server 42 is used as the destination publishing system.

First, it is assumed that the consumer 1 sets the department store exchange ticket as the kind of additional value and sets 500 yen as the threshold value and the consumer 2 sets the book token as the kind of additional value and sets 500 yen as the threshold value.

Next, the publicity agent prepares advertisements of a department store, a bookstore and a movie and delivers them to the automatic additional value appending system (in this example, installed on the side of the publicity agent), which is not shown. Then, the automatic additional value appending system refers to the destination publishing Web server 42. Since the kind of additional value of the consumer 1 is the department store exchange ticket, the automatic additional value appending system selects the advertisement of the department store, acquires the exchange ticket for 500 yen from the department store and appends it to the advertisement of the department store. Then, the automatic additional value appending system transmits E-mail 1 with this advertisement to the consumer 1 via the E-mail system 24. Likewise, since the kind of additional value of the consumer 2 is the book token, the automatic additional value appending system selects the advertisement of the bookstore, acquires the book token for 500 yen from the bookstore and appends it to the advertisement of the bookstore. Then, the automatic additional value appending system transmits E-mail 2 with this advertisement to the consumer 2 via the E-mail system 24.

As described above, by using the automatic additional value appending system, the optimum advertisement can be transmitted to the target consumer as the E-mail with no waste.

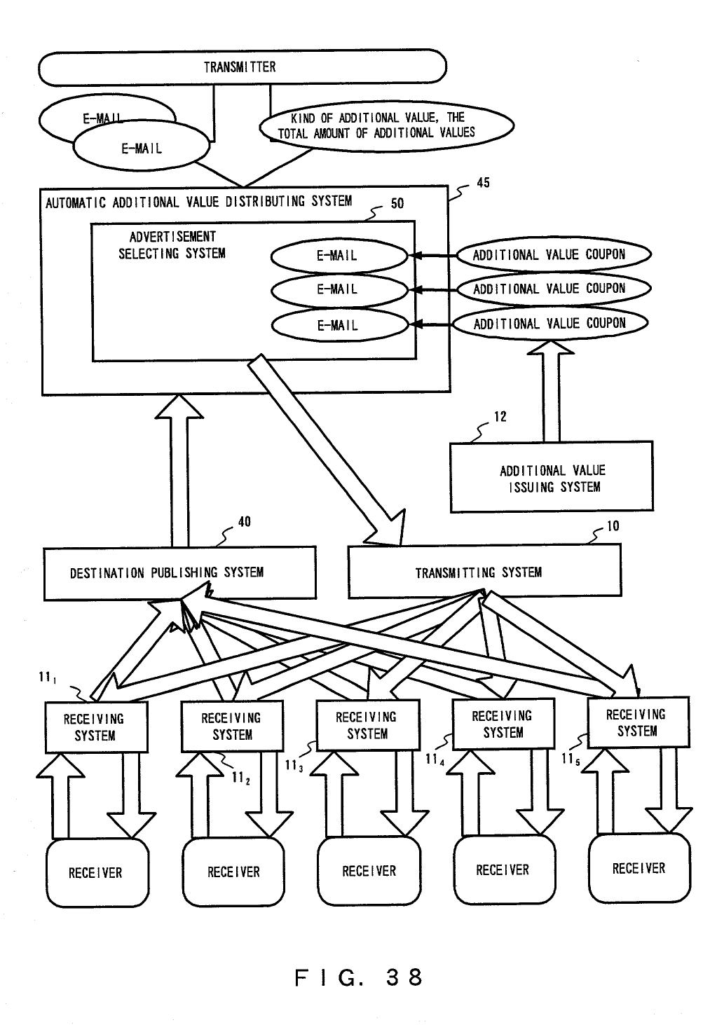

FIG. 38 is a diagram showing the fundamental structure of an eighth embodiment of the present invention. In comparison with FIG. 27 for the fifth embodiment, FIG. 38 basically differs from FIG. 27 in that within the automatic additional value distributing system 45, there is provided the advertisement selecting system 50. In the eighth embodiment, as in the case in the fifth embodiment, the total amount of the additional values is fixed. For example, E-mail transmission is conducted such that the additional value can be distributed to the maximum number of receivers, an advertisement suitable to the kind of additional value is selected by the selecting system 50 corresponding to the kind of additional value designated by each receiver and the advertisement with the coupon for the additional value appended thereto is transmitted to each receiver as the E-mail.

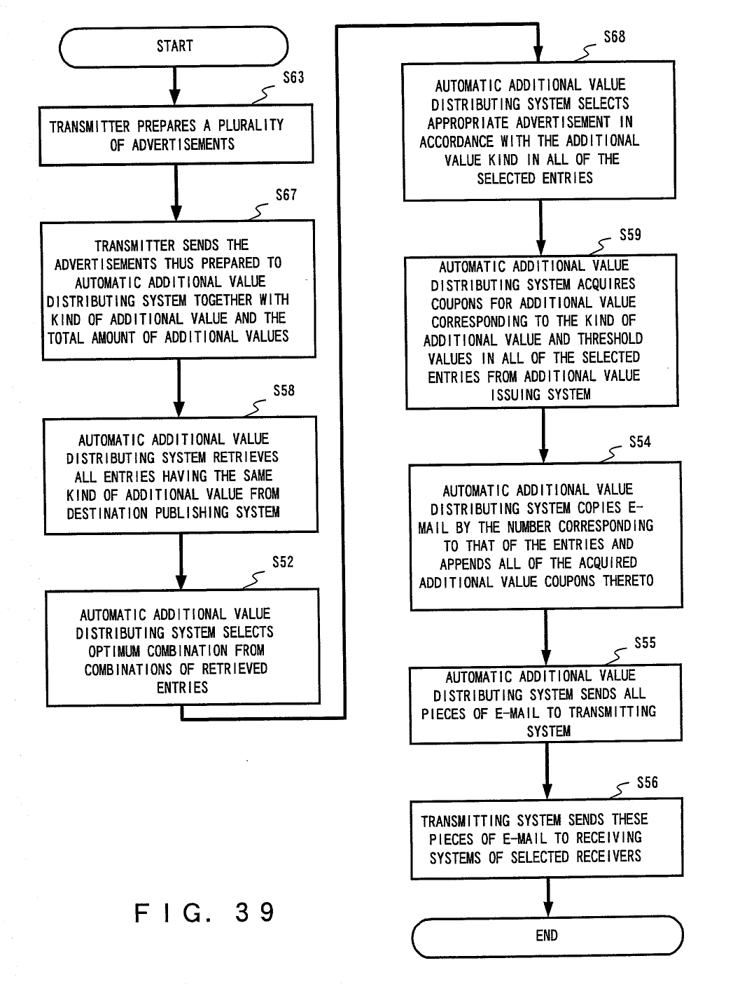

FIG. 39 is a detailed flowchart of the E-mail preparing process in the eighth embodiment of the present invention. In comparison with FIG. 30 for the fifth embodiment, in place of the first step S10, a plurality of advertisements are prepared by the transmitter at a step S63, the advertisements thus prepared are delivered to the additional value distributing system 45 together with the kind of additional value and the total amount of the additional values at a step S67 in place of the step S57, and the processes are executed at the steps S58 and S52 in the same manner as the above. Before the process at the step S59, suitable advertisements are selected by the advertisement selecting system 50 corresponding to the kinds of additional values in all the entries selected by the automatic additional value distributing system 45 at a step 68, and then the processes at the step S59 and succeeding steps are executed.

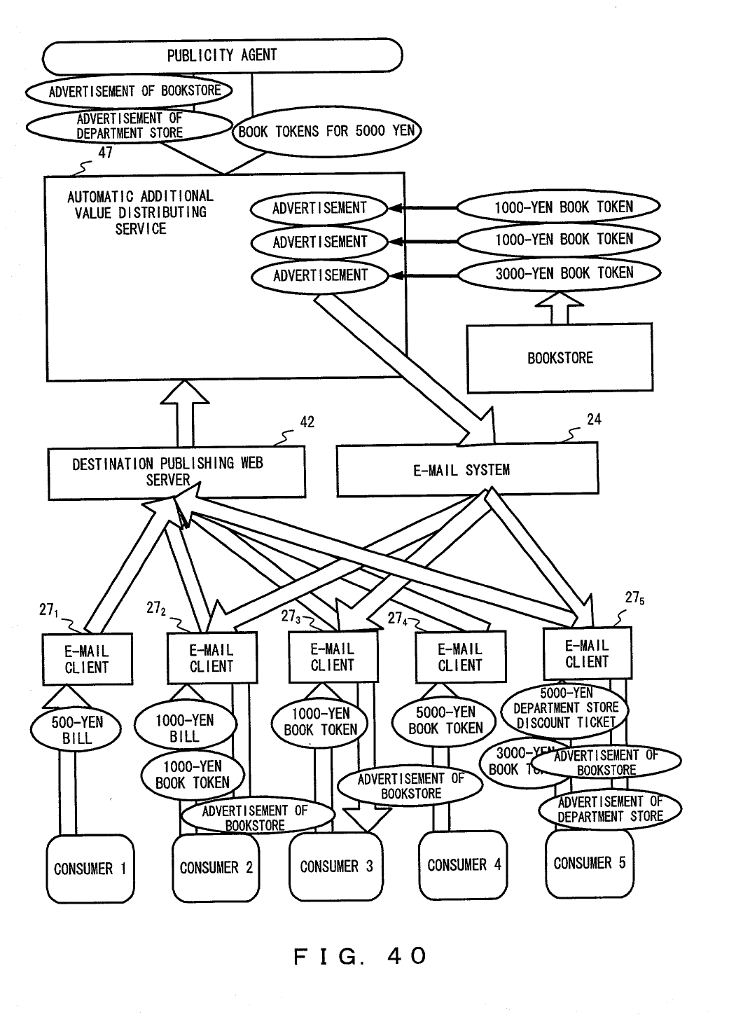

FIG. 40 is a concrete example of the eighth embodiment of the present invention. In this example, it is assumed that the transmitter corresponds to a publicity agent and the receiver corresponds to a consumer 1, a consumer 2, a consumer 3, a consumer 4 and a consumer 5. The book token is used as the additional value and the destination publishing Web server 42 is used as the destination publishing system 40.

It is assumed that the consumer 1 sets the threshold value of the bill to 500 yen, the consumer 2 sets the threshold value of the bill to 1000 yen and sets the threshold value of the book token to 1000 yen, the consumer 3 sets the threshold value of the book token to 1000 yen, the consumer 4 sets the threshold value of the book token to 5000 yen, and the consumer 5 sets the threshold value of the department store discount ticket to 5000 yen and sets the threshold value of the book token to 3000 yen.

Next, after preparation of the advertisements of the bookstore and the department store, the publicity agent uses the book token as the additional value, designates its total amount as 5000 yen and accesses the automatic additional value distributing service 47.

In this example, the optimum receiver is a combintion of the consumer 2, the consumer 3 and the consumer 5, as in the case in FIG. 31 for the fifth embodiment. However, as to the advertisement to be transmitted to the consumer 5, it is found that it is optimum to transmit not only the advertisement of the bookstore but also the advertisement of the department store because the consumer 5 makes the department store discount ticket public together with the book token.

As described above, with the use of the automatic additional value distributing service 47, the most efficient transmission of an advertisement can be realized with the limited additional value.

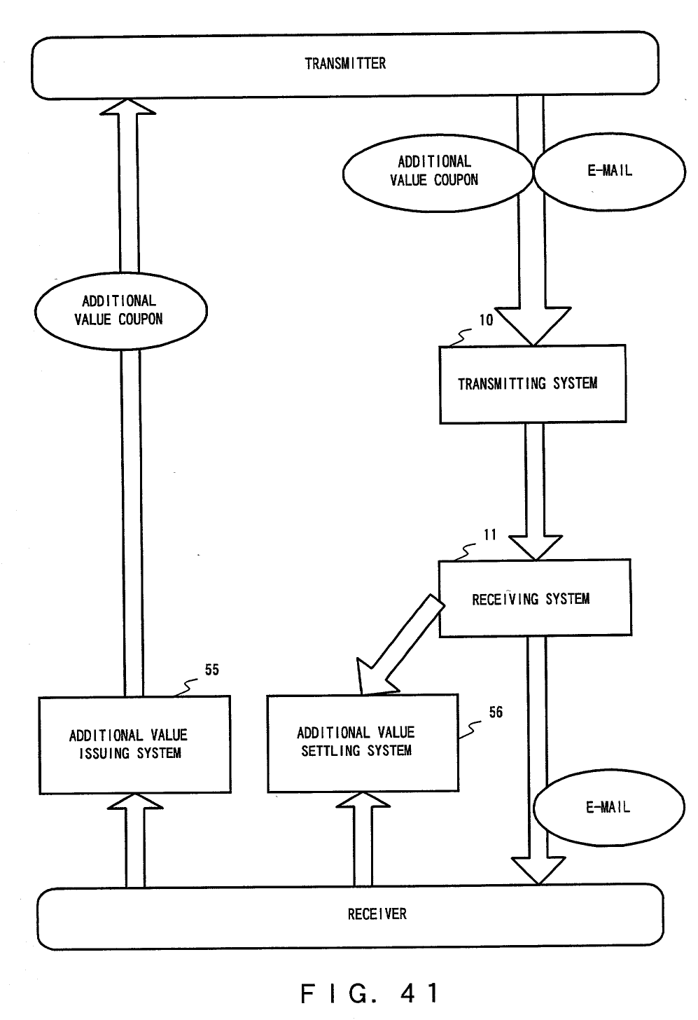

FIG. 41 is a diagram showing the fundamental structure of a ninth embodiment of the present invention. In the ninth and tenth embodiments, unlike the cases in the first to eighth embodiments, an additional value is issued on the side of the receiver, the coupon for the additional value is sent to the transmitter and then the coupon is transmitted to the receiver in a state that it is appended to E-mail.

That is, the first to eighth embodiments have been described on the assumption that the E-mail transmitter is, for example, the publicity agent or the agent which has no basic relation to the receiver. However, in the ninth and tenth embodiments, the transmitter and the receiver are known to each other in the case of friends or acquaintances. In the embodiments of the first to eighth embodiments, even when the E-mail is sent from, for example, a superior of the receiver in his working place, if an additional value exceeding the threshold value is not appended, the receiver will not read the E-mail. Accordingly, the receiver sends the additional value coupon which is issued on his side, that is, the additional value coupon for a specific receiver to the transmitter or his superior, and the superior transmits this additional value coupon for the specific receiver appending it to the E-mail, by which the receiver can surely select and read the E-mail without discarding it.

In FIG. 41, the additional value issuing system 55 is provided on the side of the receiver, unlike the case shown in, for example, FIG. 2 of the first embodiment. The receiver requests the additional value issuing system 55 to issue the additional value coupon for the specific receiver and the coupon is sent to the transmitter. Then, the transmitter appends the additional value coupon for the specific receiver to the E-mail and transmits the E-mail to the receiver via the transmitting system 10, then the E-mail is sent to the receiver via the receiving system 11 and, simultaneously therewith, the account for the additional value is settled by the additional value account settling system 56. However, in general, what is needed for the additional value settling system 56 is to simply confirm whether the additional value coupon appended to the E-mail corresponds to the additional value coupon for the specific receiver issued in the side of the receiver and no particular monetary settlement of the additional value is conducted.

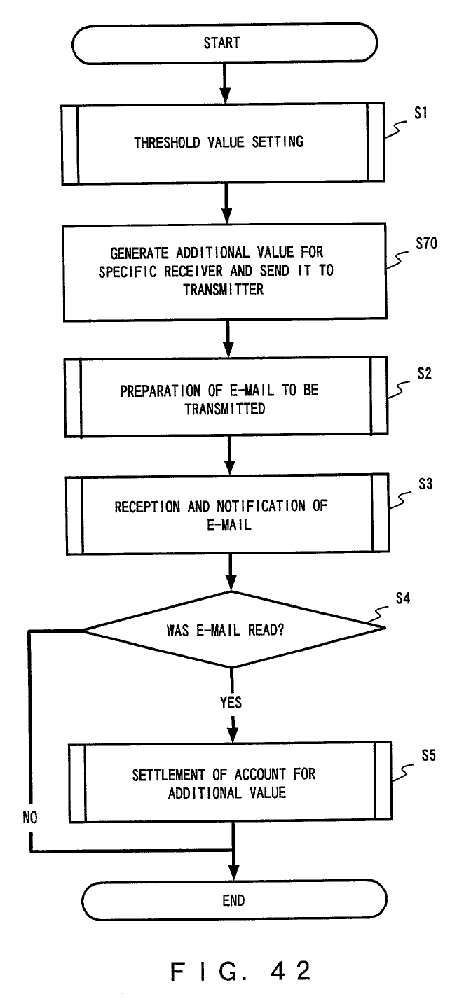

FIG. 42 is a general flowchart of the E-mail transmitting/receiving process in the ninth embodiment of the present invention. In comparison with FIG. 4 of the first embodiment, FIG. 42 differs from FIG. 4 in that between the threshold setting process at the step S1 and the process of preparing the E-mail to be transmitted at the step S2, a process of generating the additional value for the specific receiver and transmitting the value to the transmitter is added at a step S70.

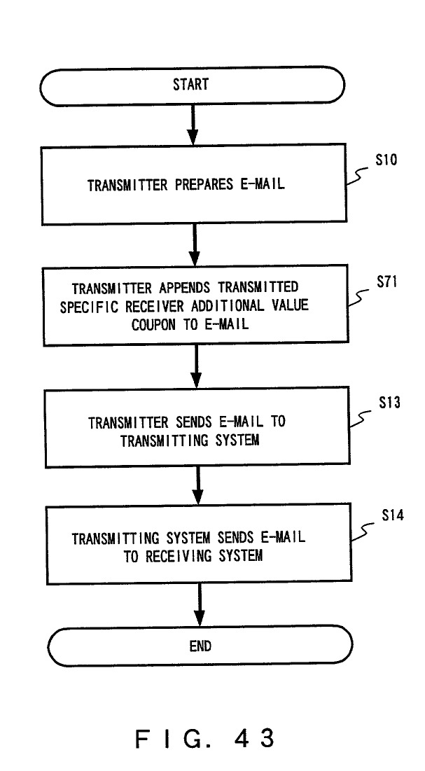

FIG. 43 is a detailed flowchart of the transmitted E-mail preparing process in the ninth embodiment, that is, the process at the step S2 in FIG. 42. In comparison with FIG. 6 of the first embodiment, FIG. 43 differs from FIG. 6 in that between the steps S10 and S13, a process of appending the additional value coupon for the specific receiver sent from the receiver to the E-mail by the transmitter is executed at a step S71, instead of the steps S11 and S12 in FIG. 6.

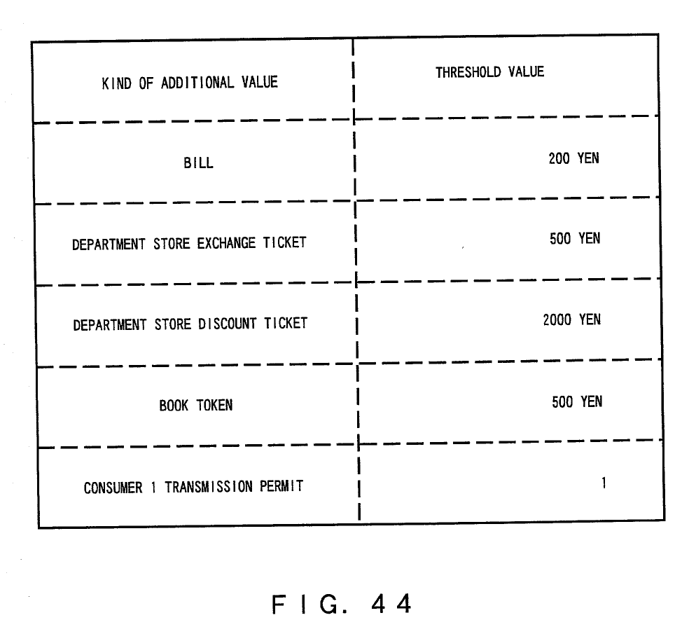

FIG. 44 shows an example of the contents stored in the threshold value storage database according to the ninth embodiment, which is provided, for example, within the filtering system in the receiving system 11 shown in FIG. 41. In comparison with FIG. 11 of the second embodiment, FIG. 44 differs from FIG. 11 in that in addition to four kinds of additional values ranging from the bill to the book token, “1” is stored as the threshold value for a consumer 1 transmission permit corresponding to the additional value coupon for the specific receiver for the consumer 1 as the receiver. This threshold value indicates that the number of the additional values, that is, the consumer 1 transmission permits, to be transmitted by being appended to the E-mail is one or more. That is, for example, even when two transmission permits are appended, this value exceeds the threshold value and hence notification is issued of the arrival of the E-mail to which these two permits are appended to the receiver from the receiving system 11.

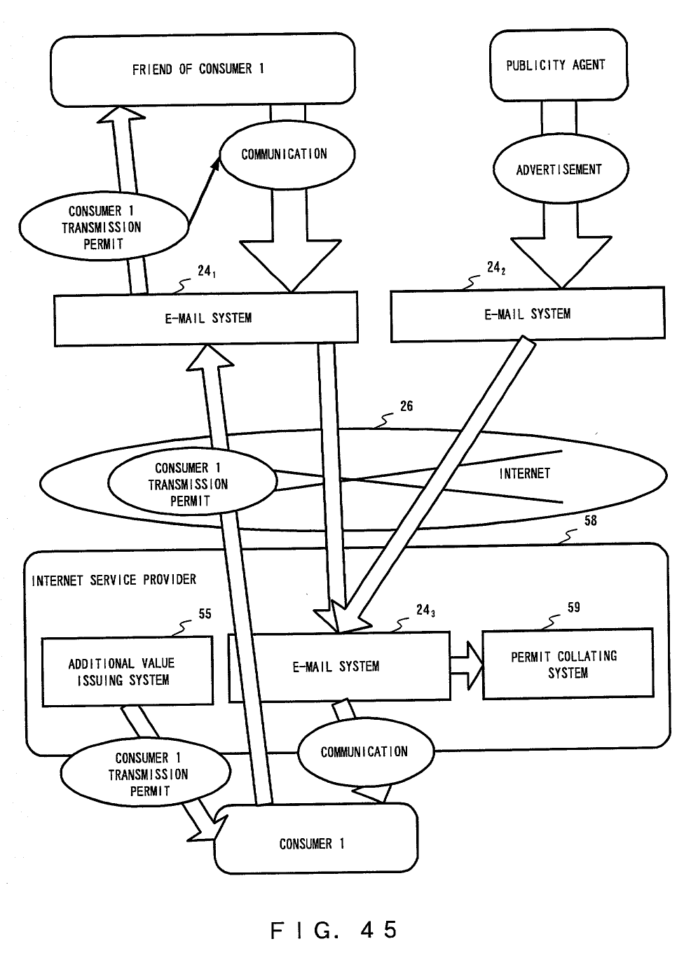

FIG. 45 is a concrete example of the ninth embodiment of the present invention. In this example, the consumer 1 who is the E-mail receiver prepares “CONSUMER 1 TRANSMISSION PERMIT” in advance as the additional value for the consumer 1 and registers it, for example, in the E-mail system 24₃ of an Internet service provider 58 as the threshold value. The contents stored in the threshold value storage DB is as shown in FIG. 44. In this example, not only the consumer 1 transmission permit, but also other kinds of additional values are registered.

In a case that the consumer 1 wants to exchange E-mail with his friend, the consumer 1 requests the additional value issuing system 55 to issue the consumer 1 transmission permit and sends this permit to the friend. In the case of communication with the consumer 1 by E-mail, the friend appends the consumer 1 transmission permit to the E-mail and sends it to the consumer 1. In this connection, it is to be noted that there is no particular need to settle the account for the permit appended to the E-mail, so that the permit is discarded directly.

However, E-mail from the publicity agent to which nothing is appended is discarded, for example, by the E-mail system 24₃ of the Internet service provider 58. In a case that the consumer 1 does not want to receive the mail from the friend, the consumer 1 must not send the consumer 1 transmission permit to the friend or the consumer must delete the registration of the threshold and must register “CONSUMER 1 TRANSMISSION PERMIT-1” for another kind of additional value.

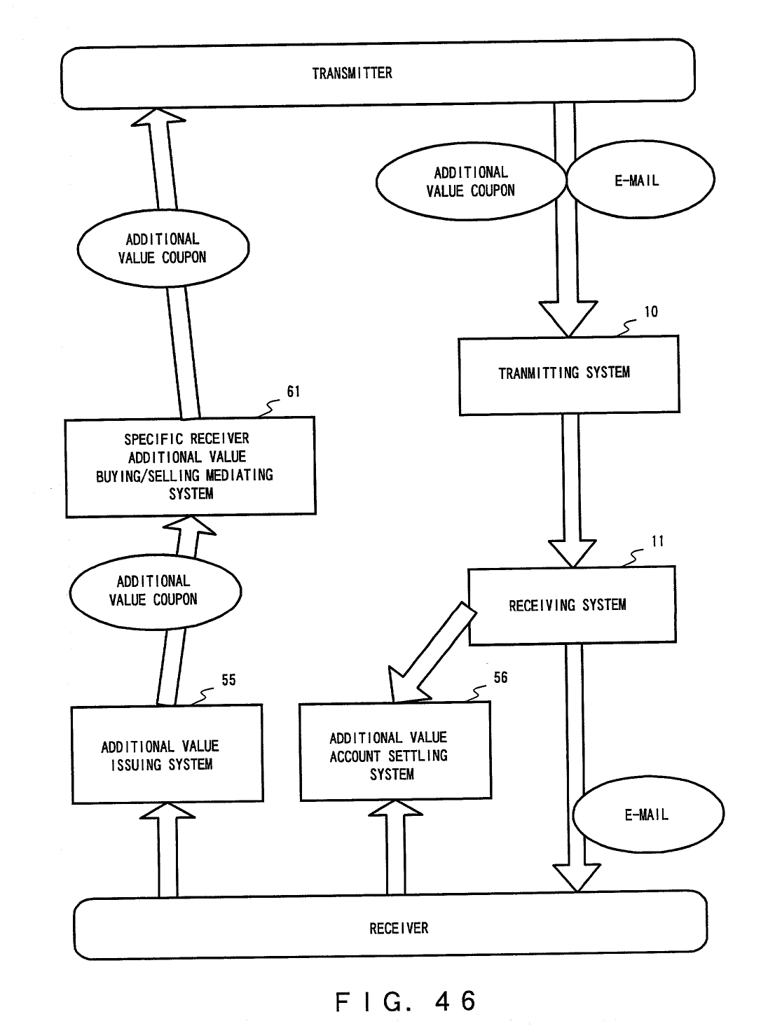

The E-mail can be selected by using the additional value kind for the specific receiver in the above mentioned manner. FIG. 46 is a diagram showing the fundamental structure of the tenth embodiment of the present invention. In the tenth embodiment, although the additional value coupon for the specific receiver is issued on the side of the receiver as in the case in the ninth embodiment, the coupon is not sent directly to the transmitter, but is bought by a specific consumer additional value buying/selling mediating system 61 and is sold to a transmitter who needs it.

Accordingly, it is not always necessary for the transmitter to be directly familiar with the receiver, unlike the case in the ninth embodiment. That is, the transmitter can buy in the additional value coupon for the specific receiver, for example, as a publicity agent so as to transmit a piece of E-mail with an advertisement to the receiver who issued the coupon and to induce him to read the advertisement. However, the receiver can control the quantity of E-mail transmitted, for example, from the publicity agent by adjusting the issued number of specific receiver additional value coupons.

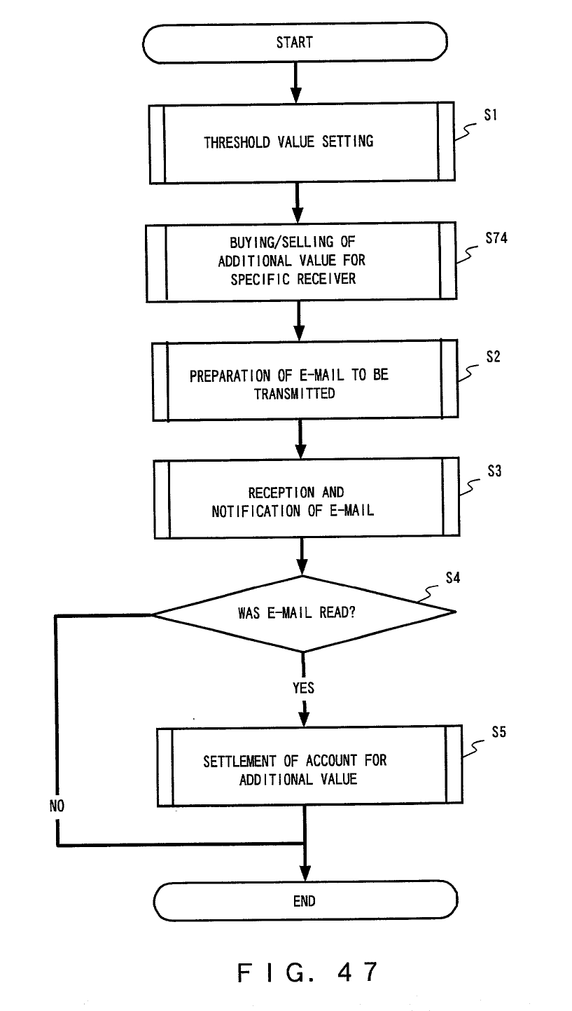

FIG. 47 is a general flowchart of the E-mail transmitting/receiving process in the tenth embodiment of the present invention. In comparison with FIG. 42 of the ninth embodiment, FIG. 47 differs from FIG. 42 in that instead of the process at the step S70 in FIG. 42, a process of buying and selling the additional value coupon for the specific receiver is executed at a step S74 such that the transmitter can append the additional value coupon for the specific receiver which he bought in to the E-mail.

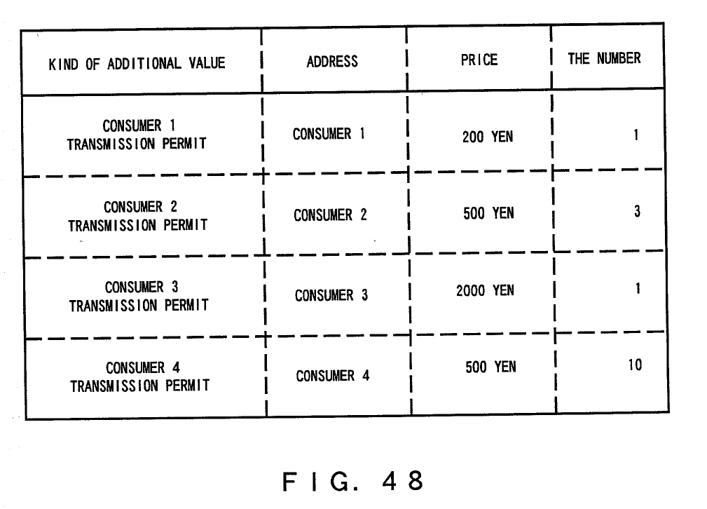

FIG. 48 shows an example of the contents stored in a transmission permit database provided within the specific receiver additional value coupon buying/selling mediating system 61 shown in FIG. 46. As shown in the drawing, data on consumers 1 to 4, that the addresses of respective consumers corresponding to transmission permits as additional values for the respective consumers, the selling prices and the number of transmission permits are stored in the transmission permit database, such that the transmitter can buy transmission permits which he needs by referring to the contents of the database.

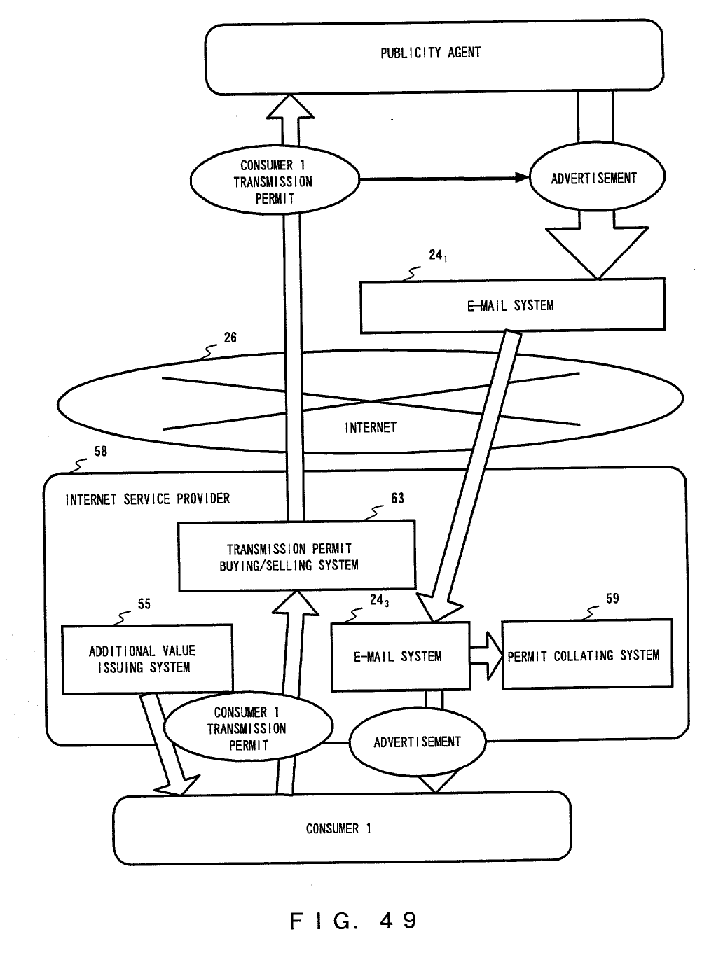

FIG. 49 is a concrete example of the tenth embodiment. In this example, the consumer 1 of an E-mail receiver prepares “CONSUMER 1 TRANSMISSION PERMIT” in advance as the additional value for the consumer 1 and registers it as the threshold value.

The consumer 1 requests the issuing system to issue the consumer 1 transmission permit and registers it in a transmission permit selling system 63. At that time, the transmission permit selling system 63 registers the kind and the number of additional values in the transmission permit DB. This example is shown in FIG. 48. In a case that a certain publicity agent wants to transmit an advertisement to the consumer 1, the agent buys in the consumer 1 transmission permit from the transmission permit selling system 63 and appends it to a piece of E-mail to be transmitted to the consumer 1. There is no need to settle the account for the permit appended to the E-mail, so that it is directly discarded. However, another piece of E-mail to which nothing is appended from another agent is discarded by the E-mail system 243. In a case that the agent wants to send his advertisement ten times, he can buy ten permits. In a case that the consumer 1 wants to accept only ten pieces of E-mail, he can sell only ten permits. In this manner, selection of valuable pieces of E-mail can be realized and the quantity thereof can be controlled by utilizing the additional value kind for the specific receiver.

In the above mentioned first to tenth embodiment, there have been described examples that do not require a mediator, which is one of the problems associated with the prior arts. For example, in the first embodiment, although it is possible to provide main constitutional elements of the receiving system 11 shown in FIG. 3 on the side of the mediator such as the Internet service provider, and not in the receiving system on the receiver side, E-mail transmission/reception is basically conducted directly by the method and apparatus of the present invention between the transmitting system 10 on the transmitter side and the receiving system 11 on the receiver side without interposing such a mediator as mentioned above.

In addition, for example, in FIG. 45 showing the concrete example of the ninth embodiment, it is apparent that an E-mail system for reception may be provided on the consumer side so as to request this system to select a piece of E-mail with a transmission permit exceeding the threshold value, thereby inducing the consumer to read only the selected E-mail without interposing the Internet service provider.

However, for example, in the third embodiment, as described with reference to FIG. 16, there are such problems that the threshold value set by the receiver for the additional value is made public directly to the transmitter via the destination publishing system 40, and on the transmitter side, in a case that advertisements are sent by E-mail, individual additional values should be appended to the individual advertisements, which requires a lot of time and labor. Accordingly, in an eleventh embodiment which will be described hereinbelow, the problem that the threshold value is made public directly to the transmitter and the problem that the transmitter should append each additional value to each advertisement can be solved, for example, by interposing a publicity agent between the transmitter and the receiver. The eleventh and succeeding embodiments will be briefly described hereinbelow.

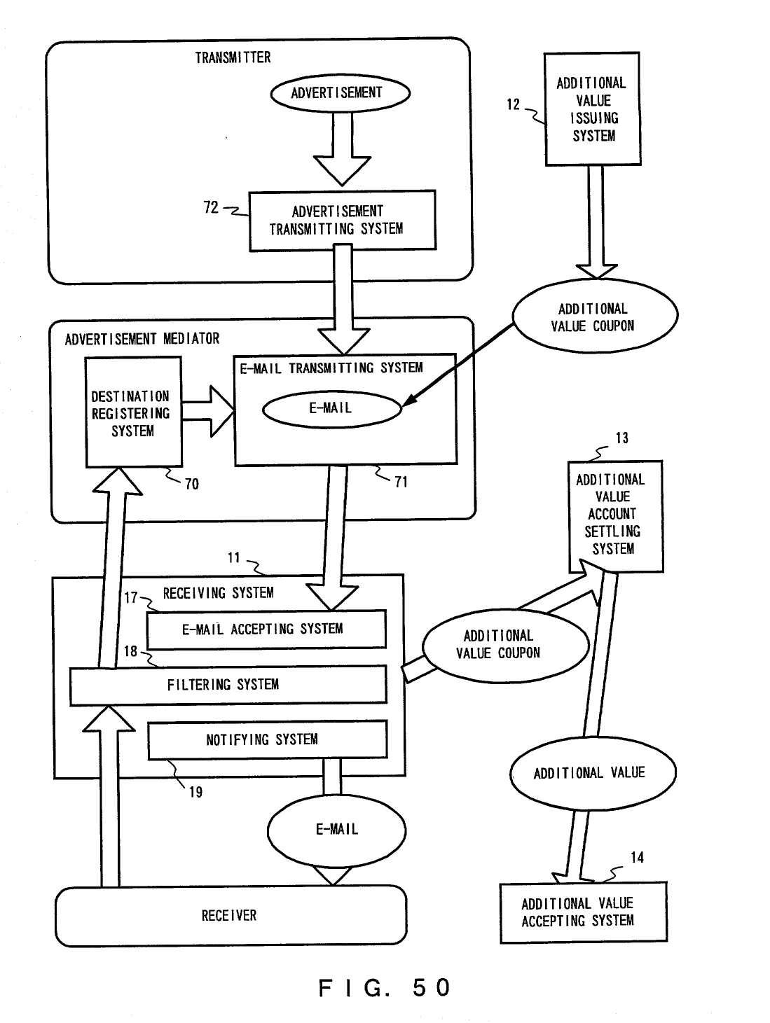

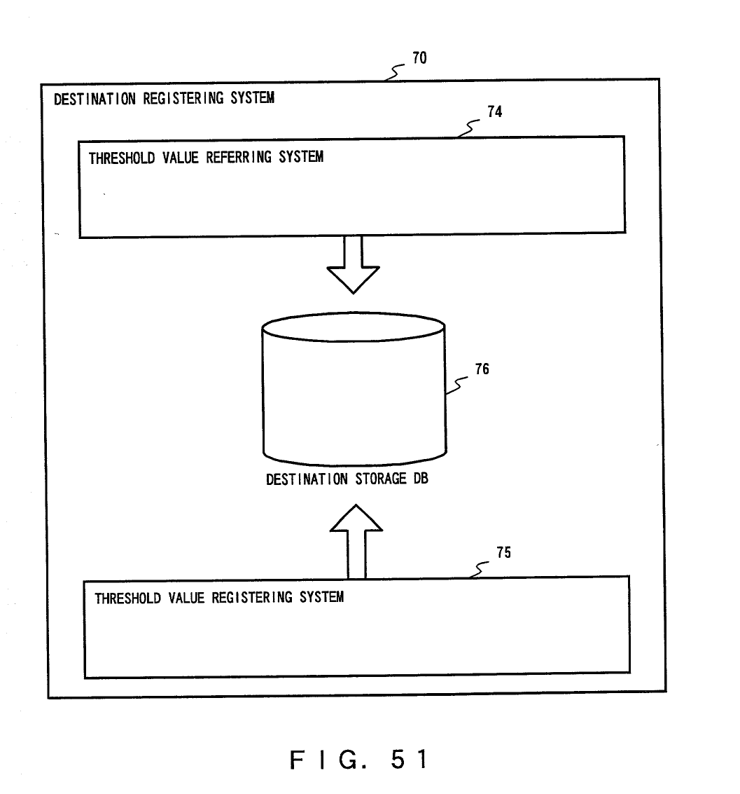

FIG. 50 is a diagram showing the fundamental structure of the eleventh embodiment of the present invention. In the eleventh embodiment, as an essential element, a destination registering system 70 is added to the structure shown in FIG. 2 of the first embodiment. FIG. 51 is a detailed diagram of the destination registering system 70.

The destination registering system 70 shown in FIG. 51 receives the address and threshold value of the receiver sent from the receiving system 11 and stores them in a destination storage DB 76. A threshold value referring system 74 fetches the destination (the address of the receiver) from the destination storage DB 76 to be transmitted to the receiver. A threshold value registering system 75 receives the address, the threshold value and the kind of additional value of the receiver transmitted from the receiving system 11 to be stored in the destination storage DB 76.

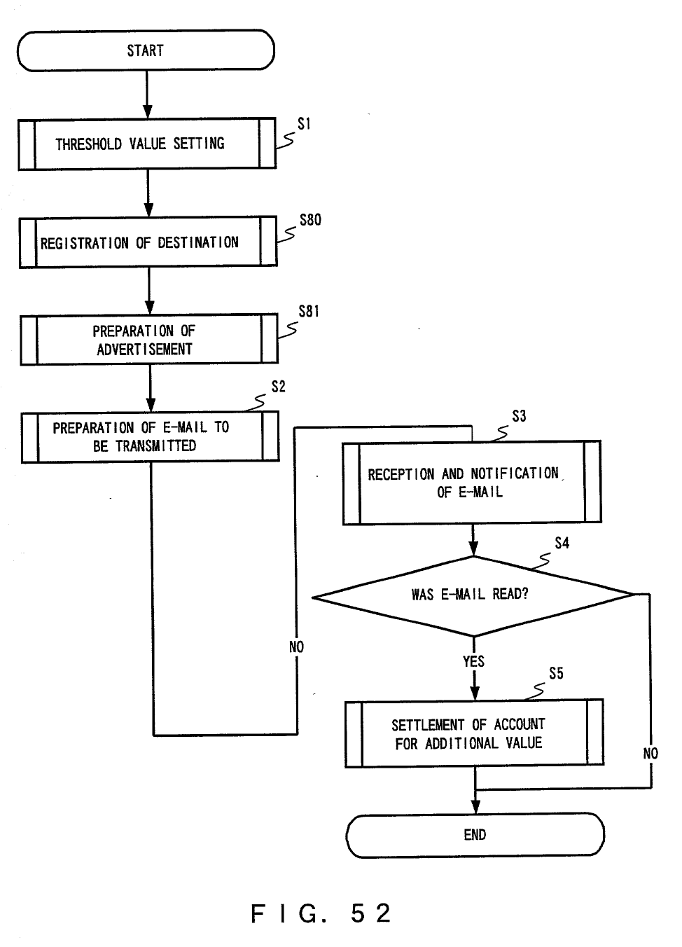

As to the operating procedures in the eleventh embodiment, the destination registering process and advertisement preparing process are added to the processes executed in the first embodiment, as shown in FIG. 52. The operations will be described as follows:

1. Threshold value setting operation

The threshold value setting operation is the same as that in the third embodiment.

2. Destination registering operation

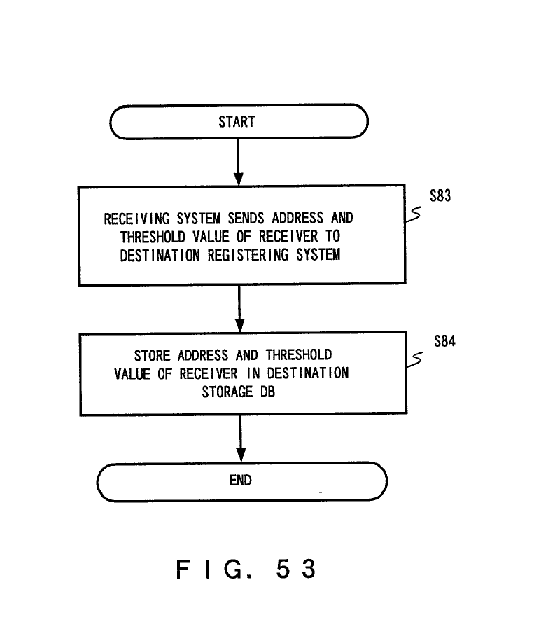

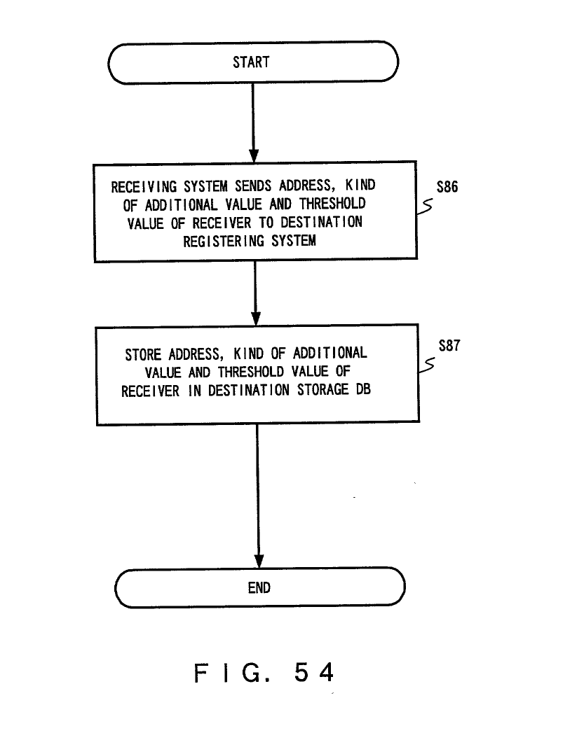

The receiving system 11 sends the set threshold value and the address of the receiver to the destination registering system 70. In the case of a plurality of additional values, upon transmission of the threshold value, the kind of additional value is transmitted in addition to the threshold value and the address of the receiver. The destination registering system 70 stores the same in the destination storage DB 76. These processes are shown in FIGS. 53 and 54.

3. Advertisement preparing operation

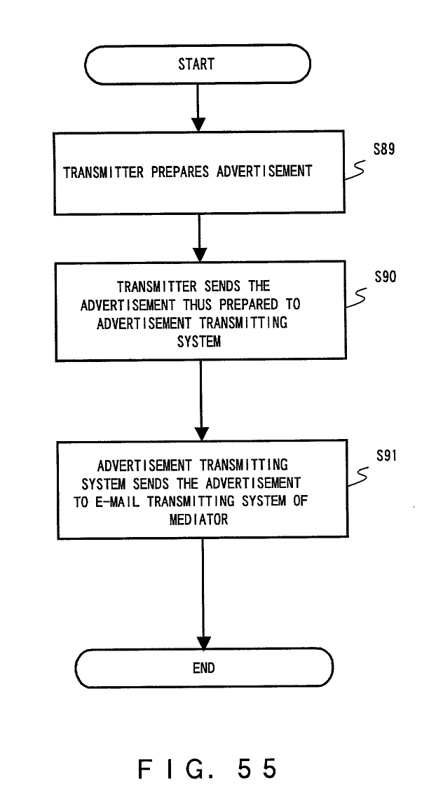

As shown in FIG. 55, the transmitter prepares an advertisement and delivers the same to a publicity agent via the advertisement transmitting system 72.

4. Transmitted E-mail preparing operation

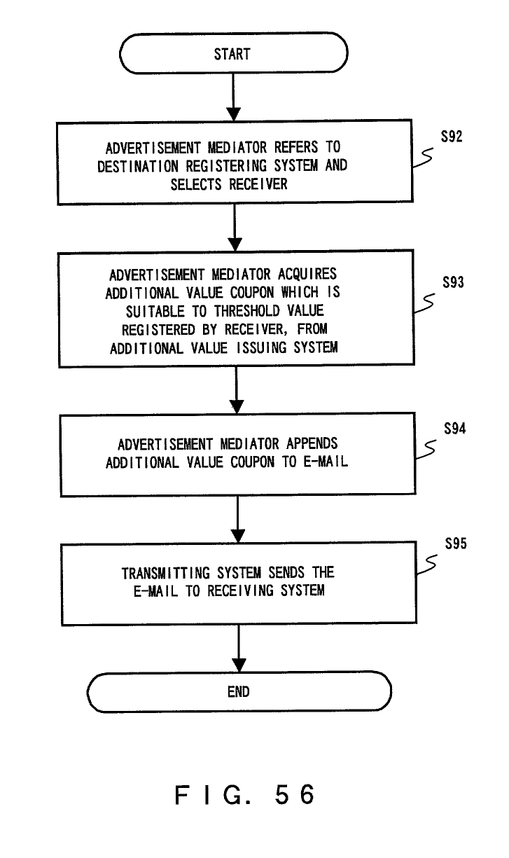

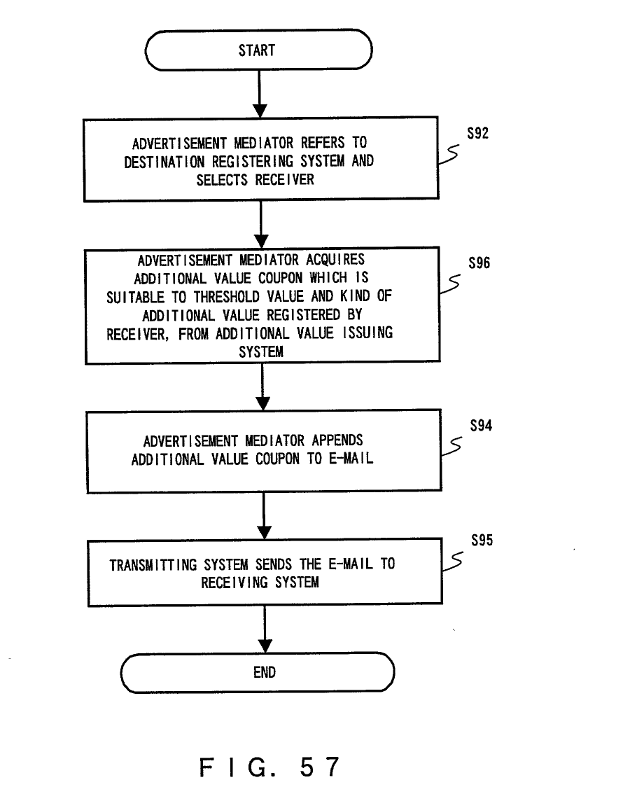

A publicity agent refers to the destination registering system 70 to acquire a suitable additional value coupon therefrom, prepares a piece of E-mail in which the coupon thus acquired is appended to an advertisement, and transmits the E-mail thus prepared to the receiving system. These processes are shown in FIG. 56 (for one kind of additional value) and FIG. 57 (for the plurality of kinds of additional values).

5. E-mail receiving and notifying operations

The E-mail receiving and notifying operations are the same as those in the third embodiment.

6. Additional value settling operation

The additional value settling method is the same as that in the third embodiment.

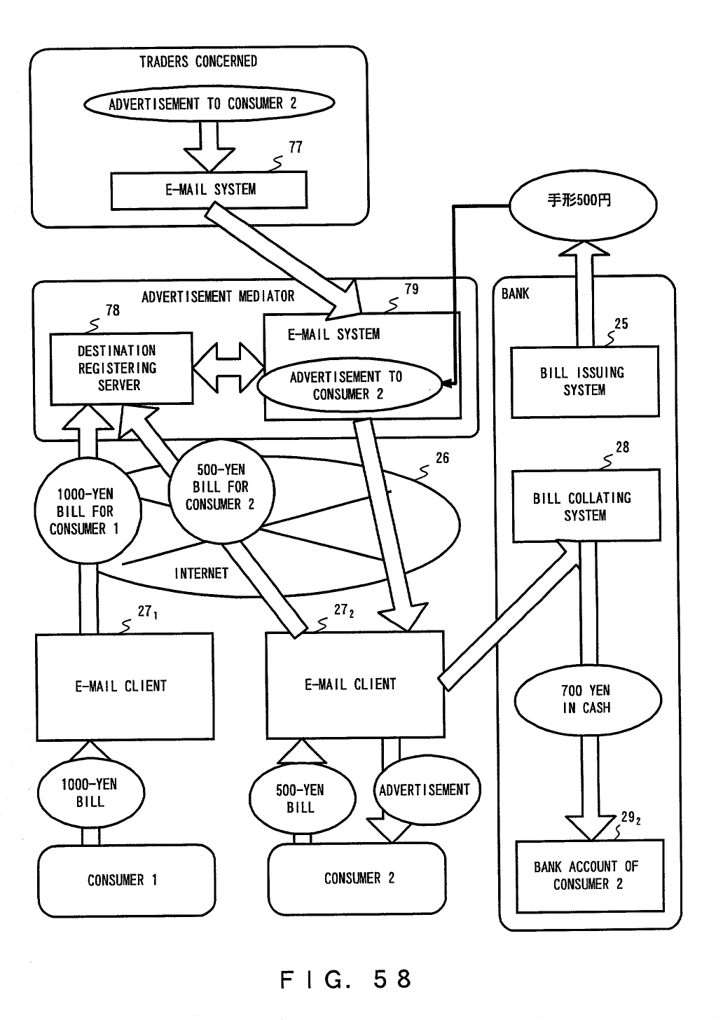

FIG. 58 is a concrete example of the eleventh embodiment of the present invention. In this example, it is assumed that the transmitter corresponds to a publicity agent and the receiver corresponds to a certain consumer 1 and a certain consumer 2. In addition, cash is used as the additional value and the bill is used as the additional value coupon. It is also assumed that a bank provides the bill issuing system 25 and the bill collating system 28, a bank account 29₂ of the consumer 2 is used as the additional value accepting system, and an advertisement is transmitted and received by E-mail.

First, it is assumed that the consumer 1 sets the bill as the kind of additional value and sets 1000 yen as the threshold value, and the consumer 2 sets the bill as the kind of additional value and sets 500 yen as the threshold value.

Next, the agent prepares an advertisement to be delivered to an advertisement mediator via an E-mail system 77. The mediator fetches the advertisement from within the E-mail thus delivered and then refers to a destination registration server 78 to select the customer 2 to whom the advertisement can be transmitted with a lesser additional value. Then, the mediator acquires the bill for 500 yen, appends the 500-yen bill to the advertisement to prepare a piece of E-mail, and transmits the E-mail thus prepared to the consumer 2. An E-mail client 27₂ who received the E-mail fetches the 500-yen bill from within the E-mail. The value of this bill exceeds the threshold value, so that the client notifies the receiver of its arrival.

After confirmation that the receiver read the advertisement in the E-mail, the E-mail client 27₂ transmits the 500-yen bill to the bill collating system 28. After confirmation that the bill thus transmitted is a real one, the bank pays 500 yen into the bank account 29₂ of the consumer 2.

Thus, the consumer 1 reads only the advertisement to which the bill of the value exceeding 1000 yen is appended and the consumer 2 reads only the advertisement to which the bill of the value exceeding 500 yen is appended. Notification of the arrival of a piece of E-mail with no additional value appended or a piece of E-mail to which a bill of the value less than the threshold value is appended is not sent to the consumer and hence the consumer can read only E-mail valuable to him. In addition, neither address information nor threshold information is made public.

Next, a twelfth embodiment of the present invention will be described. As described above, in the first to tenth embodiments, transmission and reception of E-mail is performed directly between the transmitter and the receiver, so that these embodiments have such a problem that even E-mail to which the additional value exceeding the threshold value is not appended is delivered to the receiver side and hence the load on the receiving system on the receiver side is increased accordingly. In order to solve this problem, in the twelfth embodiment, a reception mediating system is interposed between the transmitting system on the transmitter side and the receiving system on the receiver side such that the reception mediating system can delete the E-mail to which the additional value exceeding the threshold value is not appended to reduce the load on the receiving system. The twelfth embodiment will be briefly described hereinbelow.

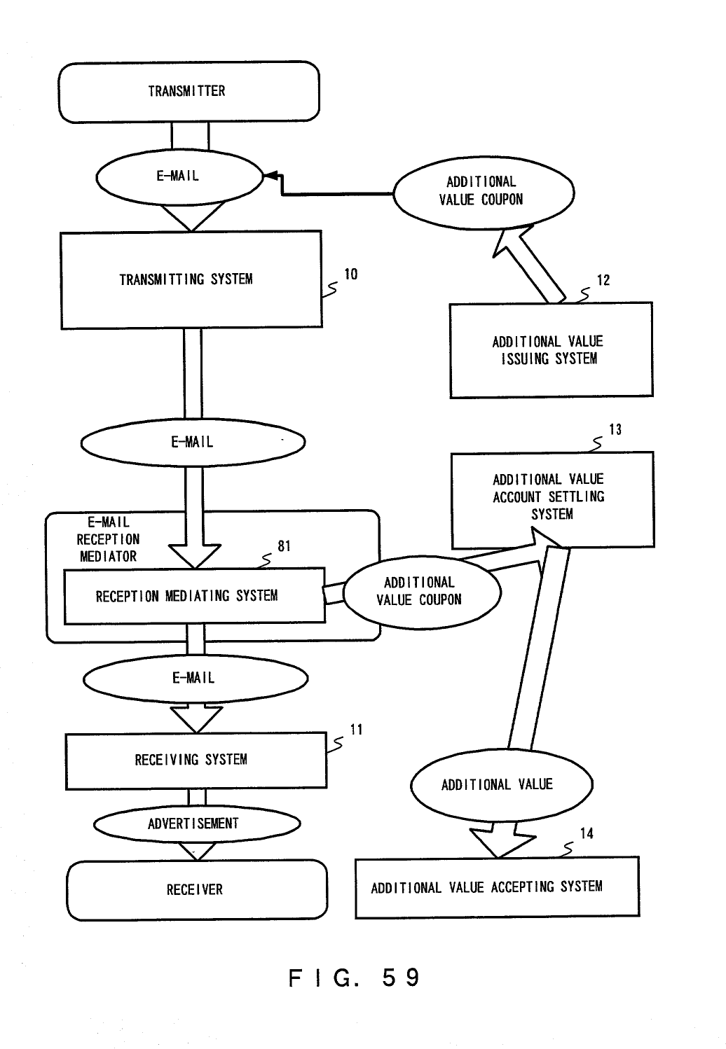

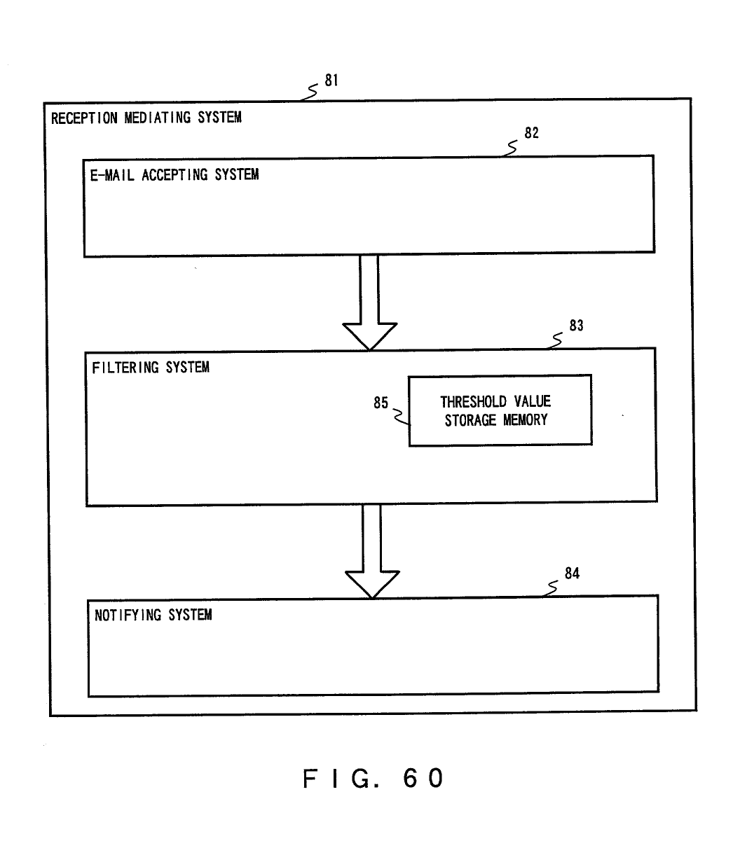

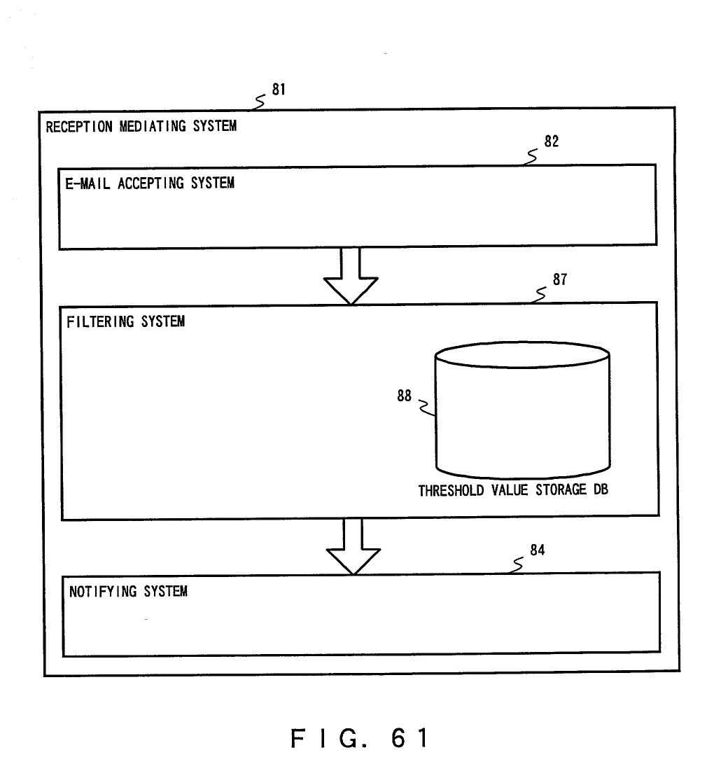

In the twelfth embodiment, a reception mediating system 81 is added to the structure shown in FIG. 2 for the first embodiment. FIG. 59 is a diagram showing the fundamental structure of the twelfth embodiment. Details of the reception mediating system 81 in a case that only one kind of additional value is used are shown in FIG. 60 and details of the reception mediating system 81 in a case that the plurality of kinds of additional values are used are shown in FIG. 61. In the reception mediating system 81 shown in FIG. 61, there is provided a threshold value storage DB 88 in place of a threshold value storage memory 85 in the reception mediating system 81 shown in FIG. 60. The threshold value storage DB 88 is adapted to simultaneously store a plurality of kinds of additional values and a plurality of threshold values thereof.

Although the operating procedures in the twelfth embodiment are the same as those in FIG. 4 for the first embodiment in terms of the general process flowchart, these are partially altered as follows:

1. Threshold setting operation

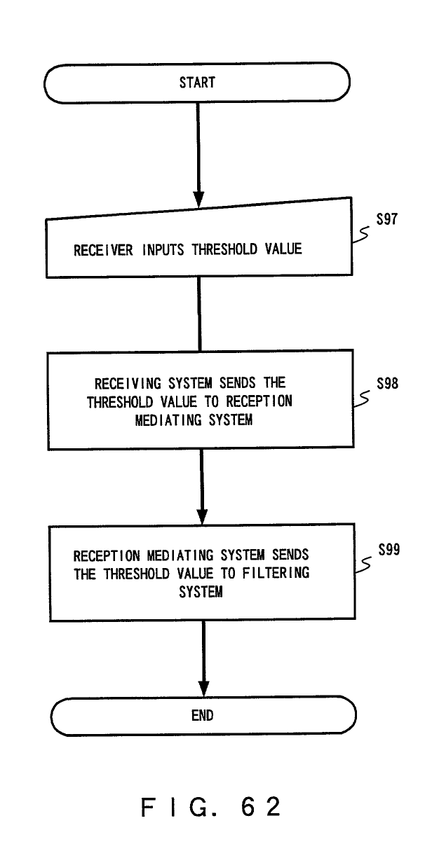

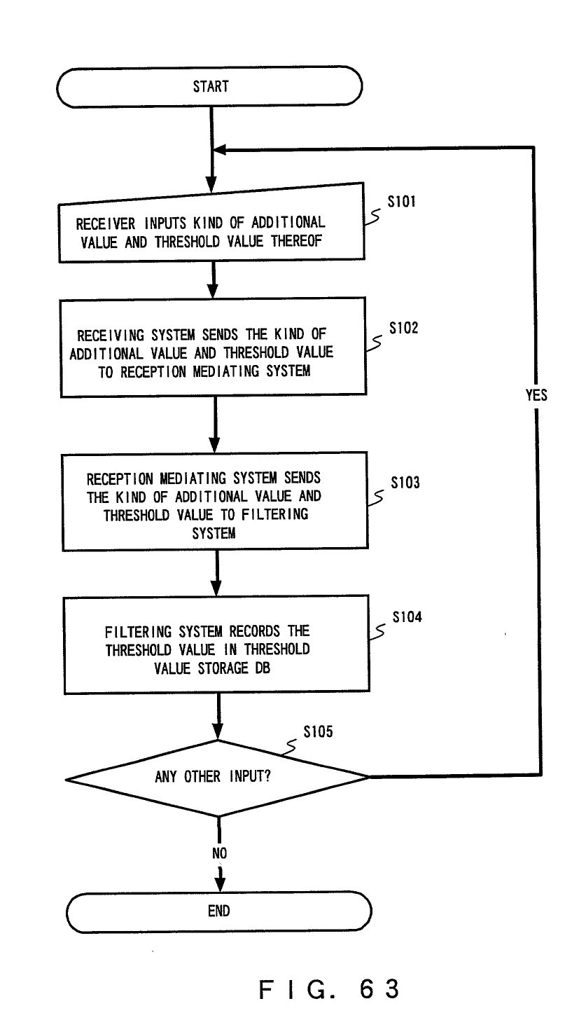

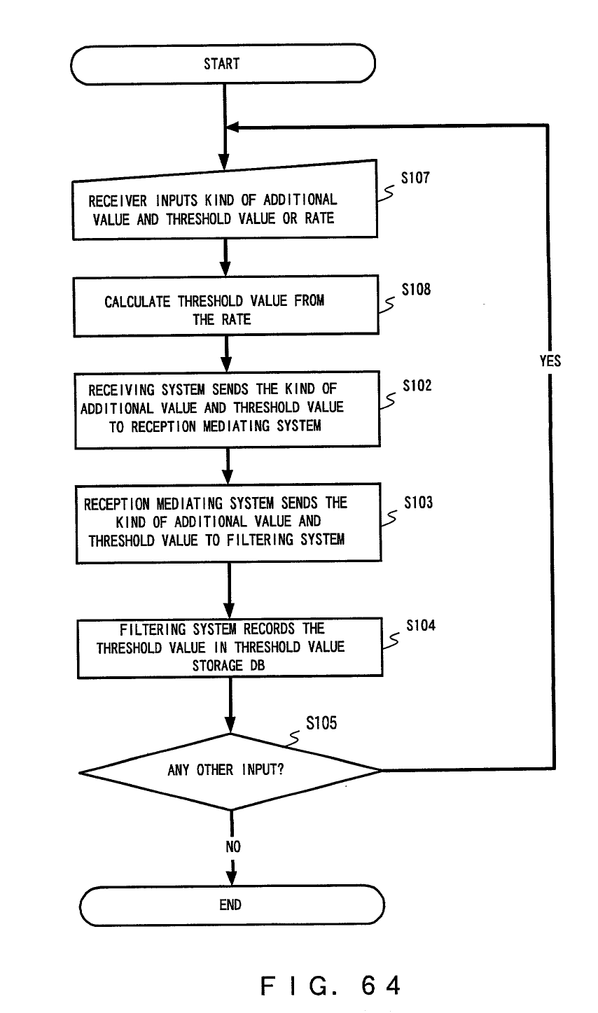

The receiver inputs the threshold value in the case of one kind of additional value, inputs the threshold value and the kind of additional value in the case of the plurality of kinds of additionl values, and inputs the kind of additional value and a conversion rate in a case that the conversion rate for calculating the threshold value can be inputted. Next, the receiving system 11 delivers the values thus inputted to the reception mediating system 81, which then stores the values thus inputted in the threshold value storage memory 83 or the threshold value storage DB 88. These processes are shown in FIGS. 62 to 64.

2. Transmitted E-mail prepararing operation

The transmitted E-mail preparing operation is the same as that in the first embodiment.

3. E-mail receiving and notifying operations

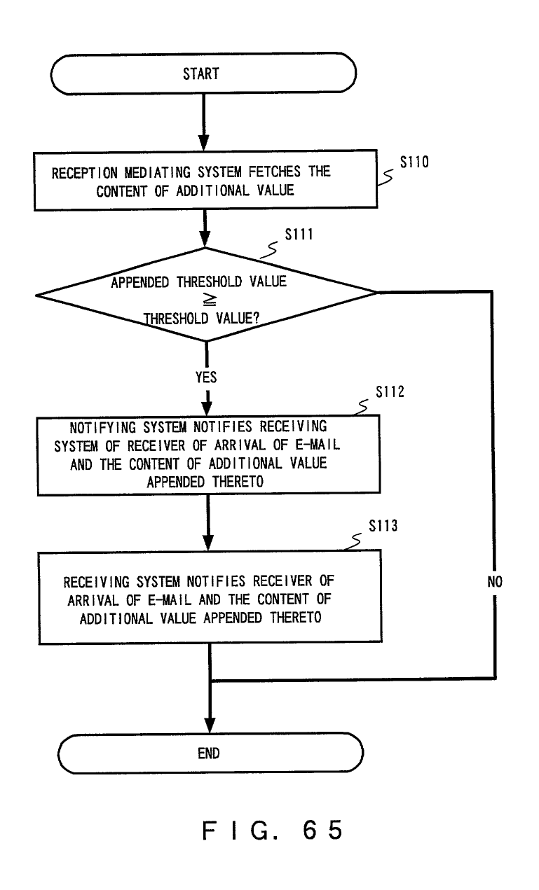

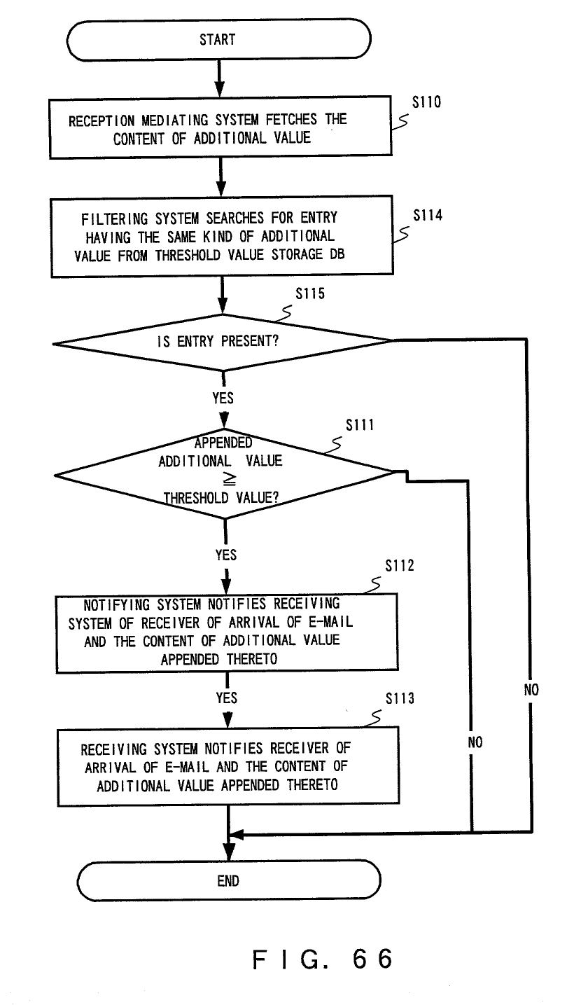

The reception mediating system 81 receives the E-mail and fetches the additional value coupon from within the E-mail. Then, in the same manner as that in the first embodiment, the reception mediating system 81 judges whether notification of the arrival of this E-mail is made to the receiver. When the appended additional value exceeds the threshold value and hence notification of the arrival of the E-mail should be made, the reception mediating system 81 notifies the receiving system 11 of the arrival of the E-mail. The receiving system 11, which received the notification, notifies the receiver of the arrival of the E-mail. These processes are shown in FIG. 65 (for one kind of additional value) and in FIG. 66 (for a plurality of kinds of additional values).

4. Additional value settling operation

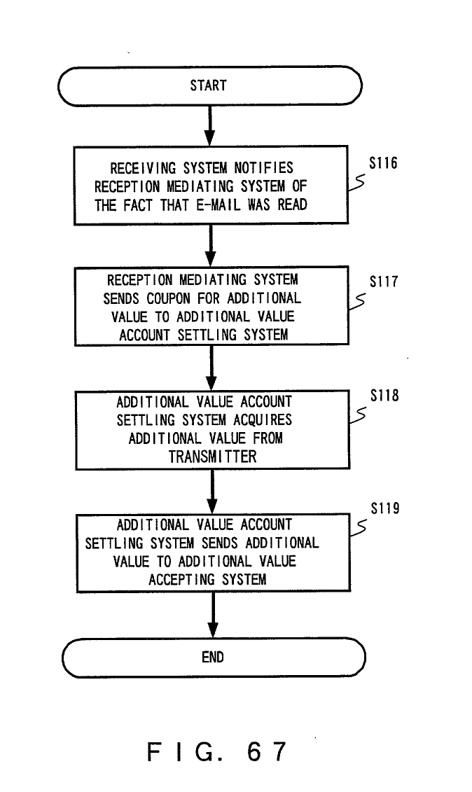

The additional value settlement is executed by the reception mediating system 81 in accordance with a flowchart shown in FIG. 67.

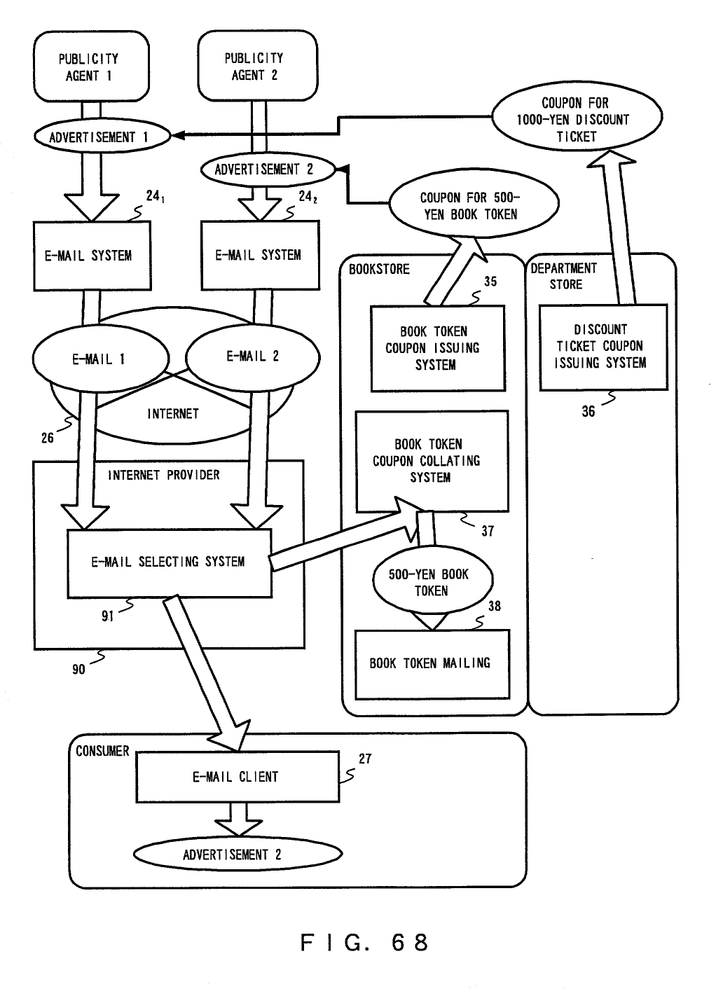

FIG. 68 is a diagram of a concrete example of the twelfth embodiment of the present invention. In this example, it is also assumed that the transmitter corresponds to a publicity agent 1 and a publicity agent 2, and the receiver corresponds to a certain consumer. In addition, the book token and the department store discount ticket are used as coupons for additional values, the bookstore and department store provide the additional value issuing system 35 and 36, and the additional value settling system 37, respectively, and a mailing system 38 to the consumer is used as the additional value accepting system 14. The mailing system via the Internet 26 is used as the E-mail transmitting/receiving system. The receiver receives a piece of E-mail via an E-mail selecting system 91 provided by an Internet provider 90.

First, it is assumed that the consumer sets 200 yen for the bill, 500 yen for the department exchange ticket, 2000 yen for the department discount ticket and 500 yen for the book token as the threshold values.

Next, the publicity agent 1 prepares an advertisement 1, acquires the coupon for the 1000-yen discount ticket from the department store, appends the coupon to the advertisement 1 and transmits E-mail 1 with the advertisement 1 to the consumer. Then, the publicity agent 2 prepares an advertisement 2, acquires the coupon for the 500-yen book token from the bookstore, appends the coupon to the advertisement 2 and transmits E-mail 2 with the advertisement 2 to the receiver.

The transmitted E-mail 1 is temporarily received by an E-mail selecting system 91, which then fetches the coupon for the 1000-yen discount ticket from within the E-mail 1. However, since the value of this coupon is less than the threshold value, notification of the arrival thereof is not made to the E-mail client 27 and the E-mail 1 is discarded. Then, the E-mail selecting system 91 receives the E-mail 2 and fetches the coupon for the 500-yen book token from within the E-mail 2. Since the value of this coupon exceeds the threshold value, the selecting system notifies the E-mail client 27 of the arrival of the E-mail 2. Then, the E-mail client 27 notifies the receiver of the arrival of the E-mail 2.

After confirmation that the receiver read the advertisement 2 in the E-mail 2, the E-mail client 27 notifies the E-mail selecting system 91 that the receiver read the E-mail 2. Then, the E-mail selecting system 91 transmits the coupon for the 500-yen book token to the book token coupon collating system 37 in the bookstore. After confirmation that the transmitted coupon is a real one, the bookstore mails the 500-yen book token to the consumer.

In general, the rate of communication between the E-mail client and the Internet provider is low. In the first embodiment, since all the E-mails are temporarily transmitted to the receiver, it takes a lot of time to inspect all pieces of E-mail. However, in the twelfth embodiment, since the E-mail is selected on the side of the Internet provider, the time required for the receiver to inspect all pieces of E-mail can be greatly reduced.

Next, as the last embodiment of the present invention, a thirteenth embodiment of the present invention will be described. In all of the above mentioned first to twelfth embodiments, only E-mail is regarded as a concrete object to be processed and the E-mail is of the type which is one-sidedly transmitted from the transmitter to the receiver. In the thirteenth embodiment, instead of referring to the E-mail, which is one-sidedly transmitted to the receiver, as mentioned above, a system in which the receiver transmits the address of a page which he or she wants to inspect to a WWW (World-WideWeb) server and the server side transmits a Web page corresponding to that address to the receiver side such as the World-Wide Web (WWW) system will be referred to.

In the thirteenth embodiment, when the address of a page of which inspection is requested by the receiver side is transmitted to the transmitter side, the page with an additional value appended thereto is sent from the transmiter side to the receiver side in return thereof. Then, when the additional value exceeds the threshold value set on the side of the receiver, the receiver inspects the page. In this case, as will be described hereinbelow, the thirteenth embodiment will also be briefly described as follows with referece to two cases, that is, a first case in which the receiver side sets only the threshold value on its own side to transmit only the address of the page to inspect to the WWW server, and a second case in which the receiver transmits the threshold value together with the address of the page to inspect and the transmitter side transmits the Web page to which an additional value exceeding the threshold value is appended to the receiver in return.

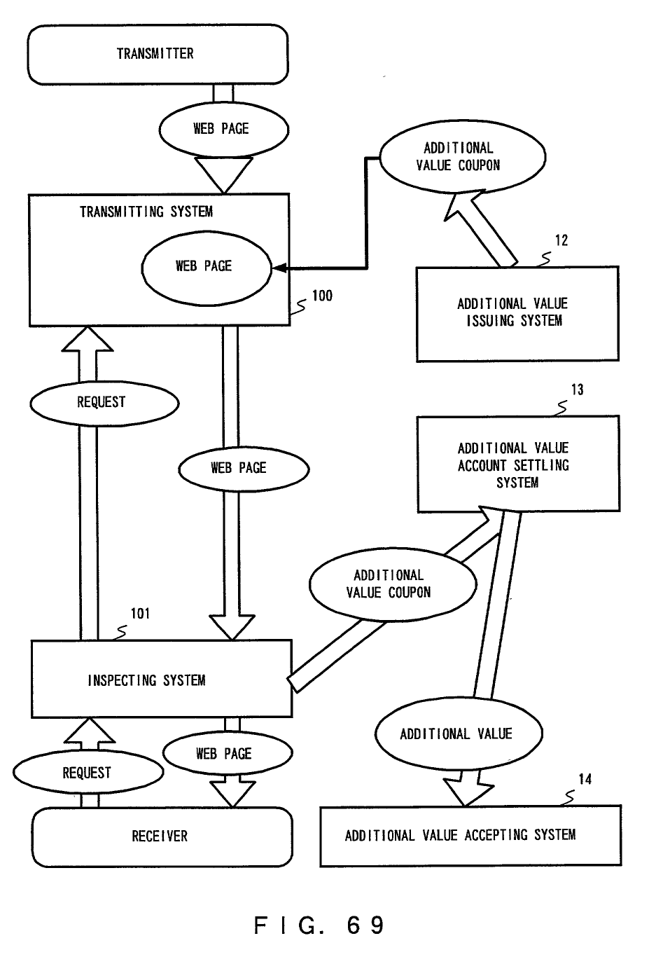

FIG. 69 is a diagram showing the fundamental structure of the thirteenth embodiment. As shown in the drawing, this embodiment comprises an inspecting system 101, a transmitting system 100, the additional value issuing system 12, the additional value settling system 13 and the additional value accepting system 14.

The inspecting system 101 transmits the address of the Web page selected by a user (receiver) to the transmitting system 100 and then receives the Web page sent from the transmitting system 100 to compare the appended additional value with the threshold value, thereby to select the Web page. Then, when the receiver reads the Web page, the inspecting system 101 sends the coupon for the additional value to the additional value settling system 13.

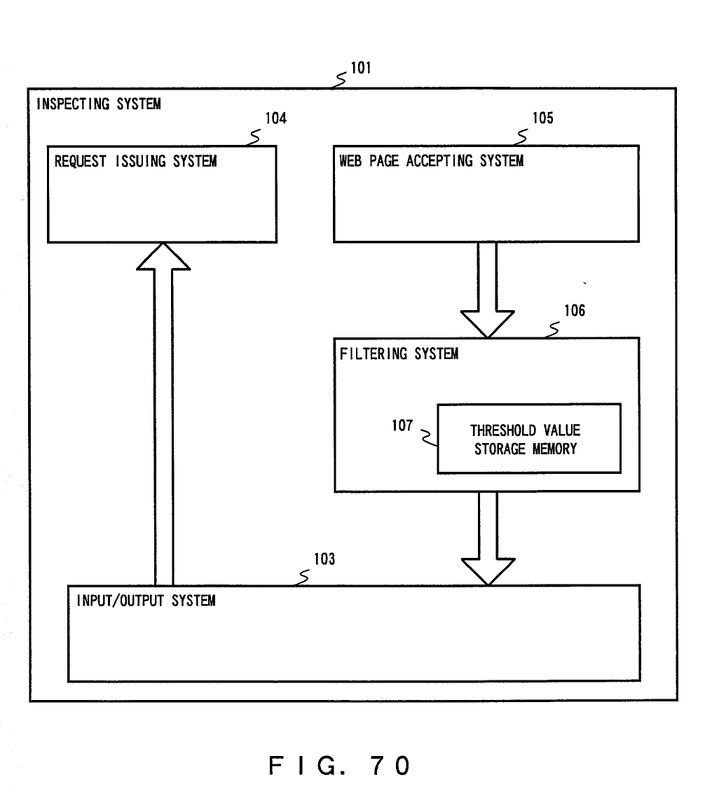

FIGS. 70 to 73 are diagrams showing the detailed structures of the inspecting system 101. The inspecting system 101 shown in FIG. 70 is designed so as to deal with one kind of additional value in the above mentioned first case (only the page address is sent to the Web server) and comprises an input/output system 103 for accepting an input from the user and for displaying a Web page, a request issuing system 104 for issuing a request to the transmitting system 100, a Web page accepting system 105 for accepting the transmitted Web page, and a filtering system 106 for selecting the Web page.

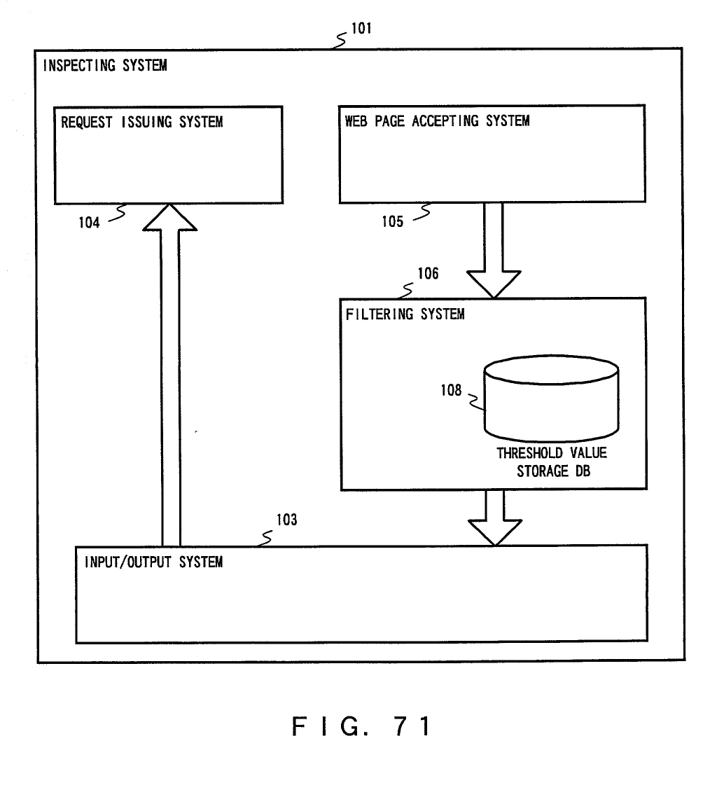

The inspecting system 101 designed so as to deal with a plurality of kinds of threshold values in the first case is capable of setting a plurality of kinds of additional values owing to the provision of a threshold value storage DB 108 as shown in FIG. 71.

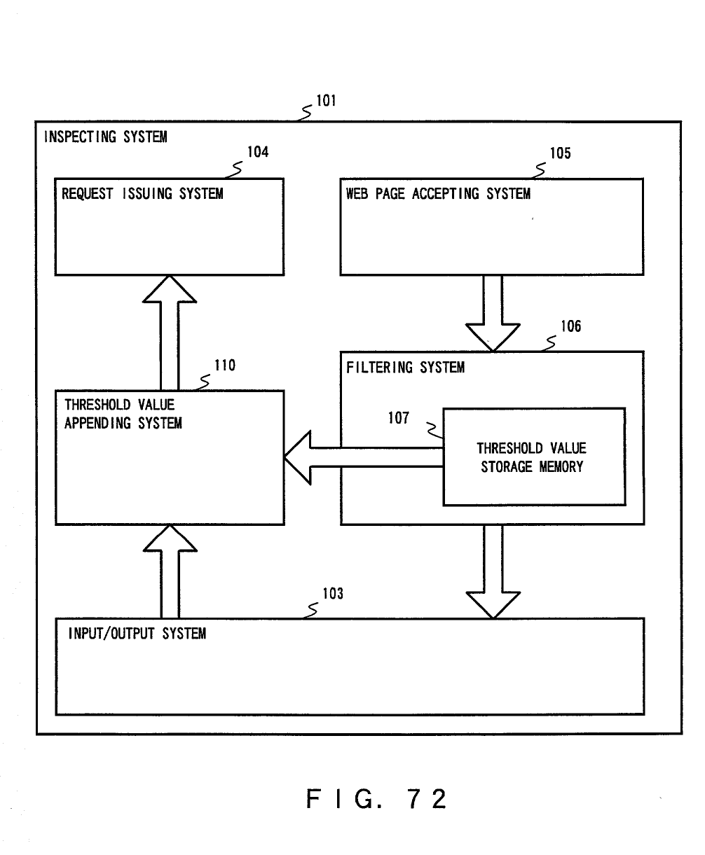

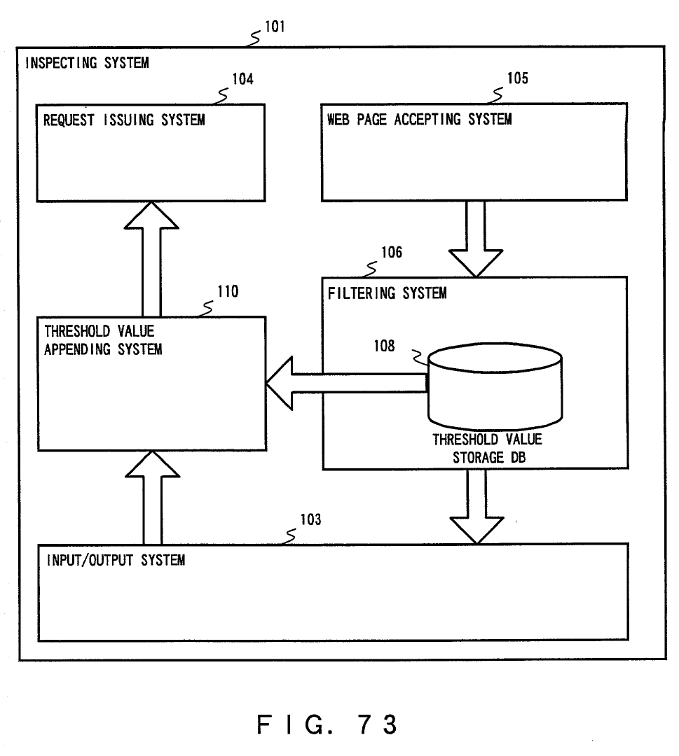

However, as shown in FIGS. 72 and 73, a threshold value appending system 110 for annexing additional value information set by the user to the request is added to the inspecting system 101 designed for the second case. The threshold value in the case shown in FIG. 72 and the kind of additional value and the threshold value in the case shown in FIG. 73 are sent to the transmitting system 100 as the additional value information.

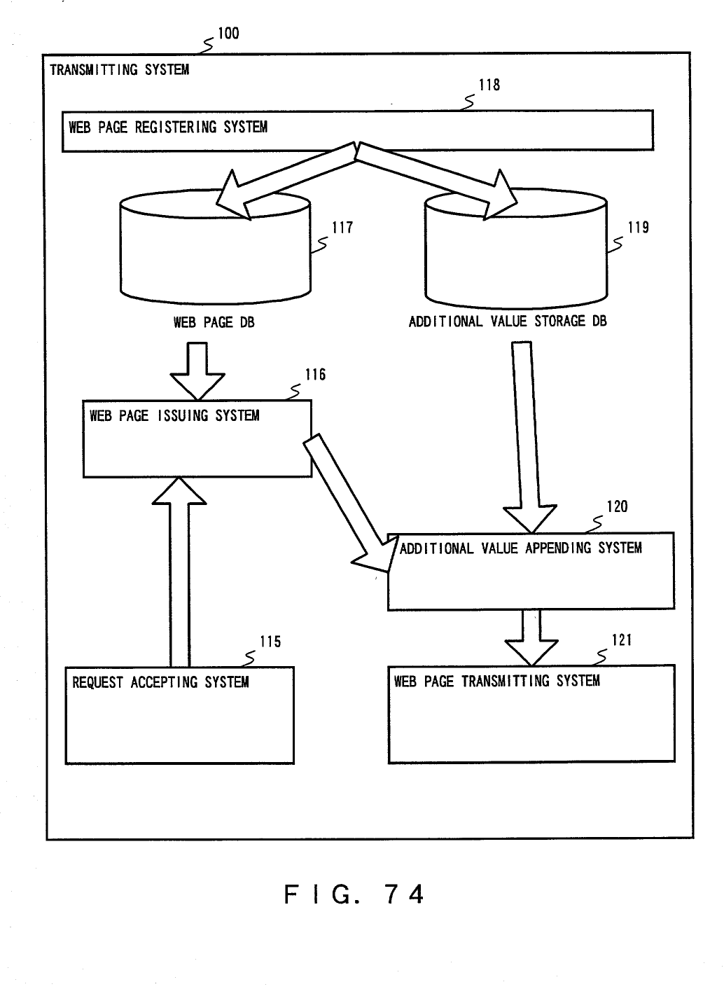

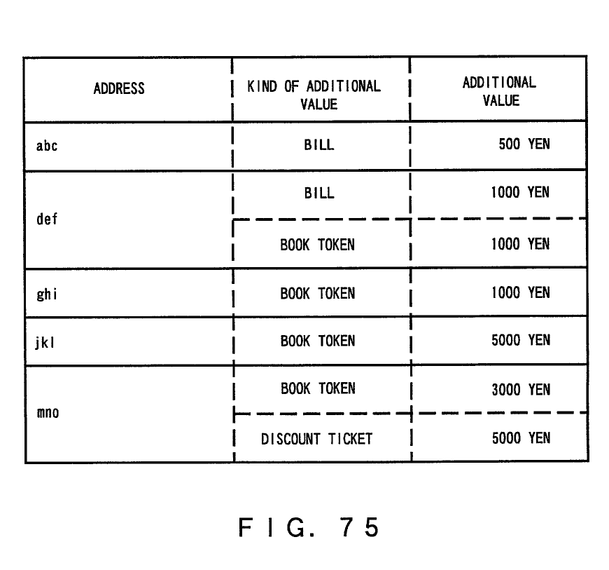

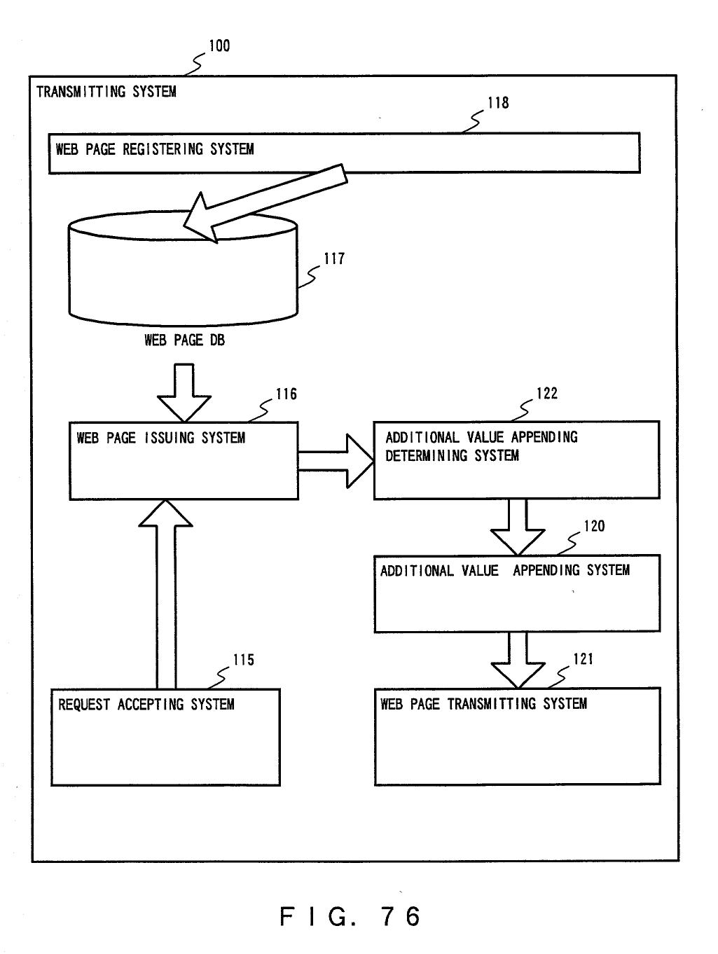

The transmitting system 100 is a system for transmitting the Web page to the inspecting system 101 corresponding to the address requested by the user. FIG. 74 is a detailed diagram of the transmitting system 100 designed for the first case, FIG. 75 shows an example of the contents stored in an additional value storage DB 119 in the transmitting system, and FIG. 76 is a detailed diagram of the transmitting system designed for the second case.

In FIG. 74, the transmitting system 100 comprises a Web page registering system 118 for accepting and registering the Web page prepared by the transmitter, a Web page DB 117 for saving the registered Web page, the above mentioned additional value storage DB 119 for storing additional values to be appended to the Web page upon registration, a request accepting system 115 for accepting the request from the user, a Web page issuing system 116 for retrieving the Web page corresponding to the accepted request, an additional value appending system 120 for appending the additional value to the Web page, and a Web page transmitting system 121 for transmitting the Web page. The transmitting system 100 shown in FIG. 76 is comprised of an additional value determining system 122 in place of the additional value storage DB 119.

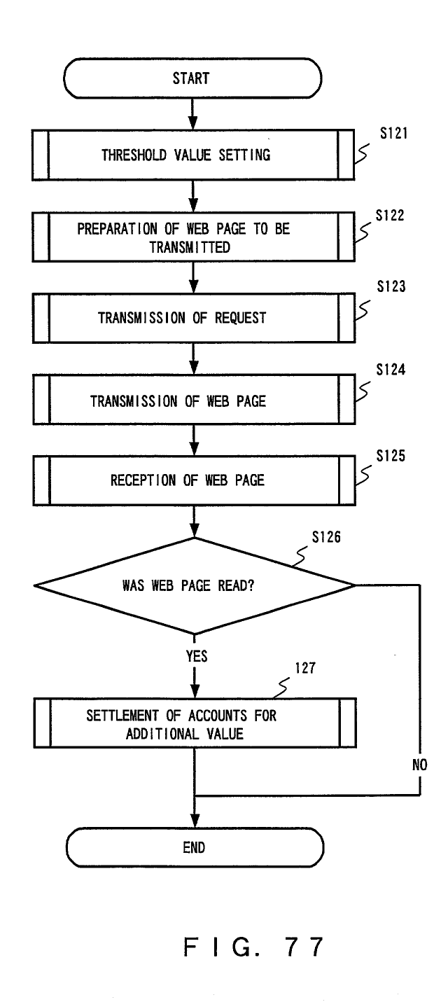

The above mentioned systems operate in accordance with a general flowchart shown in FIG. 77. Operations thereof will be described hereinbelow.

1. Threshold value setting operation (S121)

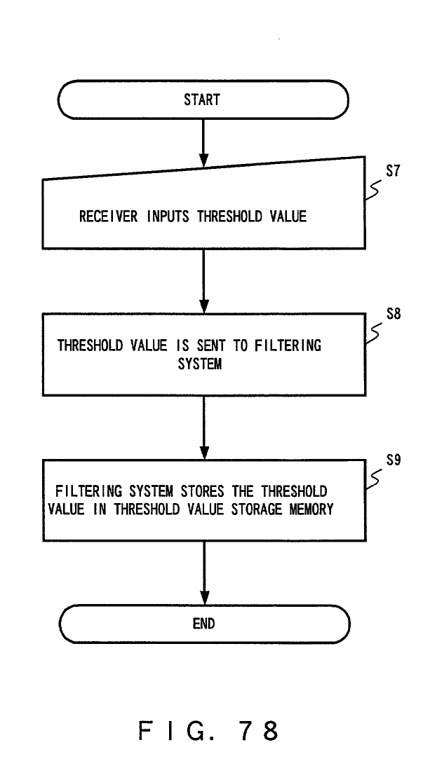

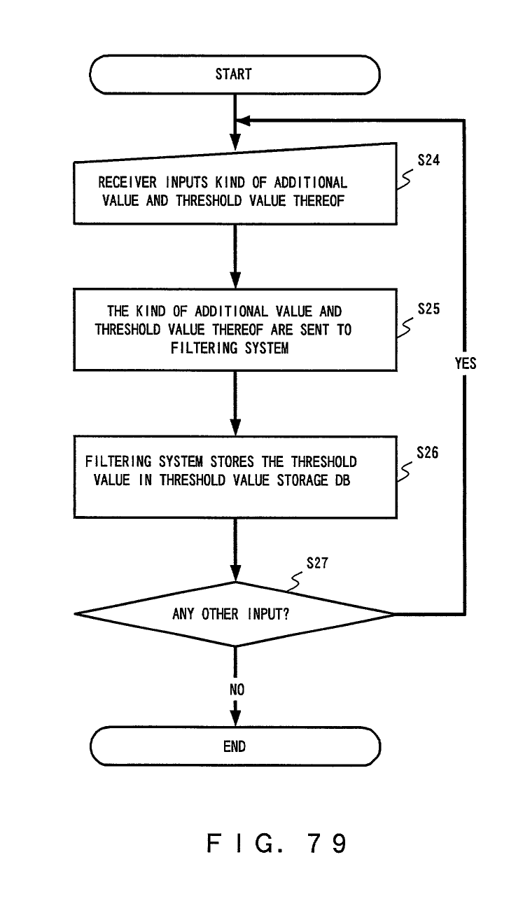

The receiver inputs a threshold value to be transmitted to the filtering system 106 in the inspecting system. Flowcharts for the threshold value setting process are shown in FIGS. 78 and 79 corresponding to FIGS. 5 and 12 for the first and second embodiments.

2. Transmitted Web page preparing operation (S122)

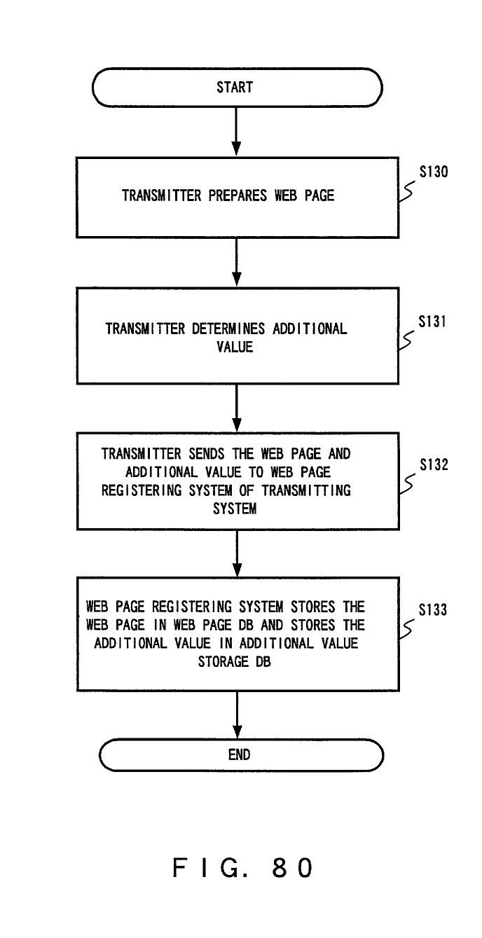

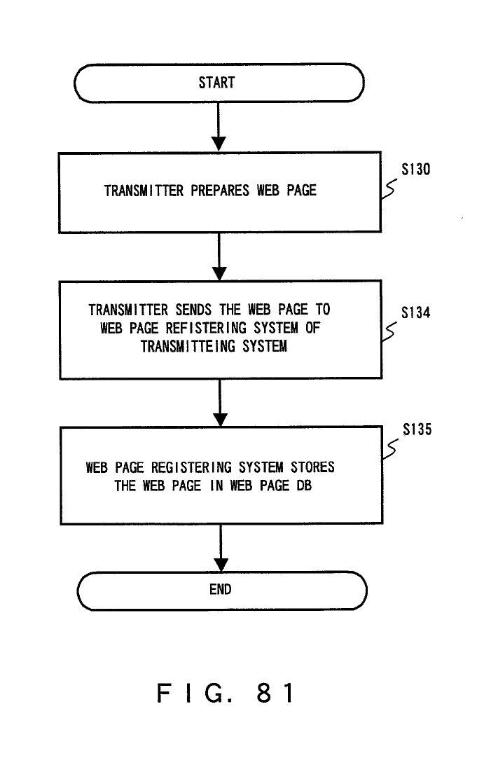

The transmitter prepares a Web page. In FIG. 80 for the first case, an additional value to be appended to the generated Web page is determined in advance. Next, the generated Web page is registered in the transmitting system 100. At that time, in the case shown in FIG. 80, the additional value information is also saved. FIG. 81 is a flowchart of a WEB page preparing process for the second case.

3. Request transmitting operation (S123)

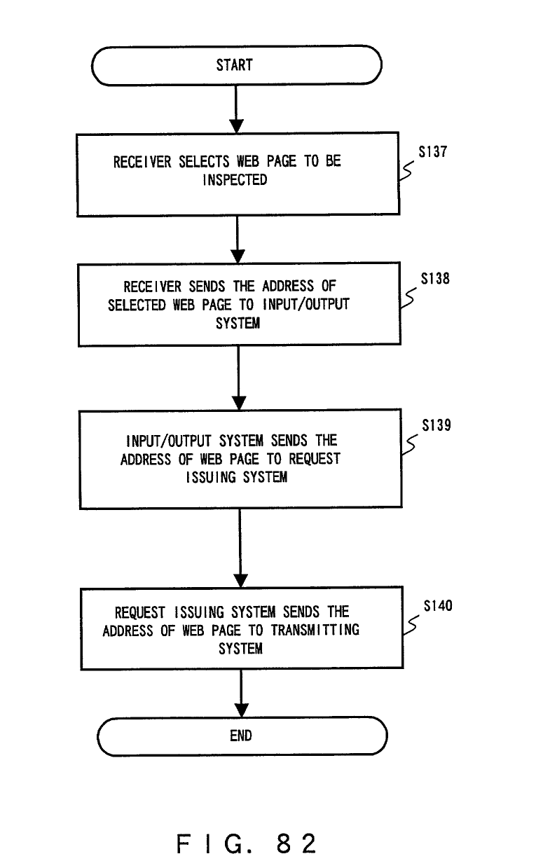

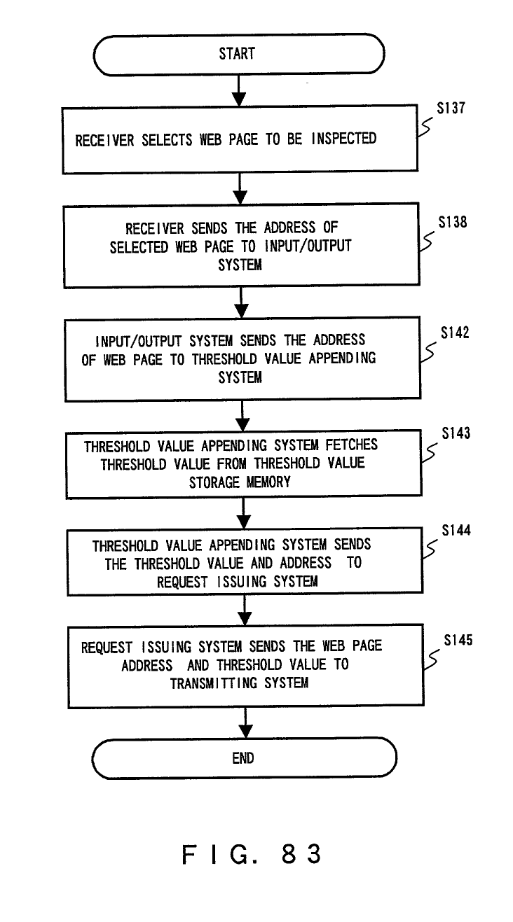

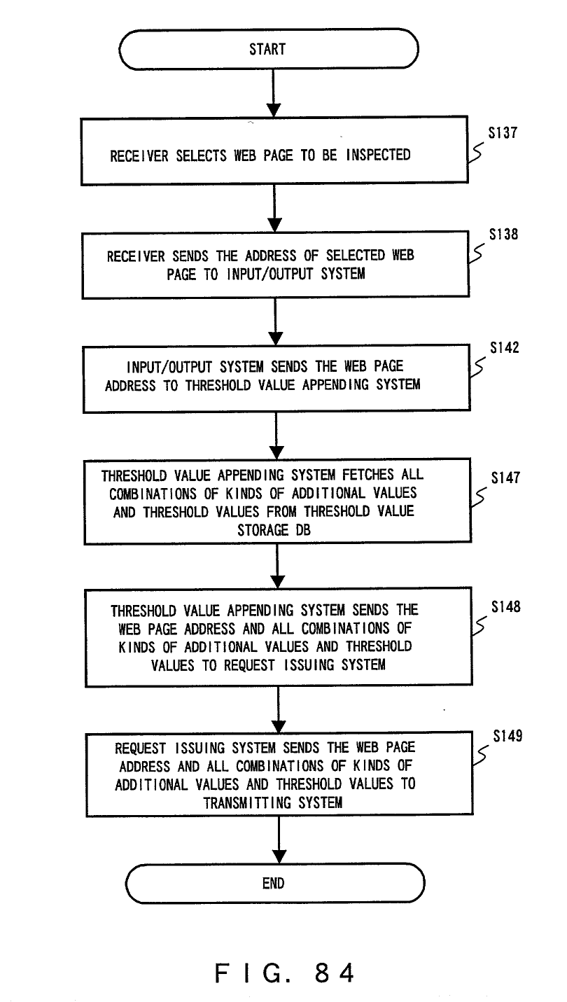

The receiver selects a WEB page that he wants to inspect and sends it to the input/output system 103 of the inspecting system 101. The input/output system 103 transmits a designated address to the transmitting system 100 via the request issuing system 104. FIG. 82 is a process flowchart for the first case. As shown in FIGS. 83 and 84 for the second case, at that time, the threshold value appending system 110 transmits the additional value information to the request issuing system together with the address.

4. Web page transmitting operation (S124)

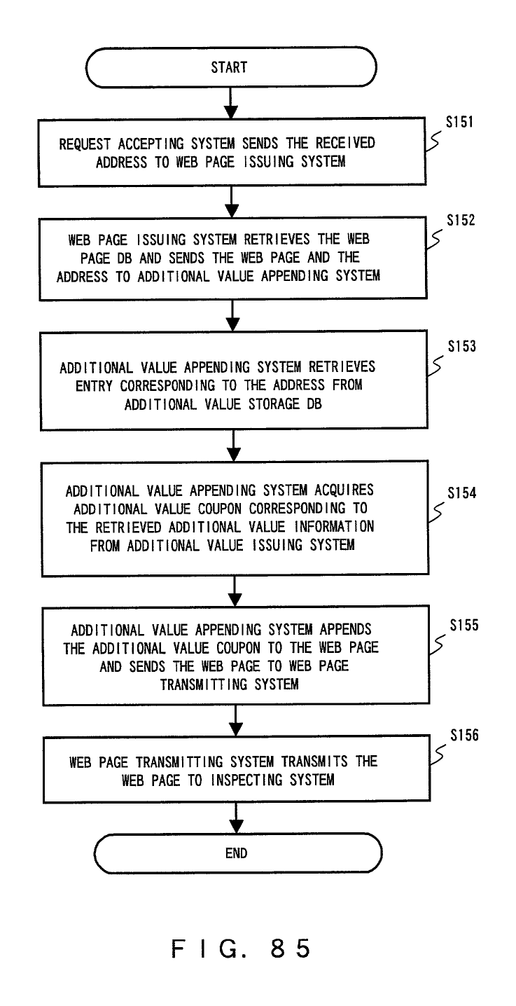

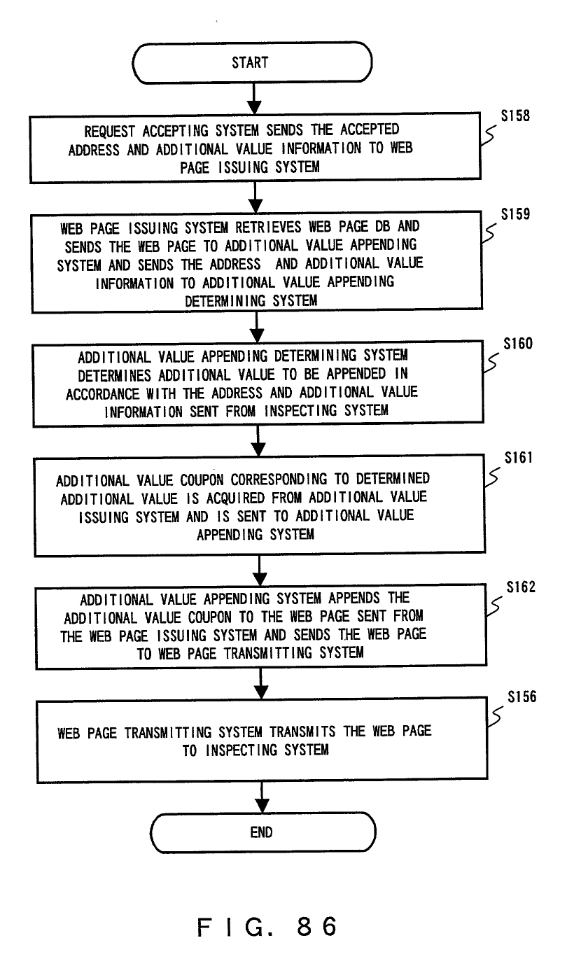

The transmitting system 100 retrieves the Web page corresponding to the designated address. In FIG. 85 for the first case, the coupon for the additional value is acquired in accordance with the additional value information designated in advance by the transmitter and is appended to the Web page. In FIG. 86 for the second case, the coupon for the additional value is appended to the Web page based on the threshold value information (the additional value information) appended to the request. The Web page with the additional value coupon appended thereto is sent by the Web page transmitting system 121 to the inspecting system 101.

5. Web page receiving operation (S125)

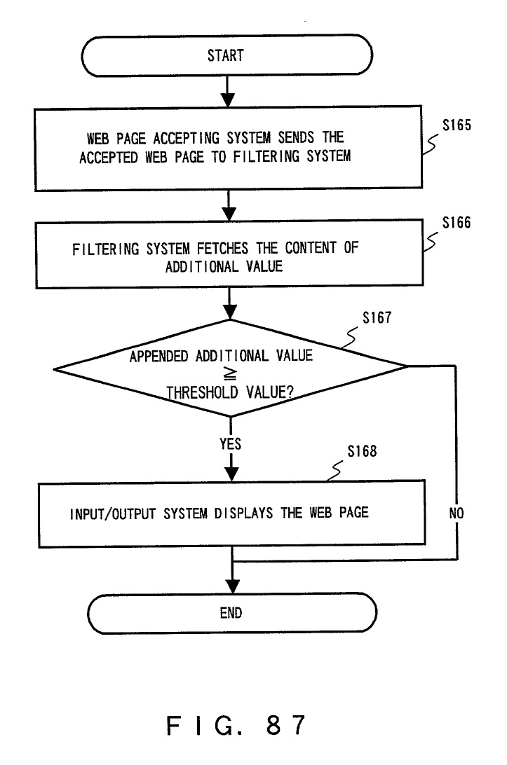

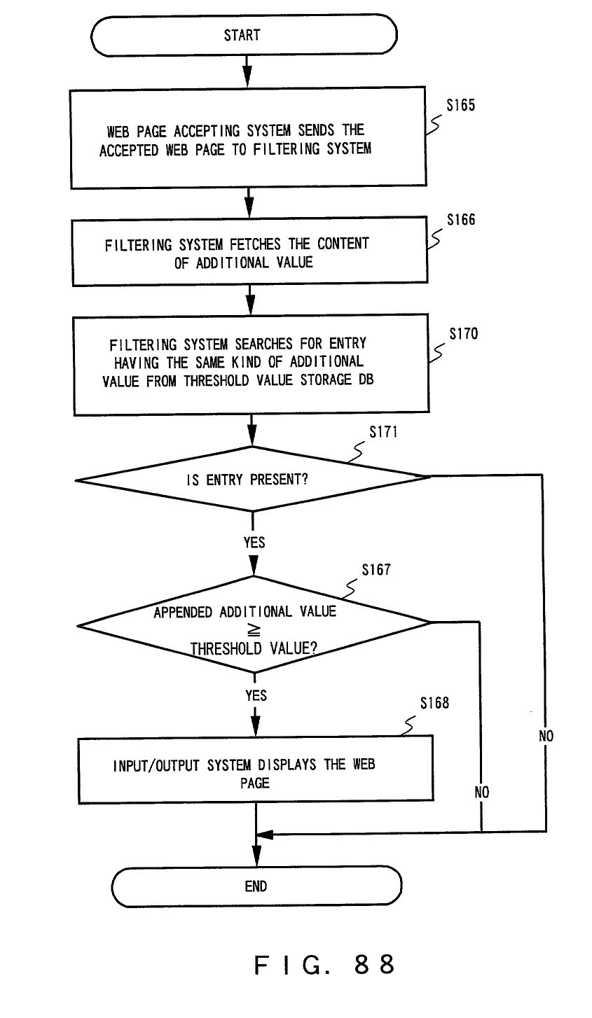

The inspecting system 101 which received the Web page fetches the additional value coupon from within the Web page, as shown in FIGS. 87 and 88. Then, the additional value is compared with the threshold value set by the threshold setting operation 1, and when it exceeds the threshold value, the Web page is displayed.

6. Additional value settling operation (S126 and S127)

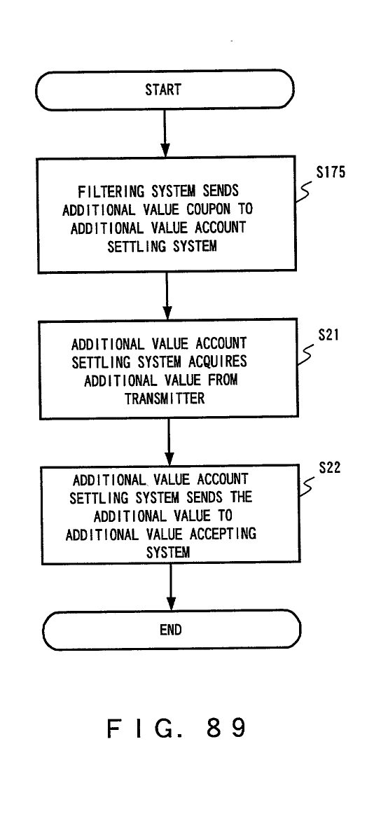

In a case that the receiver read this Web page, the inspecting system 101 sends the additional value coupon appended to the Web page to the additional value settling system 13, which then collects the additional value from the transmitter and sends it to the additional value accepting system 14. The flowchart of this process is as shown in FIG. 89, which is substantially the same as FIG. 8 for the first embodiment except that at the step S20, the receiving system is replaced by the inspecting system (that is, the filtering system therewithin).

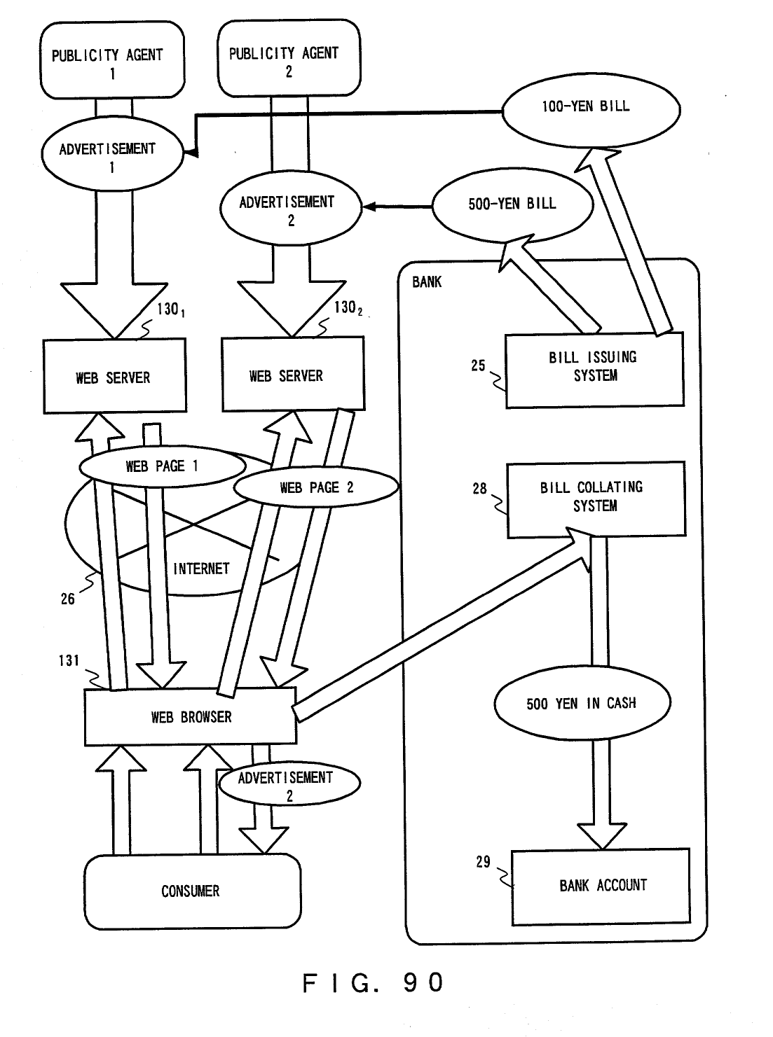

FIG. 90 shows a concrete example of the thirteenth embodiment of the present invention. In this example, it is assumed that the transmitter corresponds to a publicity agent 1 and a publicity agent 2 and the receiver corresponds to a certain consumer. In addition, cash is used as the additional value, the bill is used as the additional value coupon, the bank provides the bill issuing system 25 and the bill collating system 28, and the bank account 29 of the consumer is used as the additional value accepting system. Web servers 130₁ and 130₂ are used for Web page transmission, and a Web browser 131 is used as the inspecting system 101. In many cases, an advertisement of a Web system is embedded in a page which is inspected by the receiver and is specified indirectly in accordance with a page address to be displayed on the receiver.

First, it is assumed that the consumer sets 200 yen as the threshold value.

Next, the publicity agent 1 prepares an advertisement 1 and registers it in the Web server 130₁. In the above mentioned first case, it is determined to append the additional value for 100 yen to this advertisement (after cash has been determined as the kind of additional value in the case of the plurality of kinds of additional values) and this determination should be registered in the Web server 130₁. However, the publicity agent 2 prepares an advertisement 2 and registers it in the Web server 130₂. In the fist case, it is determined to append the additional value for 500 yen to this advertisement (after cash has been determined as the kind of additional value, in the case of the plurality of kinds of additional values) and this determination should be registered in the Web server 130₂.

Then, the consumer sends his address to the Web servers 130₁ and 130₂ for inspection of the Web pages of the publicity agents 1 and 2. At that time, in the second case, the additional value information (the threshold value information) is also transmitted. In the case of one kind of additional value, the value of 500 yen is transmitted as the threshold value, while in the case of the plurality of kinds of additional values, “cash” is transmitted as the kind of additional value and the value of 500 yen is transmitted as the threshold value.

Next, the Web pages are transmitted to the Web browser 131. That is, the Web page 1 in which the 100-yen bill is appended to the advertisement 1 is transmitted from the Web server 130₁ and the Web page 2 in which the 500-yen bill is appended to the advertisement 2 is transmitted from the Web server 130₂. In the second case, an appropriate additional value can be appended thereto based on the transmitted threshold value. In this example, the threshold value is 200 yen, so that it is determined that what is needed is to simply append the 200-yen bill thereto.

The Web browser 131 which received the Web page 1 and the Web page 2 fetches the additional values within the pages. The bill appended to the Web page 1 is worth 100 yen which is less that the threshold value and hence the Web browser 131 does not display the advertisement 1. However, the bill appended to the Web page 2 is worth 500 yen and hence the Web browser 131 displays the advertisement 2. After confirmation that the receiver read the advertisement 2, the Web browser 131 transmits the 500-yen bill to the bill collating system 28. The bank confirms that the transmitted bill is a real one and thereafter pays 500 yen into the bank account 29 of the consumer.

Thus, the consumer can read only the advertisement to which the bill of the value exceeding 200 yens is appended, that is, notification of the arrival of a piece of E-mail to which nothing is appended or a Web page to which a bill of the value less than 200 yen is appended is not made to the consumer, and as a result, the consumer can read only the Web page valuable to him. Likewise, the publicity agent can induce the consumer to read his advertisement selectively from among many Web pages.

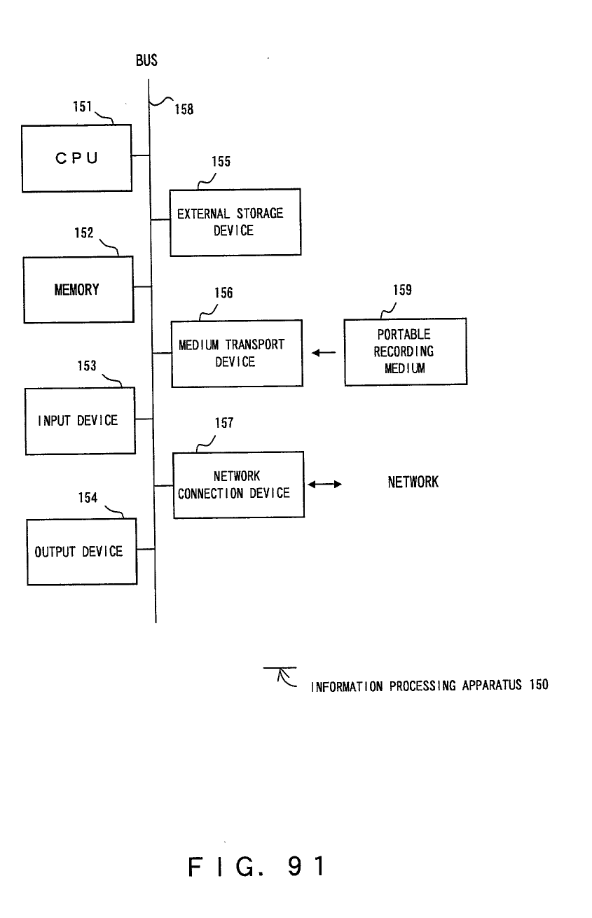

The above mentioned receiving system, the transmitting system or the like can be constructed with the use of an information processing apparatus (computer), as shown in FIG. 91. The information processing apparatus 150 shown in FIG. 91 is comprised of a CPU 151, a memory 152, an input device 153, an output device 154, an external storage 155, a medium driving device 156 and a network connecting device 157, and these are connected with one another via a bus 158.

The memory 152 includes, for example, a ROM (Read Only Memory), a RAM (Random Access Memory) and the like and stores therein programs and data used for processing. The CPU 151 executes the programs by utilizing the memory 152 to thereby perform the required processing.

Each of elements constituting each of the above mentioned systems is stored into each specific program code segment in the memory 152 as a program. The input device 153 is constituted by, for example, a keyboard, a pointing device, a touch panel or the like, and is used to input instructions and information from the user. The output device 154 is constituted, for example, by a display, a printer or the like to be used to output an inquiry, a processing result or the like to the user of the information processing apparatus 150.

The external storage 155 is constituted, for example, by a magnetic disk unit, an optical disk unit, a magneto-optical disk unit or the like. It is possible to store the above mentioned programs and data in the external storage 155 to be loaded into the memory 152 for use as needed.

The medium driving device 156 is adapted to drive a portable recording medium 159 so as to access to the content recorded therein. As the portable recording medium 159, there may be employed a given recording medium which is readable through a computer, such as a memory card, a memory stick, a floppy disk, a CD-ROM (Compact Disc Read only Memory), an optical disk, a magneto-optical disk, a DVD (Digital Versatile Disk) or the like. It is also possible to store the above mentioned programs and data in the portable recording medium 159 to be loaded into the memory 152 for use as needed.

The network connecting device 157 is adapted to communicate with an external device via a given network (line) such as a LAN, a WAN or the like to perform data translation incidental to the communication. It is also possible to request the above mentioned programs and data from the external device via the network connecting device to be loaded into the memory 152 for use as needed.

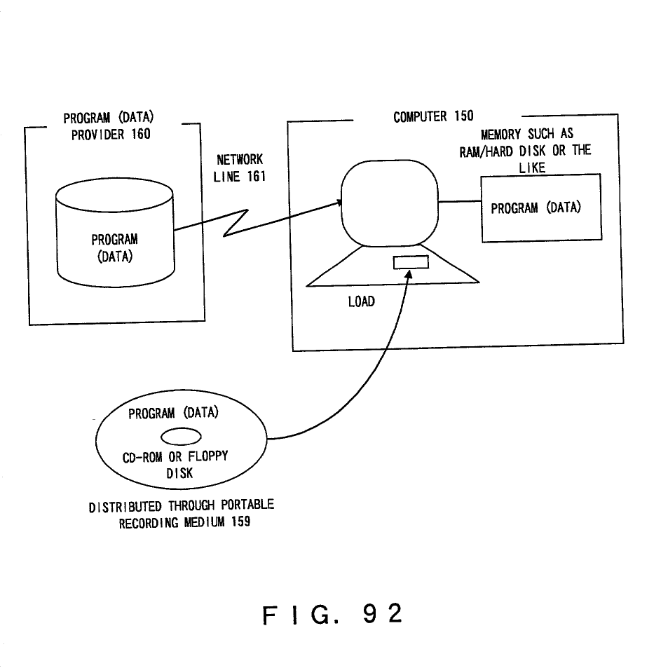

FIG. 92 is a diagram illustrating a manner of loading the programs and data into the computer for implementing the present invention shown in FIG. 91.

It is also possible to request a general purpose computer to execute functions corresponding to the devices and systems which have been described in the above mentioned embodiments. For this purpose, the computer maybe constructed such that each program, which is the same as that for each process conducted by each device and system, to be executed by the computer, is stored in advance in the recording medium 159 which is readable through the computer in accordance with each flowchart described in relation to each of the above mentioned embodiments. Then the program is read out from the recording medium 159 through the computer 150 in the manner shown in FIG. 92 and is temporarily stored in the memory 152 of the computer 150 or the external storage 155 so as to request the CPU 151 of the computer 150 to read out the program thus stored to be executed.

In addition, a transmission signal itself which is transmitted via a line 161 (a transmission medium) in a case that the program is down-loaded from a program (data) provider 160 to the computer 150 is of the type capable of requesting the general purpose computer to execute the functions corresponding to the respective devices which have been described in the above mentioned embodiments of the present invention.

Although in the above mentioned description, appending of the additional value and selection of the threshold value have been described in relation to the E-mail and Web page, the present invention is not limited thereto and the present invention is also applicable to messages and image data to be transmitted and received via the network such as message transmission and reception by means of mobile telephones in which mobile-telephone-oriented information providing service (such as the i-mode service by NTT DoCoMo) is adopted.

As described in detail above, according to the present invention, the E-mail receiver can select only the E-mail to which the additional value exceeding the threshold value is appended, by which selection of the E-mail to be read can be surely conducted. Likewise, on the side of the transmitter, the effect of the advertisement which is transmitted to the receiver in a state that it is appended to the E-mail can be improved. In addition, the destination of the advertisement can be selected such that the propagating effect of the advertisement will be optimized. Basically, such operations as mentioned above can be conducted directly between the transmitter and the receiver, that is, the receiver can control the quantity and quality of the received E-mail without aid of the server for concentratingly controlling these operations and the transmitter can improve the efficiency of the propagating effect of the enterprise.

In addition, such a way of thinking of the present invention as to read only the received document to which the additional value exceeding the threshold value is appended is applicable not only to the E-mail, but also to the Web page transmitted from the server side, for example, in the WWW system. That is, the receiver transmits the threshold value for the additional value to be appended to the page to be inspected, for example, together with the address of that page to the WWW server, and then in return the WWW server transmits the Web page to which the additional value exceeding the threshold value is appended to the receiver, by which the transmitter such as the publicity agent or the like can secure such a guarantee as to induce the receiver to read the advertisement embedded in the page.

While the invention has been described with reference to the preferred embodiments thereof, various modifications and changes may be made by those skilled in the art without departing from the true spirit and scope of the invention as defined by the claims thereof.

What is claimed is:

1. An additional value appended E-mail selecting apparatus for selecting E-mail to which an additional value that becomes effective when the E-mail is read by a receiver is appended, so as to make the receiver read the E-mail, comprising:
a threshold value storing unit storing a threshold value set by the receiver of the E-mail for said additional value; and
an E-mail arrival notifying unit notifying the receiver of the arrival of said E-mail when the additional value appended to the E-mail transmitted from a transmitter exceeds the threshold value stored in said threshold value storing unit.

2. The additional value appended E-mail selecting apparatus according to claim 1, wherein
said threshold value storing unit stores threshold values for a plurality of kinds of said additional values, and
when the additional value appended to said E-mail exceeds the threshold value for the additional value of the same kind as that stored in said threshold value storing unit, said E-mail arrival notifying unit notifies the receiver of the arrival of said E-mail.

3. The additional value appended E-mail selecting apparatus according to claim 2, further comprising:
a threshold value calculating unit receiving threshold values set for some of the plurality of kinds of additional values by the receiver of the E-mail and rates for calculating threshold values set for other kinds of additional values by the receiver, calculating threshold values for the plurality of kinds of additional values and sending said calculated threshold values to said threshold value storing unit.

4. The additional value appended E-mail selecting apparatus according to claim 1, wherein
said additional value appended E-mail selecting apparatus is installed on the side of an E-mail reception mediator interposing between the E-mail transmitter and receiver, and
said apparatus further comprises an additional value settling unit settling the account for the additional value appended to the E-mail when the receiver reads the E-mail for which notification has thus been made.

5. The additional value appended E-mail selecting apparatus according to claim 1, wherein as a kind of said additional value, there exists the additional value for the specific receiver which is generated on the side of the E-mail receiver, and
when the piece of E-mail to which said specific receiver additional value exceeding said threshold value is appended, is transmitted from the side of the transmitter who requested said specific receiver additional value, said E-mail arrival notifying unit notifies the receiver of the arrival of said E-mail.

6. An additional value appended E-mail transmitting apparatus for transmitting an additional value appended piece of E-mail to which an additional value which becomes effective for a receiver when the receiver reads the E-mail is appended, comprising:
an E-mail transmitting unit appending the additional value exceeding a threshold value, which is set by the receiver of the E-mail for said additional value and which is sent from the outside to the E-mail to be transmitted to the receiver who set said threshold value.

7. The additional value appended E-mail transmitting apparatus according to claim 6, wherein said additional value appended E-mail transmitting apparatus is installed on the side of a mediator interposing between the E-mail transmitter and receiver, and
said apparatus further comprises a threshold value storing unit storing said threshold value given from the receiver side so as to send said threshold value to said E-mail transmitting unit.

8. The additional value appended E-mail transmitting apparatus according to claim 7,
wherein said threshold value storing unit stores threshold values set by the E-mail receiver for a plurality of kinds of said additional values, and
said E-mail transmitting unit appends the additional value exceeding the threshold value thus stored and set for the additional value of the same kind as the above to the E-mail.

9. The additional value appended E-mail transmitting apparatus according to claim 8, further comprising:
a threshold value calculating unit receiving, from the E-mail receiver, threshold values set for some of the plurality of kinds of additional values set by the E-mail receiver and rates for calculating threshold values set for other kinds of additional values by said E-mail receiver, calculating threshold values for all of the plurality of kinds of additional values and providing said threshold values thus calculated to said threshold value storing unit.

10. An additional value appended E-mail transmitting/receiving system for transmitting/receiving an additional value appended piece of E-mail to which an additional value which becomes effective for a receiver when the receiver reads the E-mail is appended, comprising:
a threshold value storing unit storing a threshold value which is set for said additional value by the receiver of the E-mail and which is made public to the side of an E-mail transmitter; and
an E-mail transmitting unit referring to the contents stored in said threshold value storing unit and for transmitting the E-mail to which the additional value exceeding the published threshold value is appended to the receiver who made said threshold value public.

11. The additional value appended E-mail transmitting/receiving system according to claim 10,
wherein said threshold value storing unit stores each threshold value for a plurality of kinds of additional values, and
said E-mail transmitting unit transmits the E-mail to which the additional value exceeding the threshold value which is made public and set for the the additional value of the same kind as the above is appended.

12. The additional value appended E-mail transmitting/receiving system according to claim 11, further comprising:
a threshold value calculating unit requesting threshold values set, by the E-mail receiver, for some of the plurality of kinds of additional values and rates for calculating threshold values set, by the E-mail receiver, for other kinds of additional values, calculating threshold values for all of the plurality of kinds of additional values and forwarding the threshold values thus calculated to said threshold value storing unit.

13. The additional value appended E-mail transmitting/receiving system according to claim 11,
wherein said E-mail transmitting unit further comprises an appended additional value determining unit referring to the contents stored in said threshold value storing unit and determining an appropriate value as the additional value to be appended to the E-mail.

14. The additional value appended E-mail transmitting/receiving system according to claim 13,
wherein said E-mail transmitting unit further comprises an advertisement selecting unit referring to the contents stored in said threshold value storing unit, selecting an advertisement suitable for the receiver who made the threshold value public in accordance with the kind of additional value corresponding to the threshold value which was made public, and preparing the piece of E-mail including said advertisement to be transmitted to the receiver.

15. The additional value appended E-mail transmitting/receiving system according to claim 11,
wherein said E-mail transmitting unit further comprises an additional value distributing unit referring to the contents stored in said threshold value storing unit, appropriately distributing the total amount of additional values designated by the E-mail transmitter and determining one or more receivers to whom E-mails with said distributed additional values appended are to be transmitted.

16. The additional value appended E-mail transmitting/receiving system according to claim 15,
wherein said E-mail transmitting unit further comprises an advertisement selecting unit referring to the contents stored in said threshold value storing unit, selecting an advertisement suitable to the receiver who made said threshold value public in accordance with the kind of additional value corresponding to the threshold value thus published, preparing a piece of E-mail including said advertisement to be transmitted to the receiver.

17. The additional value appended E-mail transmitting/receiving system according to claim 11,
wherein said E-mail transmitting unit further comprises an advertisement selecting unit referring to the contents stored in said threshold value storing unit, selecting an advertisement suitable for the receiver who made said threshold value public in accordance with the kind of additional value corresponding to the threshold value thus published, and preparing a piece of E-mail including said advertisement to be transmitted to the receiver.

18. The additional value appended E-mail transmitting/receiving system according to claim 10,
wherein said E-mail transmitting unit further comprises an additional value distributing unit referring to the contents stored in said threshold value storing unit, appropriately distributing a total amount of additional values designated by the E-mail transmitter, and determining one or more receivers to whom one or more pieces of E-mail with the distributed additional values appended are to be transmitted.

19. The additional value appended E-mail transmitting/receiving system according to claim 10,
wherein said E-mail transmitting unit further comprises an appended additional value determining unit referring to the contents stored in said threshold value storing unit and determining an appropriate value as the additional value to be appended to said E-mail.

20. An E-mail transmitting/receiving system for transmitting/receiving a piece of E-mail to which an additional value for a specific receiver which is generated on the side of an E-mail receiver is appended, comprising:
a threshold value storing unit storing a threshold value set, by the E-mail receiver, for said specific receiver additional value;
an E-mail arrival notifying unit, when the additional value appended to the E-mail transmitted from a transmitter side exceeds the threshold value stored in said threshold value storing unit, notifying the receiver of the arrival of said E-mail; and
a specific receiver additional value mediating unit mediating said specific receiver additional value between the E-mail receiver and the E-mail transmitter.

21. An additional value appended Web page selecting apparatus for selecting an additional value appended Web page to which an additional value which becomes effective for a receiver when the receiver reads the Web page is appended in order to induce the receiver to read the Web page, comprising:
a threshold value storing unit storing a threshold value set for the additional value by the Web page receiver; and
a Web page arrival notifying unit, when the additional value appended to the Web page sent from a transmitter side exceeds the threshold value stored in said threshold value storing unit, notifying the receiver of the arrival of said Web page.

22. The additional value appended Web page selecting apparatus according to claim 21,
wherein said threshold value storing unit stores threshold values for a plurality of kinds of additional values; and
when the additional value appended to said Web page exceeds the threshold value which is stored in said threshold value storing unit and is set for the additional value of the same kind as the above, said Web page arrival notifying unit notifies the receiver of the arrival of said Web page.

23. An additional value appended Web page transmitting/receiving system for transmitting/receiving an additional value appended Web page to which an additional value, which becomes effective for a receiver when the receiver reads the Web page is appended, comprising:
a threshold value storing unit storing a threshold value which is set by the receiver of the Web page for said additional value;
a threshold value notifying unit notifying a Web page transmitter side of the threshold value stored in said threshold value storing unit; and
a Web page transmitting unit transmitting the Web page to which the additional value exceeding the threshold value for which notification has been made is appended to the receiver.

24. An additional value appended E-mail selecting method for selecting an additional value appended piece of E-mail to which an additional value which becomes effective for a receiver when the receiver reads the E-mail is appended in order to induce the receiver to read the E-mail, comprising:
storing a threshold value set by the E-mail receiver for said additional value; and
when the additional value appended to the E-mail transmitted from a transmitter side exceeds the threshold value thus stored, notifying the receiver of the arrival of said E-mail.

25. An additional value appended E-mail transmitting/receiving method for transmitting/receiving an additional value appended piece of E-mail to which an additional value which becomes effective for a receiver when the receiver reads the E-mail is appended, comprising:
storing a threshold value which is set by the E-mail receiver for said additional value and which is made public to a E-mail transmitter side; and
referring to the contents thus stored and transmitting the E-mail to which the additional value exceeding the published threshold value to the receiver who made the threshold value public.

26. A computer readable recording medium which records a program to make a computer perform control for use in a computer for selecting an additional value appended piece of E-mail to which an additional value which becomes effective for a receiver when the receiver reads the E-mail is appended in order to induce the receiver to read the E-mail, the programs to induce the computer to execute:
storing a threshold value set by the E-mail receiver for the additional value; and
when the additional value appended to the E-mail sent from a transmitter side exceeds the threshold value thus stored, notifying the receiver of the arrival of said E-mail.

27. A computer readable recording medium for use in a computer provided within a system for transmitting/receiving an additional value appended piece of E-mail to which an additional value which becomes effective for a receiver when the receiver reads the E-mail is appended, for storing programs to induce the computer to execute:
accepting an input of a threshold value which is set by the E-mail receiver for said additional value and which is to be made public to an E-mail transmitter side; and
storing the threshold value thus accepted.

28. A computer readable recording medium for use in a computer provided within a system for transmitting/receiving an additional value appended piece of E-mail to which an additional value which becomes effective for a receiver when the receiver reads the E-mail is appended, for storing programs to induce the computer to execute:
referring to a threshold value which is set by the E-mail receiver for said additional value and which is made public to an E-mail transmitter side; and
transmitting the E-mail to which the additional value exceeding the threshold value thus published is appended to the receiver who made the threshold value public in accordance with a result of this reference.
